(19) United States
(12) Patent Application Publication
(10) Pub. No.: US 2025/0307244 A1
(43) Pub. Date: Oct. 2, 2025

(54) QUERY EXECUTION VIA UPWARDS AND DOWNWARDS FLOW OF OPERATOR OUTPUT ACROSS MULTIPLE LEVELS OF A QUERY EXECUTION PLAN

(71) Applicant: Ocient Holdings LLC, Chicago, IL (US)

(72) Inventors: Natalia Marie Jenuwine, Chicago, IL (US); Andrew Park, St. Charles, IL (US); Ryan Joseph Kluzinski, Vancouver (CA); Ellis Mihalko Saupe, University City, MO (US); Jason Arnold, Chicago, IL (US); Knut Stolze, Jena (DE)

(73) Assignee: Ocient Holdings LLC, Chicago, IL (US)

(21) Appl. No.: 18/620,268

(22) Filed: Mar. 28, 2024

(51) Int. Cl. G06F 16/2453; G06F 11/34

(52) U.S. Cl. CPC G06F 16/24542; G06F 11/3409; G06F 16/24532

(57) ABSTRACT

A database system is operable to execute a query operator execution flow via a plurality of nodes each assigned to participate in a corresponding level of a hierarchical query plan. A first subset of nodes participating in at least one lower level of the hierarchical query plan generate a plurality of first output. A second node participating in at least one upper level of the hierarchical query plan generates second output based on processing the plurality of first output. The second output is segregated into a plurality of second output portions, and the plurality of second output portions are dispersed across the first subset of nodes for processing. The first subset of nodes generates a plurality of third output based on processing corresponding second output portions of the plurality of second output portions. The second node generates fourth output based on processing the plurality of third output.

### CROSS-REFERENCE TO RELATED APPLICATIONS

None

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to computer networking and more particularly to database system and operation.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function.

Of the many applications a computer can perform, a database system is one of the largest and most complex applications. In general, a database system stores a large amount of data in a particular way for subsequent processing. In some situations, the hardware of the computer is a limiting factor regarding the speed at which a database system can process a particular function. In some other instances, the way in which the data is stored is a limiting factor regarding the speed of execution. In yet some other instances, restricted co-process options are a limiting factor regarding the speed of execution.

### BRIEF DESCRIPTION OF THE SEVERAL VIEWS OF THE DRAWING(S)

FIG. 1 is a schematic block diagram of an embodiment of a large scale data processing network that includes a database system in accordance with various embodiments;

FIG. 1A is a schematic block diagram of an embodiment of a database system in accordance with various embodiments;

FIG. 2 is a schematic block diagram of an embodiment of an administrative sub-system in accordance with various embodiments;

FIG. 3 is a schematic block diagram of an embodiment of a configuration sub-system in accordance with various embodiments;

FIG. 4 is a schematic block diagram of an embodiment of a parallelized data input sub-system in accordance with various embodiments;

FIG. 5 is a schematic block diagram of an embodiment of a parallelized query and response (Q&R) sub-system in accordance with various embodiments;

FIG. 6 is a schematic block diagram of an embodiment of a parallelized data store, retrieve, and/or process (IO& P) sub-system in accordance with various embodiments;

FIG. 7 is a schematic block diagram of an embodiment of a computing device in accordance with various embodiments;

FIG. 8 is a schematic block diagram of another embodiment of a computing device in accordance with various embodiments;

FIG. 9 is a schematic block diagram of another embodiment of a computing device in accordance with various embodiments;

FIG. 10 is a schematic block diagram of an embodiment of a node of a computing device in accordance with various embodiments;

FIG. 11 is a schematic block diagram of an embodiment of a node of a computing device in accordance with various embodiments;

FIG. 12 is a schematic block diagram of an embodiment of a node of a computing device in accordance with various embodiments;

FIG. 13 is a schematic block diagram of an embodiment of a node of a computing device in accordance with various embodiments;

FIG. 14 is a schematic block diagram of an embodiment of operating systems of a computing device in accordance with various embodiments;

FIGS. 15-23 are schematic block diagrams of an example of processing a table or data set for storage in the database system in accordance with various embodiments;

FIG. 24A is a schematic block diagram of a query execution plan implemented via a plurality of nodes in accordance with various embodiments;

FIGS. 24B-24D are schematic block diagrams of embodiments of a node that implements a query processing module in accordance with various embodiments;

FIG. 24E is an embodiment is schematic block diagrams illustrating a plurality of nodes that communicate via shuffle networks in accordance with various embodiments;

FIG. 24F is a schematic block diagram of a database system communicating with an external requesting entity in accordance with various embodiments;

FIG. 24G is a schematic block diagram of a query processing system in accordance with various embodiments;

FIG. 24H is a schematic block diagram of a query operator execution flow in accordance with various embodiments;

FIG. 24I is a schematic block diagram of a plurality of nodes that utilize query operator execution flows in accordance with various embodiments;

FIG. 24J is a schematic block diagram of a query execution module that executes a query operator execution flow via a plurality of corresponding operator execution modules in accordance with various embodiments;

FIG. 24K illustrates an example embodiment of a plurality of database tables stored in database storage in accordance with various embodiments;

FIG. 24L illustrates an example embodiment of a dataset stored in database storage that includes at least one array field in accordance with various embodiments;

FIG. 24M is a schematic block diagram of a query execution module that implements a plurality of column data streams in accordance with various embodiments;

FIG. 24N illustrates example data blocks of a column data stream in accordance with various embodiments;

FIG. 24O is a schematic block diagram of a query execution module illustrating writing and processing of data blocks by operator execution modules in accordance with various embodiments;

FIG. 24P is a schematic block diagram of a database system that implements a segment generator that generates segments from a plurality of records in accordance with various embodiments;

FIG. 24Q is a schematic block diagram of a segment generator that implements a cluster key-based grouping module, a columnar rotation module, and a metadata generator module in accordance with various embodiments;

FIG. 24R is a schematic block diagram of a query processing system that generates and executes a plurality of IO pipelines to generate filtered records sets from a plurality of segments in conjunction with executing a query in accordance with various embodiments;

FIG. 24S is a schematic block diagram of a query processing system that generates an IO pipeline for accessing a corresponding segment based on predicates of a query in accordance with various embodiments;

FIG. 24T is a schematic block diagram of a database system that includes a plurality of storage clusters that each mediate cluster state data via a plurality of nodes in accordance with a consensus protocol in accordance with various embodiments;

FIG. 24U is a schematic block diagram of a database system that implements a compressed column filter conversion module based on accessing a dictionary structure in accordance with various embodiments;

FIG. 24V is a schematic block diagram of a query execution module that implements a Global Dictionary Compression join via access to a dictionary structure in accordance with various embodiments;

FIG. 25A is a schematic block diagram of a query execution module that executes a load operation indicated in a query request via a plurality of nodes in accordance with various embodiments;

FIG. 25B is a schematic block diagram illustrating execution of a query via a mode switch operation based on a selected mode of operation in accordance with various embodiments;

FIG. 25C is a schematic block diagram illustrating execution of a query via a node implementing a mode switch operation in accordance with various embodiments;

FIG. 25D is a logic diagram illustrating a method for execution in accordance with various embodiments;

FIG. 26A is a schematic block diagram of an operator flow generator module that generates a query execution flow for execution of a query that includes an unnest operation in accordance with various embodiments;

FIG. 26B is a schematic block diagram illustrating execution of a query execution flow via a row filtering operation, an array filtering operation, and an unnest operation in accordance with various embodiments;

FIG. 26C is a schematic block diagram illustrating optimizing of a query execution flow that includes an unnest operation in accordance with various embodiments;

FIGS. 26D-26E are schematic block diagram illustrating optimizing of a query execution flow that includes an unnest operation for a compressed column in accordance with various embodiments;

FIG. 26F is a logic diagram illustrating a method for execution in accordance with various embodiments;

FIG. 27A is a schematic block diagram of a query execution module that executes a plurality of flow subplans via a plurality of nodes at a plurality levels of a query execution plan to generate a plurality of output that includes scatter output;

FIG. 27B is a schematic block diagram of a query execution module that executes a plurality of flow subplans to generate scatter output for processing at lower levels of a query execution plan;

FIG. 27C is a schematic block diagram of a parent node that executes a scatter operator to segregate a scatter input row set into plurality of row subsets each for processing via a corresponding child node of a plurality of child nodes;

FIG. 27D is a schematic block diagram of an operator flow generator module that implements a flow optimizer module to generate an operator execution flow that includes at least one scatter operator and at least on gather operator;

FIG. 27E is a schematic block diagram of an operator flow generator module that generates a plurality of flow subplans for execution via a plurality of levels of a query execution plan;

FIG. 27F is a schematic block diagram of an operator flow generator module that generates an operator execution flow based on implementing a pushdown operator selection module via a flow optimizer module;

FIG. 27G is a schematic block diagram of a topmost level node of a query execution module that generates and communicates a plurality of messages indicating a plurality of subplan groupings to lower level nodes of a query execution plan;

FIG. 27H is a logic diagram illustrating a method for execution in accordance with various embodiments;

FIG. 27I is a logic diagram illustrating a method for execution in accordance with various embodiments; and

FIG. 27J is a logic diagram illustrating a method for execution in accordance with various embodiments.

### DETAILED DESCRIPTION OF THE INVENTION

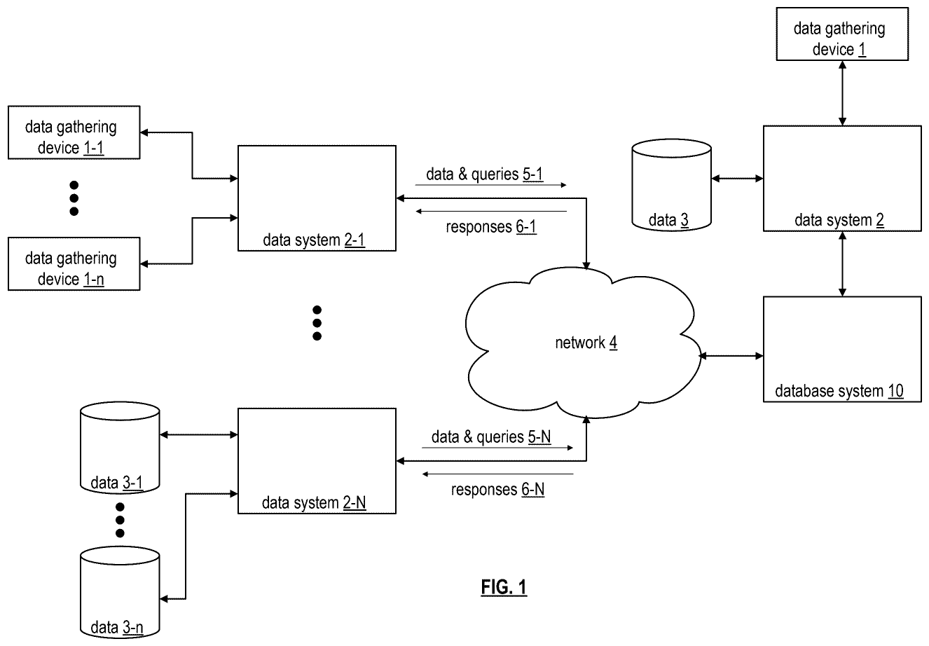

FIG. 1 is a schematic block diagram of an embodiment of a large-scale data processing network that includes data gathering devices (1, 1-1 through 1-n), data systems (2, 2-1 through 2-N), data storage systems (3, 3-1 through 3-n), a network 4, and a database system 10. The data gathering devices are computing devices that collect a wide variety of data and may further include sensors, monitors, measuring instruments, and/or other instrument for collecting data. The data gathering devices collect data in real-time (i.e., as it is happening) and provides it to data system 2-1 for storage and real-time processing of queries 5-1 to produce responses 6-1. As an example, the data gathering devices are computing in a factory collecting data regarding manufacturing of one or more products and the data system is evaluating queries to determine manufacturing efficiency, quality control, and/or product development status.

The data storage systems 3 store existing data. The existing data may originate from the data gathering devices or other sources, but the data is not real time data. For example, the data storage system stores financial data of a bank, a credit card company, or like financial institution. The data system 2-N processes queries 5-N regarding the data stored in the data storage systems to produce responses 6-N.

Data system 2 processes queries regarding real time data from data gathering devices and/or queries regarding non-real time data stored in the data storage system 3. The data system 2 produces responses in regard to the queries. Storage of real time and non-real time data, the processing of queries, and the generating of responses will be discussed with reference to one or more of the subsequent figures.

FIG. 1A is a schematic block diagram of an embodiment of a database system 10 that includes a parallelized data input sub-system 11, a parallelized data store, retrieve, and/or process sub-system 12, a parallelized query and response sub-system 13, system communication resources 14, an administrative sub-system 15, and a configuration sub-system 16. The system communication resources 14 include one or more of: wide area network (WAN) connections, local area network (LAN) connections, wireless connections, wireline connections, etc. to couple the sub-systems 11, 12, 13, 15, and 16 together.

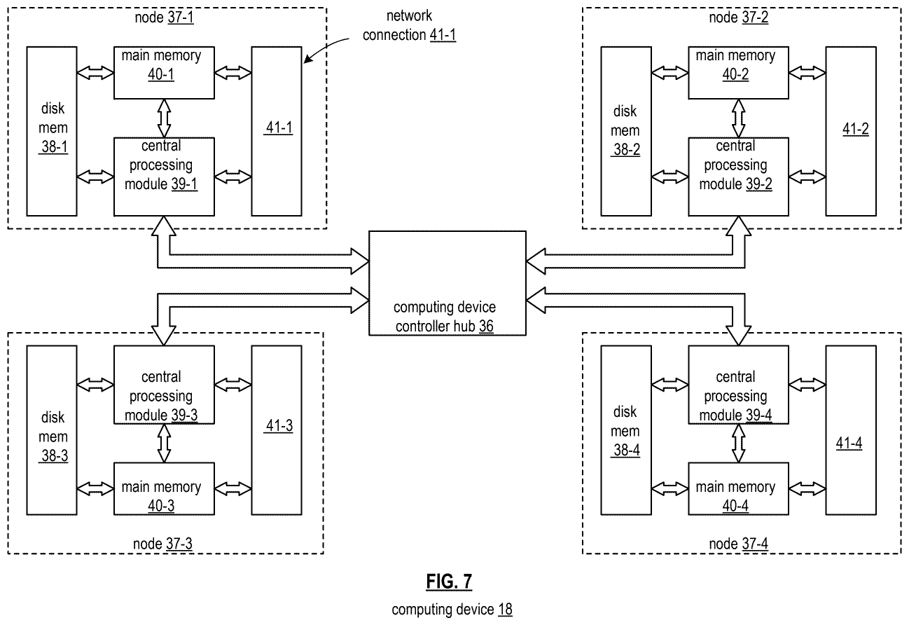

Each of the sub-systems 11, 12, 13, 15, and 16 include a plurality of computing devices; an example of which is discussed with reference to one or more of FIGS. 7-9. Hereafter, the parallelized data input sub-system 11 may also be referred to as a data input sub-system, the parallelized data store, retrieve, and/or process sub-system may also be referred to as a data storage and processing sub-system, and the parallelized query and response sub-system 13 may also be referred to as a query and results sub-system.

In an example of operation, the parallelized data input sub-system 11 receives a data set (e.g., a table) that includes a plurality of records. A record includes a plurality of data fields. As a specific example, the data set includes tables of data from a data source. For example, a data source includes one or more computers. As another example, the data source is a plurality of machines. As yet another example, the data source is a plurality of data mining algorithms operating on one or more computers.

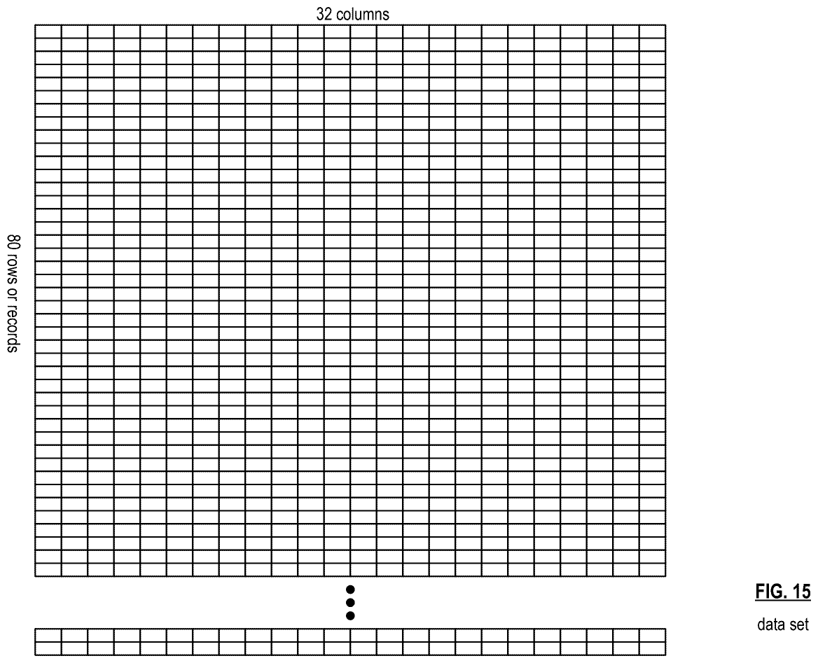

As is further discussed with reference to FIG. 15, the data source organizes its records of the data set into a table that includes rows and columns. The columns represent data fields of data for the rows. Each row corresponds to a record of data. For example, a table include payroll information for a company's employees. Each row is an employee's payroll record. The columns include data fields for employee name, address, department, annual salary, tax deduction information, direct deposit information, etc.

The parallelized data input sub-system 11 processes a table to determine how to store it. For example, the parallelized data input sub-system 11 divides the data set into a plurality of data partitions. For each partition, the parallelized data input sub-system 11 divides it into a plurality of data segments based on a segmenting factor. The segmenting factor includes a variety of approaches of dividing a partition into segments. For example, the segment factor indicates a number of records to include in a segment. As another example, the segmenting factor indicates a number of segments to include in a segment group. As another example, the segmenting factor identifies how to segment a data partition based on storage capabilities of the data store and processing sub-system. As a further example, the segmenting factor indicates how many segments for a data partition based on a redundancy storage encoding scheme.

As an example of dividing a data partition into segments based on a redundancy storage encoding scheme, assume that it includes a 4 of 5 encoding scheme (meaning any 4 of 5 encoded data elements can be used to recover the data). Based on these parameters, the parallelized data input sub-system 11 divides a data partition into 5 segments: one corresponding to each of the data elements).

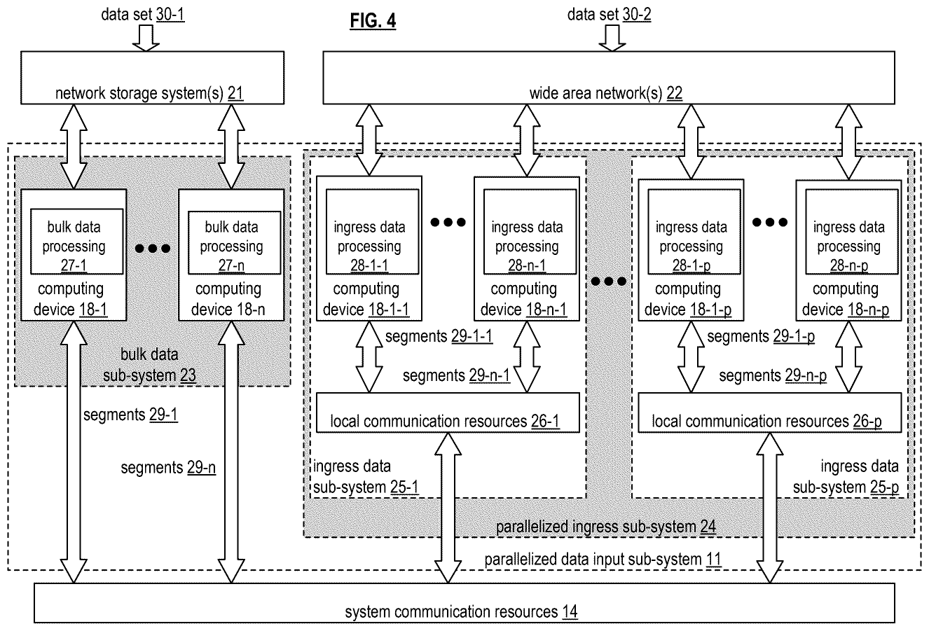

The parallelized data input sub-system 11 restructures the plurality of data segments to produce restructured data segments. For example, the parallelized data input sub-system 11 restructures records of a first data segment of the plurality of data segments based on a key field of the plurality of data fields to produce a first restructured data segment. The key field is common to the plurality of records. As a specific example, the parallelized data input sub-system 11 restructures a first data segment by dividing the first data segment into a plurality of data slabs (e.g., columns of a segment of a partition of a table). Using one or more of the columns as a key, or keys, the parallelized data input sub-system 11 sorts the data slabs. The restructuring to produce the data slabs is discussed in greater detail with reference to FIG. 4 and FIGS. 16-18.

The parallelized data input sub-system 11 also generates storage instructions regarding how sub-system 12 is to store the restructured data segments for efficient processing of subsequently received queries regarding the stored data. For example, the storage instructions include one or more of: a naming scheme, a request to store, a memory resource requirement, a processing resource requirement, an expected access frequency level, an expected storage duration, a required maximum access latency time, and other requirements associated with storage, processing, and retrieval of data.

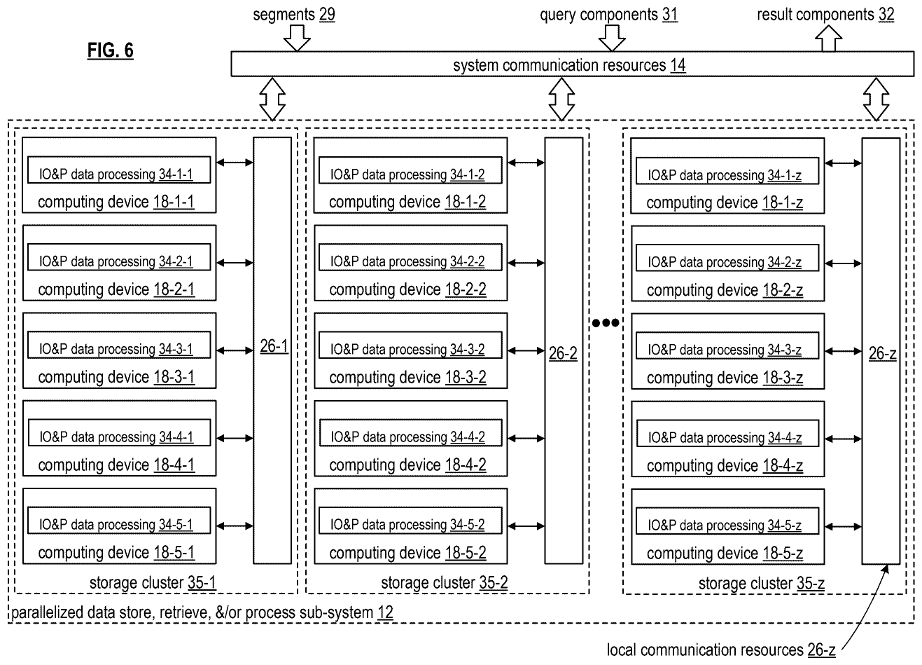

A designated computing device of the parallelized data store, retrieve, and/or process sub-system 12 receives the restructured data segments and the storage instructions. The designated computing device (which is randomly selected, selected in a round robin manner, or by default) interprets the storage instructions to identify resources (e.g., itself, its components, other computing devices, and/or components thereof) within the computing device's storage cluster. The designated computing device then divides the restructured data segments of a segment group of a partition of a table into segment divisions based on the identified resources and/or the storage instructions. The designated computing device then sends the segment divisions to the identified resources for storage and subsequent processing in accordance with a query. The operation of the parallelized data store, retrieve, and/or process sub-system 12 is discussed in greater detail with reference to FIG. 6.

The parallelized query and response sub-system 13 receives queries regarding tables (e.g., data sets) and processes the queries prior to sending them to the parallelized data store, retrieve, and/or process sub-system 12 for execution. For example, the parallelized query and response sub-system 13 generates an initial query plan based on a data processing request (e.g., a query) regarding a data set (e.g., the tables). Sub-system 13 optimizes the initial query plan based on one or more of the storage instructions, the engaged resources, and optimization functions to produce an optimized query plan.

For example, the parallelized query and response sub-system 13 receives a specific query no. 1 regarding the data set no. 1 (e.g., a specific table). The query is in a standard query format such as Open Database Connectivity (ODBC), Java Database Connectivity (JDBC), and/or SPARK. The query is assigned to a node within the parallelized query and response sub-system 13 for processing. The assigned node identifies the relevant table, determines where and how it is stored, and determines available nodes within the parallelized data store, retrieve, and/or process sub-system 12 for processing the query.

In addition, the assigned node parses the query to create an abstract syntax tree. As a specific example, the assigned node converts an SQL (Structured Query Language) statement into a database instruction set. The assigned node then validates the abstract syntax tree. If not valid, the assigned node generates a SQL exception, determines an appropriate correction, and repeats. When the abstract syntax tree is validated, the assigned node then creates an annotated abstract syntax tree. The annotated abstract syntax tree includes the verified abstract syntax tree plus annotations regarding column names, data type(s), data aggregation or not, correlation or not, sub-query or not, and so on.

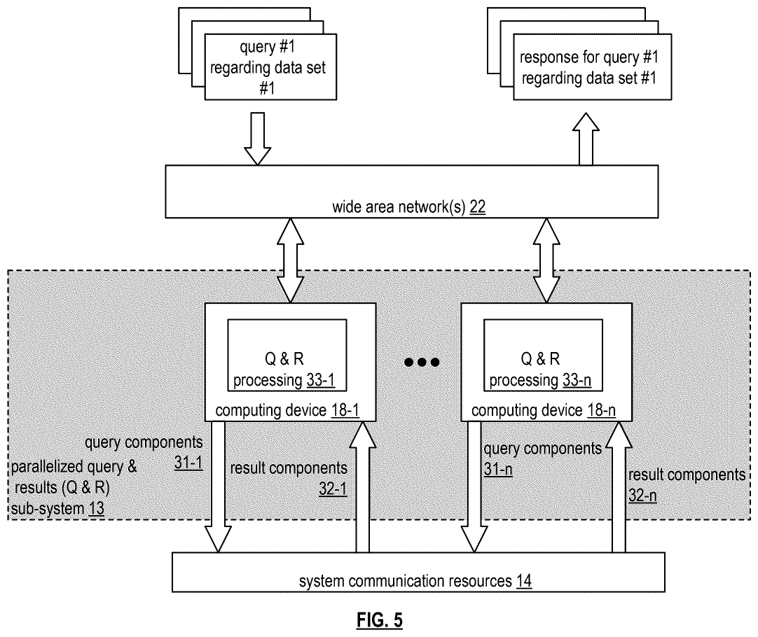

The assigned node then creates an initial query plan from the annotated abstract syntax tree. The assigned node optimizes the initial query plan using a cost analysis function (e.g., processing time, processing resources, etc.) and/or other optimization functions. Having produced the optimized query plan, the parallelized query and response sub-system 13 sends the optimized query plan to the parallelized data store, retrieve, and/or process sub-system 12 for execution. The operation of the parallelized query and response sub-system 13 is discussed in greater detail with reference to FIG. 5.

The parallelized data store, retrieve, and/or process sub-system 12 executes the optimized query plan to produce resultants and sends the resultants to the parallelized query and response sub-system 13. Within the parallelized data store, retrieve, and/or process sub-system 12, a computing device is designated as a primary device for the query plan (e.g., optimized query plan) and receives it. The primary device processes the query plan to identify nodes within the parallelized data store, retrieve, and/or process sub-system 12 for processing the query plan. The primary device then sends appropriate portions of the query plan to the identified nodes for execution. The primary device receives responses from the identified nodes and processes them in accordance with the query plan.

The primary device of the parallelized data store, retrieve, and/or process sub-system 12 provides the resulting response (e.g., resultants) to the assigned node of the parallelized query and response sub-system 13. For example, the assigned node determines whether further processing is needed on the resulting response (e.g., joining, filtering, etc.). If not, the assigned node outputs the resulting response as the response to the query (e.g., a response for query no. 1 regarding data set no. 1). If, however, further processing is determined, the assigned node further processes the resulting response to produce the response to the query. Having received the resultants, the parallelized query and response sub-system 13 creates a response from the resultants for the data processing request.

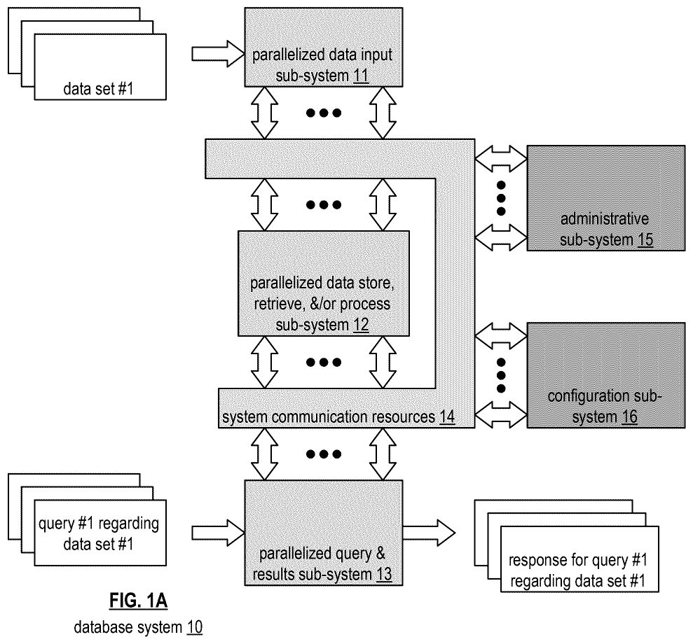

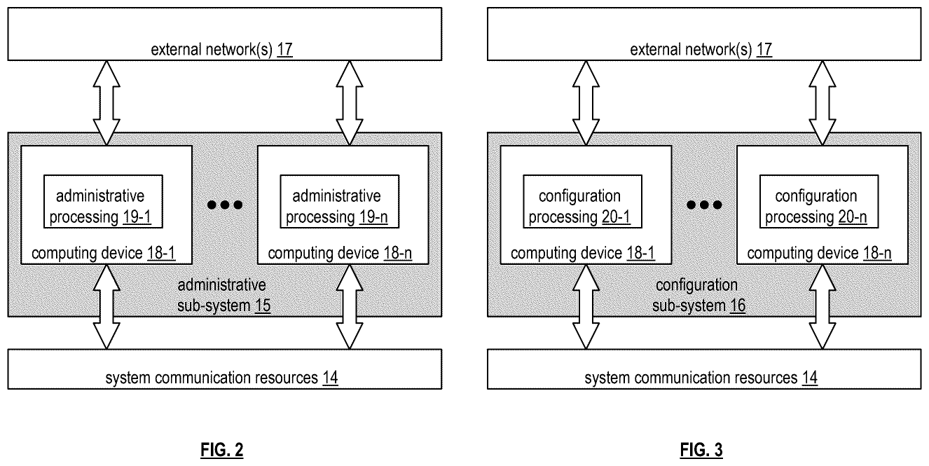

FIG. 2 is a schematic block diagram of an embodiment of the administrative sub-system 15 of FIG. 1A that includes one or more computing devices 18-1 through 18-n. Each of the computing devices executes an administrative processing function utilizing a corresponding administrative processing of administrative processing 19-1 through 19-n (which includes a plurality of administrative operations) that coordinates system level operations of the database system. Each computing device is coupled to an external network 17, or networks, and to the system communication resources 14 of FIG. 1A.

As will be described in greater detail with reference to one or more subsequent figures, a computing device includes a plurality of nodes and each node includes a plurality of processing core resources. Each processing core resource is capable of executing at least a portion of an administrative operation independently. This supports lock free and parallel execution of one or more administrative operations.

The administrative sub-system 15 functions to store metadata of the data set described with reference to FIG. 1A. For example, the storing includes generating the metadata to include one or more of an identifier of a stored table, the size of the stored table (e.g., bytes, number of columns, number of rows, etc.), labels for key fields of data segments, a data type indicator, the data owner, access permissions, available storage resources, storage resource specifications, software for operating the data processing, historical storage information, storage statistics, stored data access statistics (e.g., frequency, time of day, accessing entity identifiers, etc.) and any other information associated with optimizing operation of the database system 10.

FIG. 3 is a schematic block diagram of an embodiment of the configuration sub-system 16 of FIG. 1A that includes one or more computing devices 18-1 through 18-n. Each of the computing devices executes a configuration processing function 20-1 through 20-n (which includes a plurality of configuration operations) that coordinates system level configurations of the database system. Each computing device is coupled to the external network 17 of FIG. 2, or networks, and to the system communication resources 14 of FIG. 1A.

FIG. 4 is a schematic block diagram of an embodiment of the parallelized data input sub-system 11 of FIG. 1A that includes a bulk data sub-system 23 and a parallelized ingress sub-system 24. The bulk data sub-system 23 includes a plurality of computing devices 18-1 through 18-n. A computing device includes a bulk data processing function (e.g., 27-1) for receiving a table from a network storage system 21 (e.g., a server, a cloud storage service, etc.) and processing it for storage as generally discussed with reference to FIG. 1A.

The parallelized ingress sub-system 24 includes a plurality of ingress data sub-systems 25-1 through 25-p that each include a local communication resource of local communication resources 26-1 through 26-p and a plurality of computing devices 18-1 through 18-n. A computing device executes an ingress data processing function (e.g., 28-1) to receive streaming data regarding a table via a wide area network 22 and processing it for storage as generally discussed with reference to FIG. 1A. With a plurality of ingress data sub-systems 25-1 through 25-p, data from a plurality of tables can be streamed into the database system 10 at one time.

In general, the bulk data processing function is geared towards receiving data of a table in a bulk fashion (e.g., the table exists and is being retrieved as a whole, or portion thereof). The ingress data processing function is geared towards receiving streaming data from one or more data sources (e.g., receive data of a table as the data is being generated). For example, the ingress data processing function is geared towards receiving data from a plurality of machines in a factory in a periodic or continual manner as the machines create the data.

FIG. 5 is a schematic block diagram of an embodiment of a parallelized query and results sub-system 13 that includes a plurality of computing devices 18-1 through 18-n. Each of the computing devices executes a query (Q) & response (R) processing function 33-1 through 33-n. The computing devices are coupled to the wide area network 22 to receive queries (e.g., query no. 1 regarding data set no. 1) regarding tables and to provide responses to the queries (e.g., response for query no. 1 regarding the data set no. 1). For example, a computing device (e.g., 18-1) receives a query, creates an initial query plan therefrom, and optimizes it to produce an optimized plan. The computing device then sends components (e.g., one or more operations) of the optimized plan to the parallelized data store, retrieve, &/or process sub-system 12.

Processing resources of the parallelized data store, retrieve, &/or process sub-system 12 processes the components of the optimized plan to produce results components 32-1 through 32-n. The computing device of the Q&R sub-system 13 processes the result components to produce a query response.

The Q&R sub-system 13 allows for multiple queries regarding one or more tables to be processed concurrently. For example, a set of processing core resources of a computing device (e.g., one or more processing core resources) processes a first query and a second set of processing core resources of the computing device (or a different computing device) processes a second query.

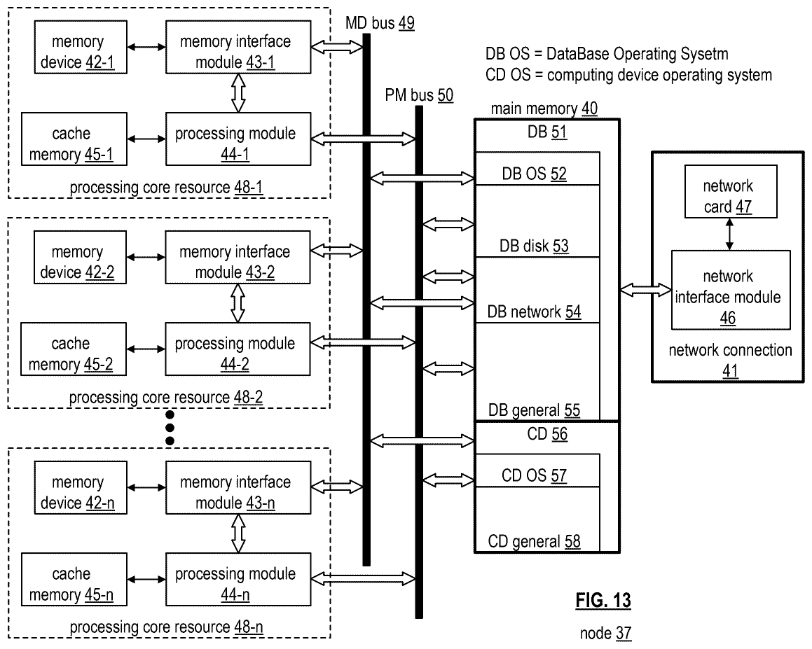

As will be described in greater detail with reference to one or more subsequent figures, a computing device includes a plurality of nodes and each node includes multiple processing core resources such that a plurality of computing devices includes pluralities of multiple processing core resources A processing core resource of the pluralities of multiple processing core resources generates the optimized query plan and other processing core resources of the pluralities of multiple processing core resources generates other optimized query plans for other data processing requests. Each processing core resource is capable of executing at least a portion of the Q & R function. In an embodiment, a plurality of processing core resources of one or more nodes executes the Q & R function to produce a response to a query. The processing core resource is discussed in greater detail with reference to FIG. 13.

FIG. 6 is a schematic block diagram of an embodiment of a parallelized data store, retrieve, and/or process sub-system 12 that includes a plurality of computing devices, where each computing device includes a plurality of nodes and each node includes multiple processing core resources. Each processing core resource is capable of executing at least a portion of the function of the parallelized data store, retrieve, and/or process sub-system 12. The plurality of computing devices is arranged into a plurality of storage clusters. Each storage cluster includes a number of computing devices.

In an embodiment, the parallelized data store, retrieve, and/or process sub-system 12 includes a plurality of storage clusters 35-1 through 35-z. Each storage cluster includes a corresponding local communication resource 26-1 through 26-z and a number of computing devices 18-1 through 18-5. Each computing device executes an input, output, and processing (IO &P) processing function 34-1 through 34-5 to store and process data.

The number of computing devices in a storage cluster corresponds to the number of segments (e.g., a segment group) in which a data partitioned is divided. For example, if a data partition is divided into five segments, a storage cluster includes five computing devices. As another example, if the data is divided into eight segments, then there are eight computing devices in the storage clusters.

To store a segment group of segments 29 within a storage cluster, a designated computing device of the storage cluster interprets storage instructions to identify computing devices (and/or processing core resources thereof) for storing the segments to produce identified engaged resources. The designated computing device is selected by a random selection, a default selection, a round-robin selection, or any other mechanism for selection.

The designated computing device sends a segment to each computing device in the storage cluster, including itself. Each of the computing devices stores their segment of the segment group. As an example, five segments 29 of a segment group are stored by five computing devices of storage cluster 35-1. The first computing device 18-1-1 stores a first segment of the segment group; a second computing device 18-2-1 stores a second segment of the segment group; and so on. With the segments stored, the computing devices are able to process queries (e.g., query components from the Q&R sub-system 13) and produce appropriate result components.

While storage cluster 35-1 is storing and/or processing a segment group, the other storage clusters 35-2 through 35-n are storing and/or processing other segment groups. For example, a table is partitioned into three segment groups. Three storage clusters store and/or process the three segment groups independently. As another example, four tables are independently stored and/or processed by one or more storage clusters. As yet another example, storage cluster 35-1 is storing and/or processing a second segment group while it is storing/or and processing a first segment group.

FIG. 7 is a schematic block diagram of an embodiment of a computing device 18 that includes a plurality of nodes 37-1 through 37-4 coupled to a computing device controller hub 36. The computing device controller hub 36 includes one or more of a chipset, a quick path interconnect (QPI), and an ultra path interconnection (UPI). Each node 37-1 through 37-4 includes a central processing module 39-1 through 39-4, a main memory 40-1 through 40-4 (e.g., volatile memory), a disk memory 38-1 through 38-4 (non-volatile memory), and a network connection 41-1 through 41-4. In an alternate configuration, the nodes share a network connection, which is coupled to the computing device controller hub 36 or to one of the nodes as illustrated in subsequent figures.

In an embodiment, each node is capable of operating independently of the other nodes. This allows for large scale parallel operation of a query request, which significantly reduces processing time for such queries. In another embodiment, one or more node function as co-processors to share processing requirements of a particular function, or functions.

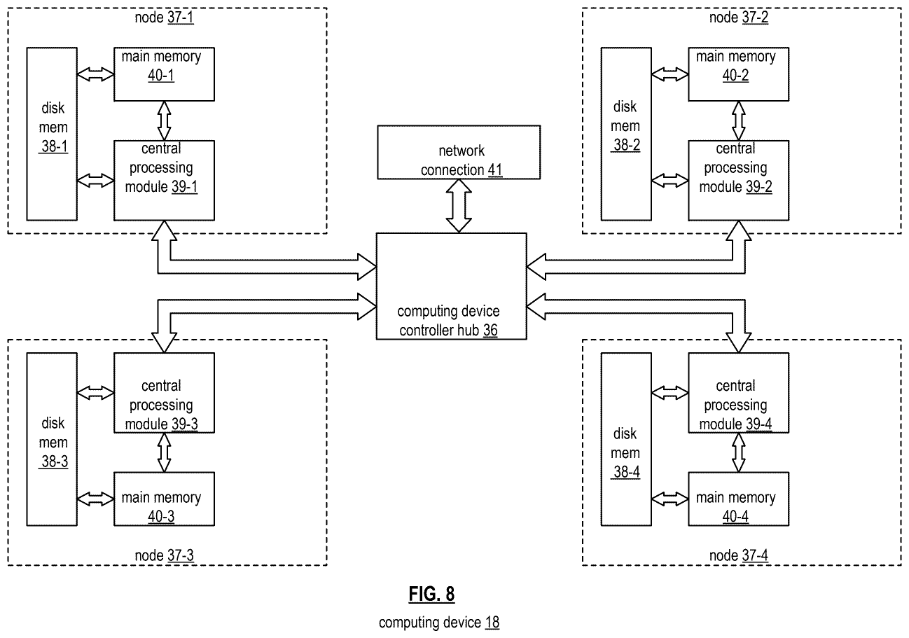

FIG. 8 is a schematic block diagram of another embodiment of a computing device similar to the computing device of FIG. 7 with an exception that it includes a single network connection 41, which is coupled to the computing device controller hub 36. As such, each node coordinates with the computing device controller hub to transmit or receive data via the network connection.

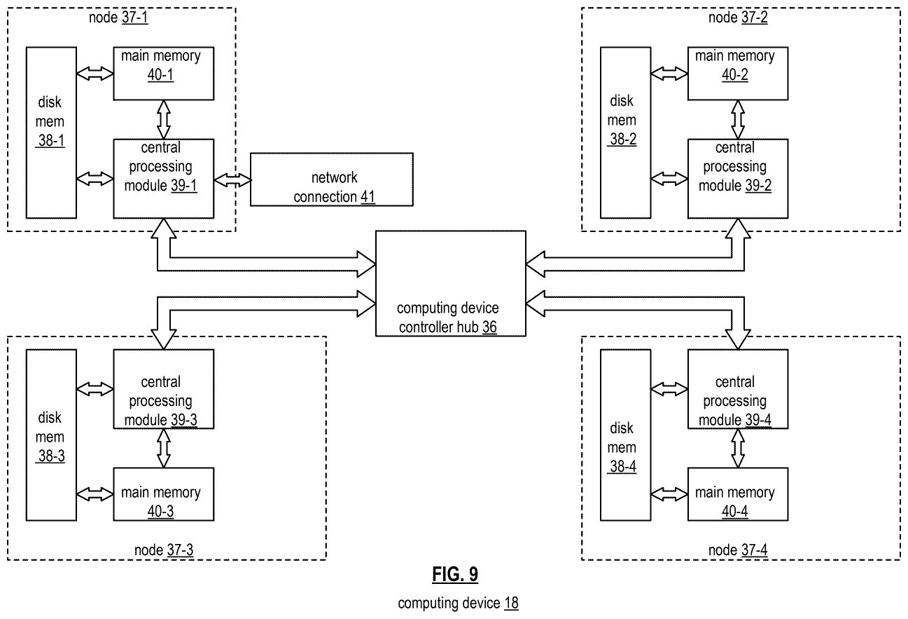

FIG. 9 is a schematic block diagram of another embodiment of a computing device is similar to the computing device of FIG. 7 with an exception that it includes a single network connection 41, which is coupled to a central processing module of a node (e.g., to central processing module 39-1 of node 37-1). As such, each node coordinates with the central processing module via the computing device controller hub 36 to transmit or receive data via the network connection.

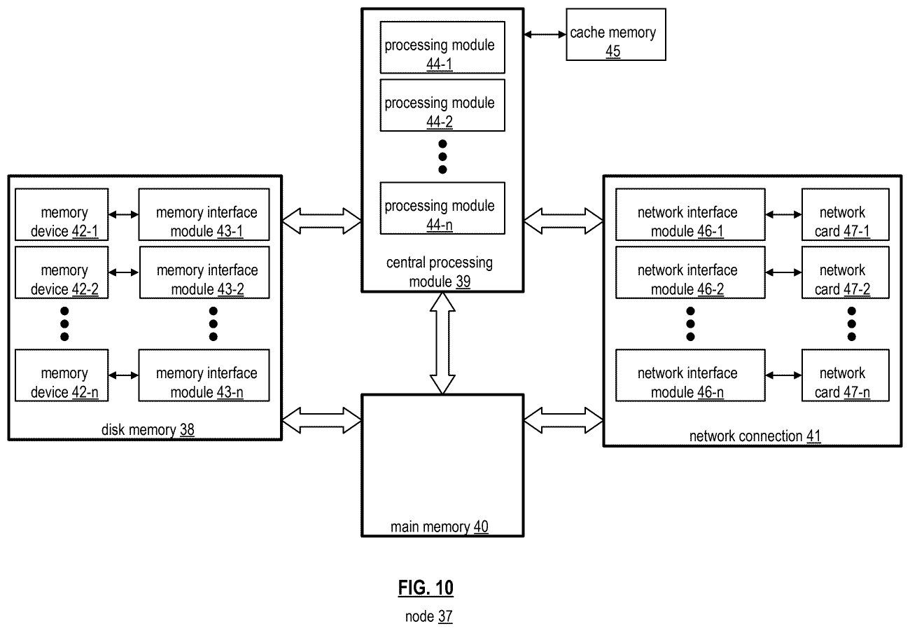

FIG. 10 is a schematic block diagram of an embodiment of a node 37 of computing device 18. The node 37 includes the central processing module 39, the main memory 40, the disk memory 38, and the network connection 41. The main memory 40 includes read only memory (RAM) and/or other form of volatile memory for storage of data and/or operational instructions of applications and/or of the operating system. The central processing module 39 includes a plurality of processing modules 44-1 through 44-n and an associated one or more cache memory 45. A processing module is as defined at the end of the detailed description.

The disk memory 38 includes a plurality of memory interface modules 43-1 through 43-n and a plurality of memory devices 42-1 through 42-n (e.g., non-volatile memory). The memory devices 42-1 through 42-n include, but are not limited to, solid state memory, disk drive memory, cloud storage memory, and other non-volatile memory. For each type of memory device, a different memory interface module 43-1 through 43-n is used. For example, solid state memory uses a standard, or serial, ATA (SATA), variation, or extension thereof, as its memory interface. As another example, disk drive memory devices use a small computer system interface (SCSI), variation, or extension thereof, as its memory interface.

In an embodiment, the disk memory 38 includes a plurality of solid state memory devices and corresponding memory interface modules. In another embodiment, the disk memory 38 includes a plurality of solid state memory devices, a plurality of disk memories, and corresponding memory interface modules.

The network connection 41 includes a plurality of network interface modules 46-1 through 46-n and a plurality of network cards 47-1 through 47-n. A network card includes a wireless LAN (WLAN) device (e.g., an IEEE 802.11n or another protocol), a LAN device (e.g., Ethernet), a cellular device (e.g., CDMA), etc. The corresponding network interface modules 46-1 through 46-n include a software driver for the corresponding network card and a physical connection that couples the network card to the central processing module 39 or other component(s) of the node.

The connections between the central processing module 39, the main memory 40, the disk memory 38, and the network connection 41 may be implemented in a variety of ways. For example, the connections are made through a node controller (e.g., a local version of the computing device controller hub 36). As another example, the connections are made through the computing device controller hub 36.

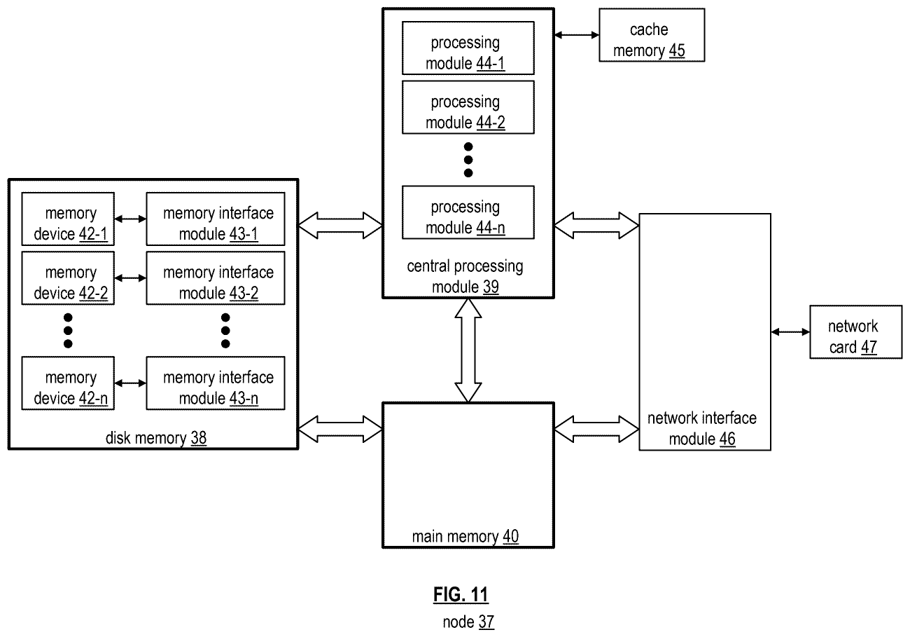

FIG. 11 is a schematic block diagram of an embodiment of a node 37 of a computing device 18 that is similar to the node of FIG. 10, with a difference in the network connection. In this embodiment, the node 37 includes a single network interface module 46 and a corresponding network card 47 configuration.

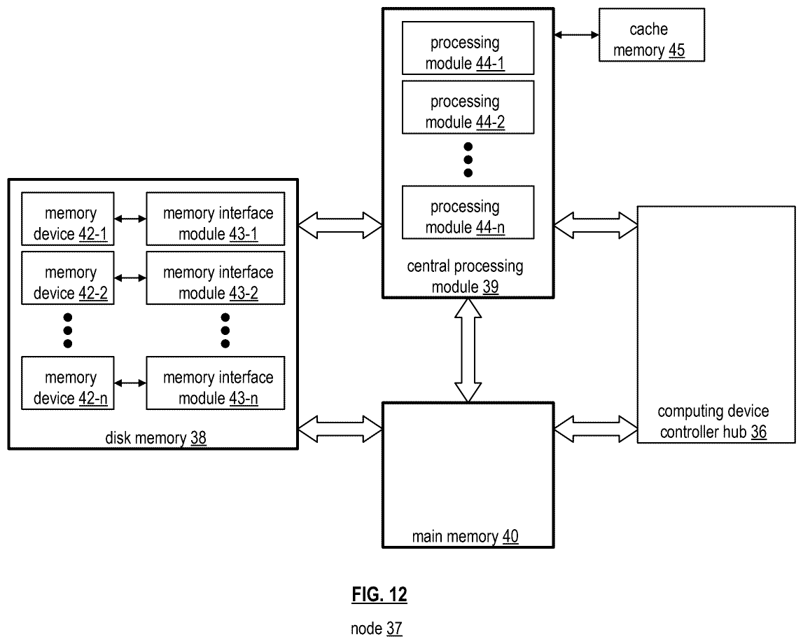

FIG. 12 is a schematic block diagram of an embodiment of a node 37 of a computing device 18 that is similar to the node of FIG. 10, with a difference in the network connection. In this embodiment, the node 37 connects to a network connection via the computing device controller hub 36.

FIG. 13 is a schematic block diagram of another embodiment of a node 37 of computing device 18 that includes processing core resources 48-1 through 48-n, a memory device (MD) bus 49, a processing module (PM) bus 50, a main memory 40 and a network connection 41. The network connection 41 includes the network card 47 and the network interface module 46 of FIG. 10. Each processing core resource 48 includes a corresponding processing module 44-1 through 44-n, a corresponding memory interface module 43-1 through 43-n, a corresponding memory device 42-1 through 42-n, and a corresponding cache memory 45-1 through 45-n. In this configuration, each processing core resource can operate independently of the other processing core resources. This further supports increased parallel operation of database functions to further reduce execution time.

The main memory 40 is divided into a computing device (CD) 56 section and a database (DB) 51 section. The database section includes a database operating system (OS) area 52, a disk area 53, a network area 54, and a general area 55. The computing device section includes a computing device operating system (OS) area 57 and a general area 58. Note that each section could include more or less allocated areas for various tasks being executed by the database system.

In general, the database OS 52 allocates main memory for database operations. Once allocated, the computing device OS 57 cannot access that portion of the main memory 40. This supports lock free and independent parallel execution of one or more operations.

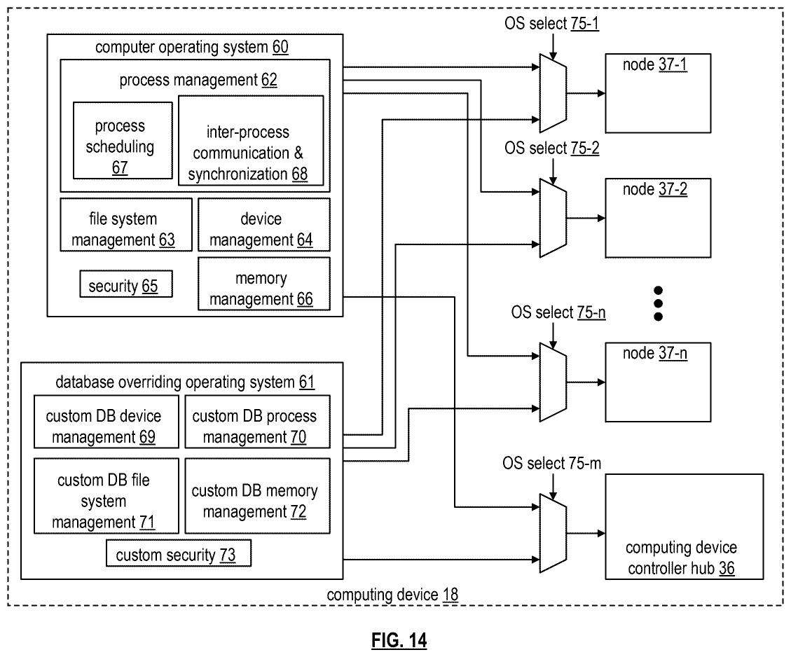

FIG. 14 is a schematic block diagram of an embodiment of operating systems of a computing device 18. The computing device 18 includes a computer operating system 60 and a database overriding operating system (DB OS) 61. The computer OS 60 includes process management 62, file system management 63, device management 64, memory management 66, and security 65. The processing management 62 generally includes process scheduling 67 and inter-process communication and synchronization 68. In general, the computer OS 60 is a conventional operating system used by a variety of types of computing devices. For example, the computer operating system is a personal computer operating system, a server operating system, a tablet operating system, a cell phone operating system, etc.

The database overriding operating system (DB OS) 61 includes custom DB device management 69, custom DB process management 70 (e.g., process scheduling and/or inter-process communication & synchronization), custom DB file system management 71, custom DB memory management 72, and/or custom security 73. In general, the database overriding OS 61 provides hardware components of a node for more direct access to memory, more direct access to a network connection, improved independency, improved data storage, improved data retrieval, and/or improved data processing than the computing device OS.

In an example of operation, the database overriding OS 61 controls which operating system, or portions thereof, operate with each node and/or computing device controller hub of a computing device (e.g., via OS select 75-1 through 75-n when communicating with nodes 37-1 through 37-n and via OS select 75-m when communicating with the computing device controller hub 36). For example, device management of a node is supported by the computer operating system, while process management, memory management, and file system management are supported by the database overriding operating system. To override the computer OS, the database overriding OS provides instructions to the computer OS regarding which management tasks will be controlled by the database overriding OS. The database overriding OS also provides notification to the computer OS as to which sections of the main memory it is reserving exclusively for one or more database functions, operations, and/or tasks. One or more examples of the database overriding operating system are provided in subsequent figures.

The database system 10 can be implemented as a massive scale database system that is operable to process data at a massive scale. As used herein, a massive scale refers to a massive number of records of a single dataset and/or many datasets, such as millions, billions, and/or trillions of records that collectively include many Gigabytes, Terabytes, Petabytes, and/or Exabytes of data. As used herein, a massive scale database system refers to a database system operable to process data at a massive scale. The processing of data at this massive scale can be achieved via a large number, such as hundreds, thousands, and/or millions of computing devices 18, nodes 37, and/or processing core resources 48 performing various functionality of database system 10 described herein in parallel, for example, independently and/or without coordination.

Such processing of data at this massive scale cannot practically be performed by the human mind. In particular, the human mind is not equipped to perform processing of data at a massive scale. Furthermore, the human mind is not equipped to perform hundreds, thousands, and/or millions of independent processes in parallel, within overlapping time spans. The embodiments of database system 10 discussed herein improves the technology of database systems by enabling data to be processed at a massive scale efficiently and/or reliably.

In particular, the database system 10 can be operable to receive data and/or to store received data at a massive scale. For example, the parallelized input and/or storing of data by the database system 10 achieved by utilizing the parallelized data input sub-system 11 and/or the parallelized data store, retrieve, and/or process sub-system 12 can cause the database system 10 to receive records for storage at a massive scale, where millions, billions, and/or trillions of records that collectively include many Gigabytes, Terabytes, Petabytes, and/or Exabytes can be received for storage, for example, reliably, redundantly and/or with a guarantee that no received records are missing in storage and/or that no received records are duplicated in storage. This can include processing real-time and/or near-real time data streams from one or more data sources at a massive scale based on facilitating ingress of these data streams in parallel. To meet the data rates required by these one or more real-time data streams, the processing of incoming data streams can be distributed across hundreds, thousands, and/or millions of computing devices 18, nodes 37, and/or processing core resources 48 for separate, independent processing with minimal and/or no coordination. The processing of incoming data streams for storage at this scale and/or this data rate cannot practically be performed by the human mind. The processing of incoming data streams for storage at this scale and/or this data rate improves database system by enabling greater amounts of data to be stored in databases for analysis and/or by enabling real-time data to be stored and utilized for analysis. The resulting richness of data stored in the database system can improve the technology of database systems by improving the depth and/or insights of various data analyses performed upon this massive scale of data.

Additionally, the database system 10 can be operable to perform queries upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to retrieve stored records at a massive scale and/or to and/or filter, aggregate, and/or perform query operators upon records at a massive scale in conjunction with query execution, where millions, billions, and/or trillions of records that collectively include many Gigabytes, Terabytes, Petabytes, and/or Exabytes can be accessed and processed in accordance with execution of one or more queries at a given time, for example, reliably, redundantly and/or with a guarantee that no records are inadvertently missing from representation in a query resultant and/or duplicated in a query resultant. To execute a query against a massive scale of records in a reasonable amount of time such as a small number of seconds, minutes, or hours, the processing of a given query can be distributed across hundreds, thousands, and/or millions of computing devices 18, nodes 37, and/or processing core resources 48 for separate, independent processing with minimal and/or no coordination. The processing of queries at this massive scale and/or this data rate cannot practically be performed by the human mind. The processing of queries at this massive scale improves the technology of database systems by facilitating greater depth and/or insights of query resultants for queries performed upon this massive scale of data.

Furthermore, the database system 10 can be operable to perform multiple queries concurrently upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to perform multiple queries concurrently, for example, in parallel, against data at this massive scale, where hundreds and/or thousands of queries can be performed against the same, massive scale dataset within a same time frame and/or in overlapping time frames. To execute multiple concurrent queries against a massive scale of records in a reasonable amount of time such as a small number of seconds, minutes, or hours, the processing of a multiple queries can be distributed across hundreds, thousands, and/or millions of computing devices 18, nodes 37, and/or processing core resources 48 for separate, independent processing with minimal and/or no coordination. A given computing devices 18, nodes 37, and/or processing core resources 48 may be responsible for participating in execution of multiple queries at a same time and/or within a given time frame, where its execution of different queries occurs within overlapping time frames. The processing of many concurrent queries at this massive scale and/or this data rate cannot practically be performed by the human mind. The processing of concurrent queries improves the technology of database systems by facilitating greater numbers of users and/or greater numbers of analyses to be serviced within a given time frame and/or over time.

FIGS. 15-23 are schematic block diagrams of an example of processing a table or data set for storage in the database system 10. FIG. 15 illustrates an example of a data set or table that includes 32 columns and 80 rows, or records, that is received by the parallelized data input-subsystem. This is a very small table, but is sufficient for illustrating one or more concepts regarding one or more aspects of a database system. The table is representative of a variety of data ranging from insurance data, to financial data, to employee data, to medical data, and so on.

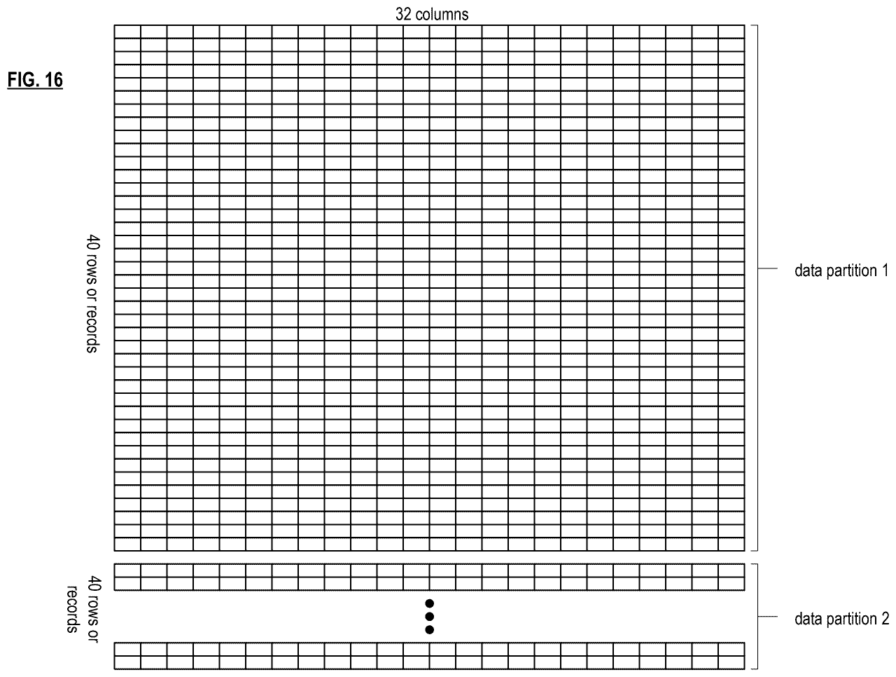

FIG. 16 illustrates an example of the parallelized data input-subsystem dividing the data set into two partitions. Each of the data partitions includes 40 rows, or records, of the data set. In another example, the parallelized data input-subsystem divides the data set into more than two partitions. In yet another example, the parallelized data input-subsystem divides the data set into many partitions and at least two of the partitions have a different number of rows.

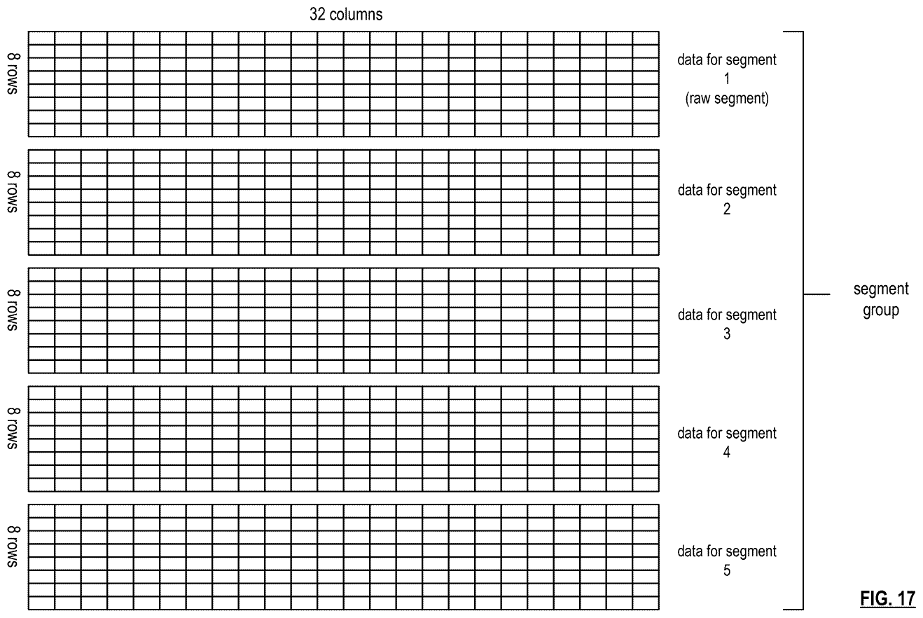

FIG. 17 illustrates an example of the parallelized data input-subsystem dividing a data partition into a plurality of segments to form a segment group. The number of segments in a segment group is a function of the data redundancy encoding. In this example, the data redundancy encoding is single parity encoding from four data pieces; thus, five segments are created. In another example, the data redundancy encoding is a two parity encoding from four data pieces; thus, six segments are created. In yet another example, the data redundancy encoding is single parity encoding from seven data pieces; thus, eight segments are created.

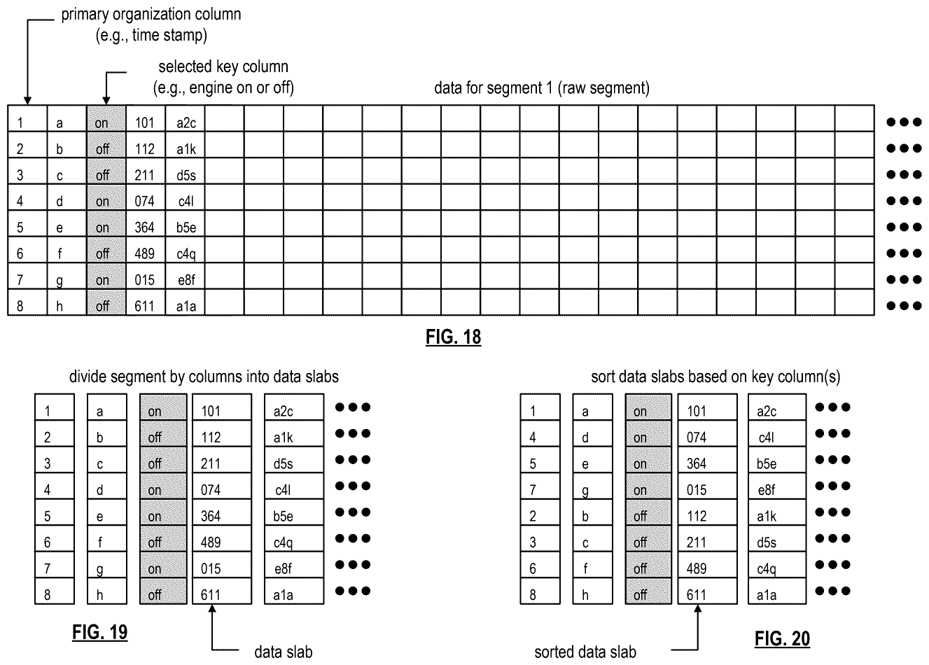

FIG. 18 illustrates an example of data for segment 1 of the segments of FIG. 17. The segment is in a raw form since it has not yet been key column sorted. As shown, segment 1 includes 8 rows and 32 columns. The third column is selected as the key column and the other columns store various pieces of information for a given row (i.e., a record). The key column may be selected in a variety of ways. For example, the key column is selected based on a type of query (e.g., a query regarding a year, where a data column is selected as the key column). As another example, the key column is selected in accordance with a received input command that identified the key column. As yet another example, the key column is selected as a default key column (e.g., a date column, an ID column, etc.)

As an example, the table is regarding a fleet of vehicles. Each row represents data regarding a unique vehicle. The first column stores a vehicle ID, the second column stores make and model information of the vehicle. The third column stores data as to whether the vehicle is on or off. The remaining columns store data regarding the operation of the vehicle such as mileage, gas level, oil level, maintenance information, routes taken, etc.

With the third column selected as the key column, the other columns of the segment are to be sorted based on the key column. Prior to being sorted, the columns are separated to form data slabs. As such, one column is separated out to form one data slab.

FIG. 19 illustrates an example of the parallelized data input-subsystem dividing segment 1 of FIG. 18 into a plurality of data slabs. A data slab is a column of segment 1. In this figure, the data of the data slabs has not been sorted. Once the columns have been separated into data slabs, each data slab is sorted based on the key column. Note that more than one key column may be selected and used to sort the data slabs based on two or more other columns.

FIG. 20 illustrates an example of the parallelized data input-subsystem sorting the each of the data slabs based on the key column. In this example, the data slabs are sorted based on the third column which includes data of “on” or “off”. The rows of a data slab are rearranged based on the key column to produce a sorted data slab. Each segment of the segment group is divided into similar data slabs and sorted by the same key column to produce sorted data slabs.

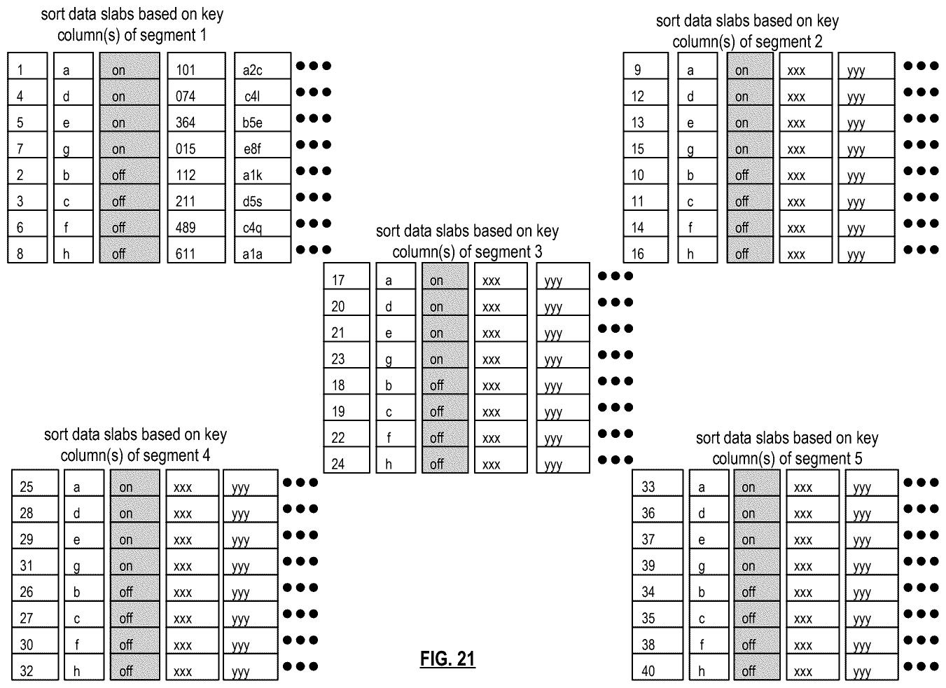

FIG. 21 illustrates an example of each segment of the segment group sorted into sorted data slabs. The similarity of data from segment to segment is for the convenience of illustration. Note that each segment has its own data, which may or may not be similar to the data in the other sections.

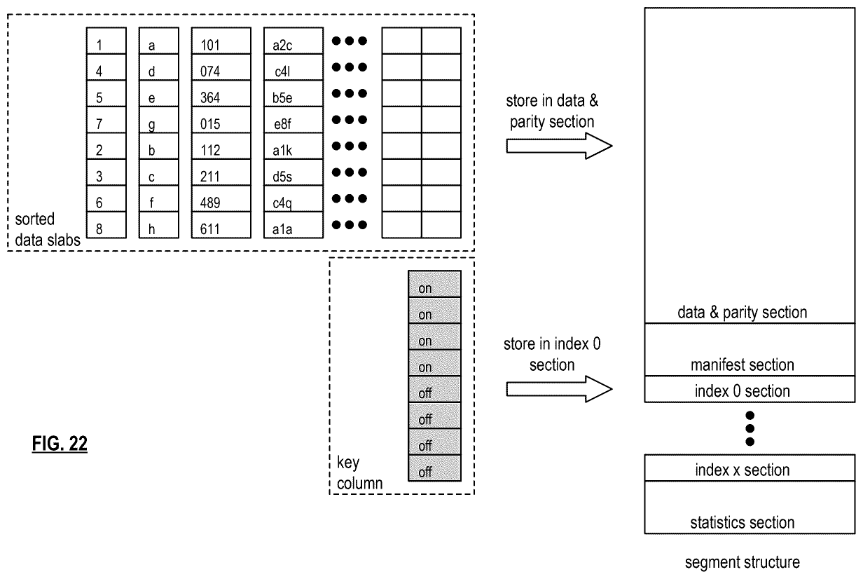

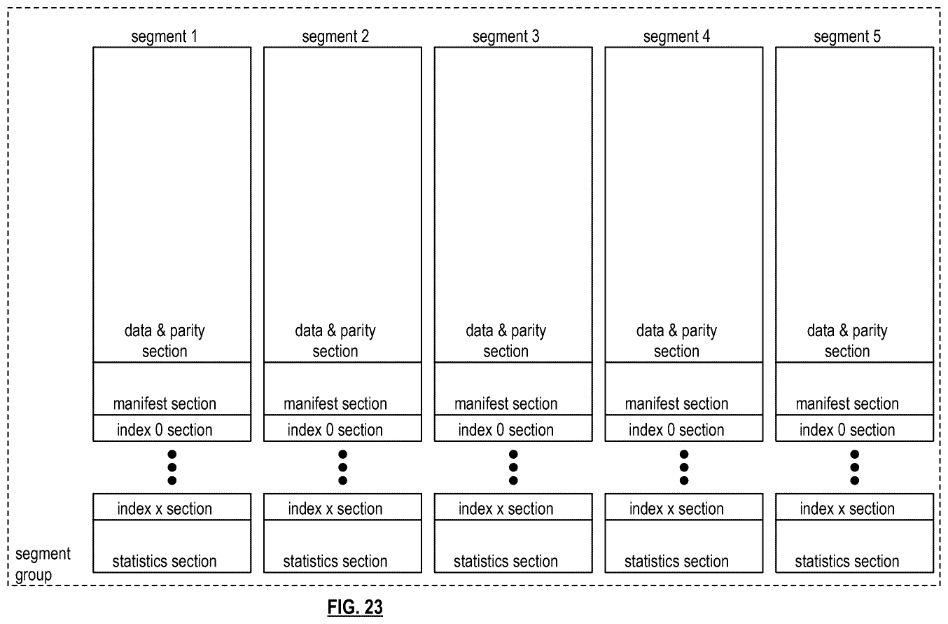

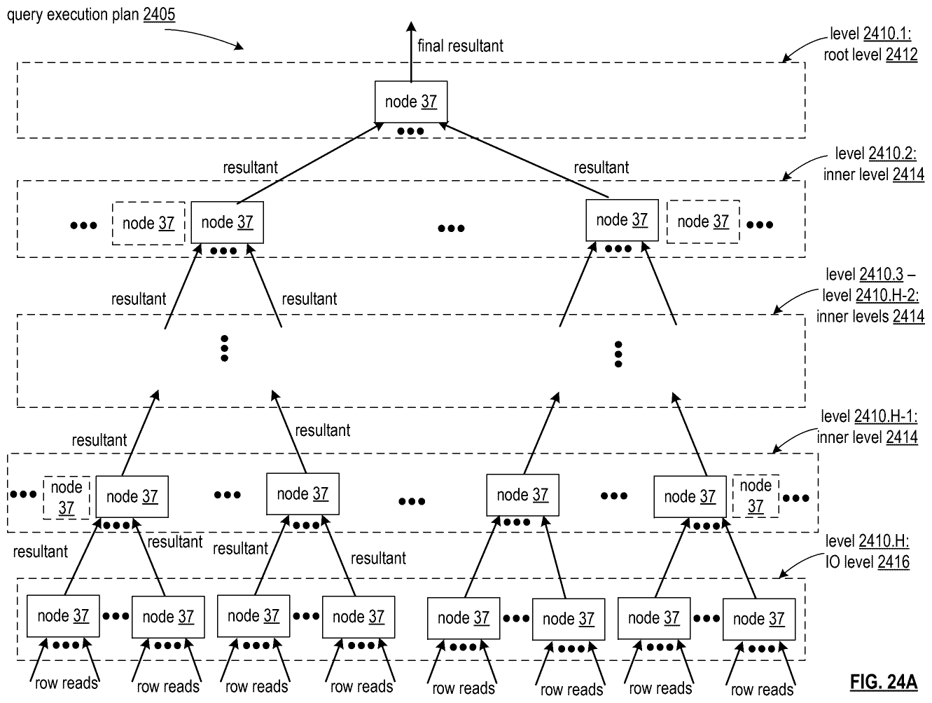

FIG. 22 illustrates an example of a segment structure for a segment of the segment group. The segment structure for a segment includes the data & parity section, a manifest section, one or more index sections, and a statistics section. The segment structure represents a storage mapping of the data (e.g., data slabs and parity data) of a segment and associated data (e.g., metadata, statistics, key column(s), etc.) regarding the data of the segment. The sorted data slabs of FIG. 16 of the segment are stored in the data & parity section of the segment structure. The sorted data slabs are stored in the data & parity section in a compressed format or as raw data (i.e., non-compressed format). Note that a segment structure has a particular data size (e.g., 32 Giga-Bytes) and data is stored within coding block sizes (e.g., 4 Kilo-Bytes).

Before the sorted data slabs are stored in the data & parity section, or concurrently with storing in the data & parity section, the sorted data slabs of a segment are redundancy encoded. The redundancy encoding may be done in a variety of ways. For example, the redundancy encoding is in accordance with RAID 5, RAID 6, or RAID 10. As another example, the redundancy encoding is a form of forward error encoding (e.g., Reed Solomon, Trellis, etc.). As another example, the redundancy encoding utilizes an erasure coding scheme.

The manifest section stores metadata regarding the sorted data slabs. The metadata includes one or more of, but is not limited to, descriptive metadata, structural metadata, and/or administrative metadata. Descriptive metadata includes one or more of, but is not limited to, information regarding data such as name, an abstract, keywords, author, etc. Structural metadata includes one or more of, but is not limited to, structural features of the data such as page size, page ordering, formatting, compression information, redundancy encoding information, logical addressing information, physical addressing information, physical to logical addressing information, etc. Administrative metadata includes one or more of, but is not limited to, information that aids in managing data such as file type, access privileges, rights management, preservation of the data, etc.

The key column is stored in an index section. For example, a first key column is stored in index #0. If a second key column exists, it is stored in index #1. As such, for each key column, it is stored in its own index section. Alternatively, one or more key columns are stored in a single index section.

The statistics section stores statistical information regarding the segment and/or the segment group. The statistical information includes one or more of, but is not limited, to number of rows (e.g., data values) in one or more of the sorted data slabs, average length of one or more of the sorted data slabs, average row size (e.g., average size of a data value), etc. The statistical information includes information regarding raw data slabs, raw parity data, and/or compressed data slabs and parity data.

FIG. 23 illustrates the segment structures for each segment of a segment group having five segments. Each segment includes a data & parity section, a manifest section, one or more index sections, and a statistic section. Each segment is targeted for storage in a different computing device of a storage cluster. The number of segments in the segment group corresponds to the number of computing devices in a storage cluster. In this example, there are five computing devices in a storage cluster. Other examples include more or less than five computing devices in a storage cluster.

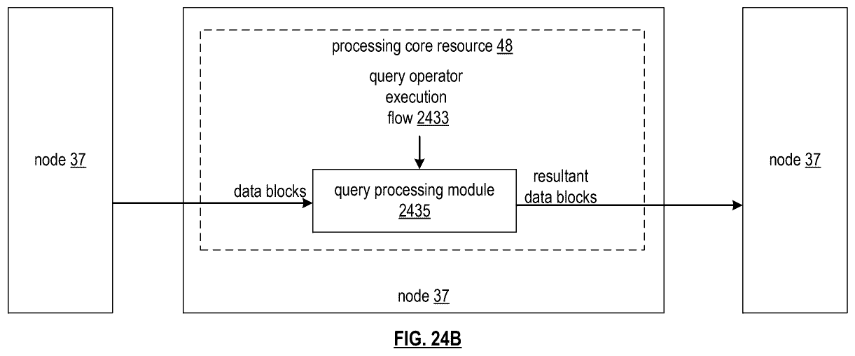

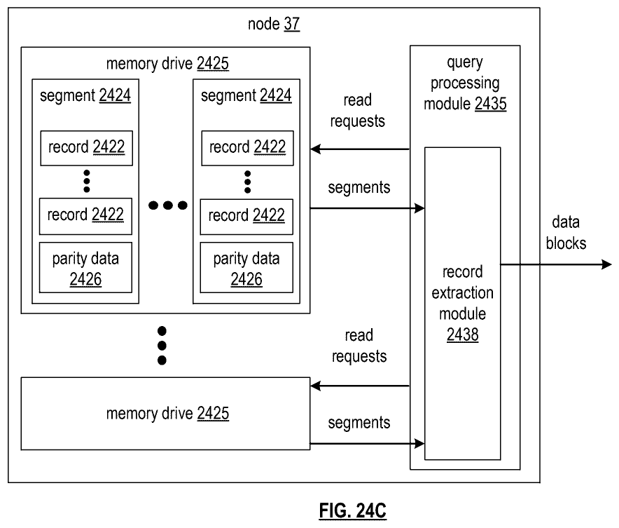

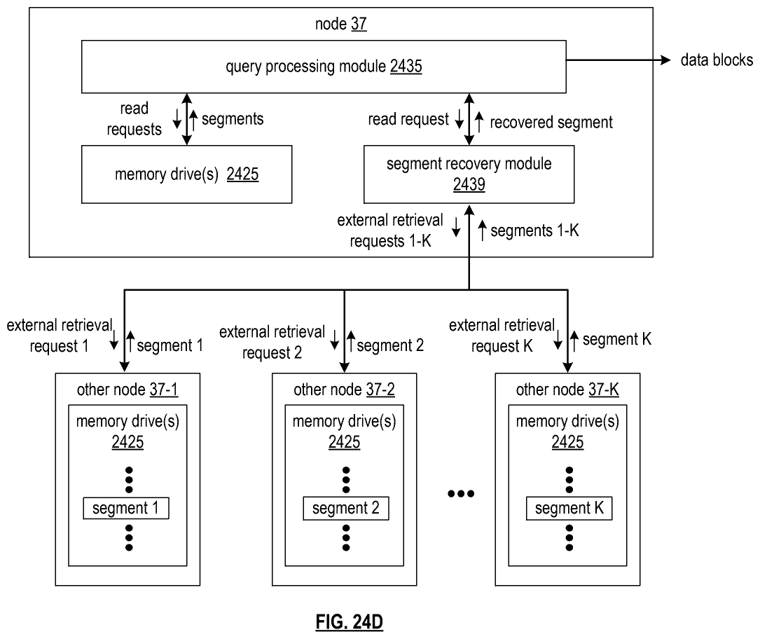

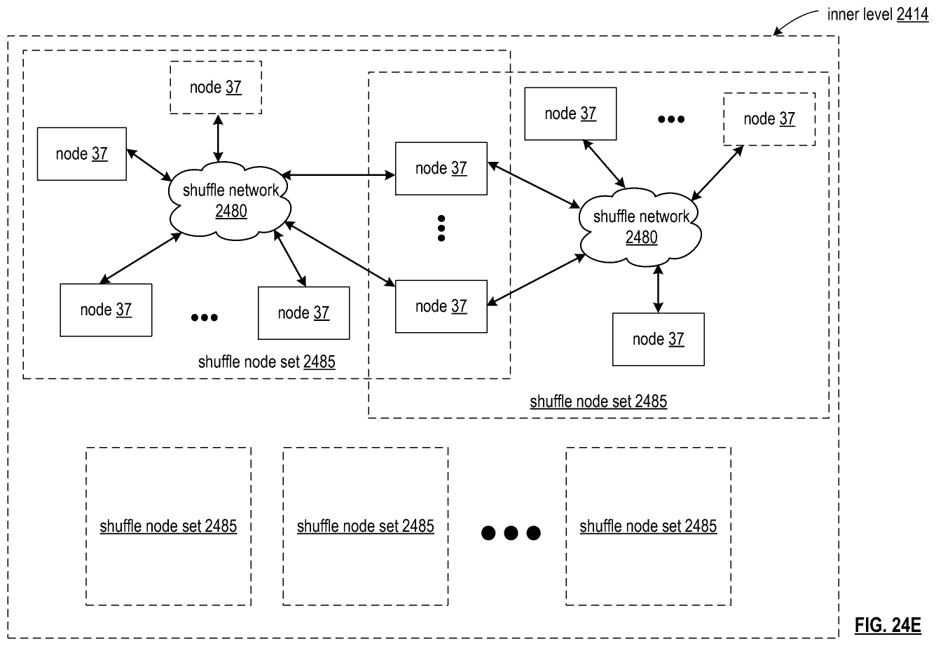

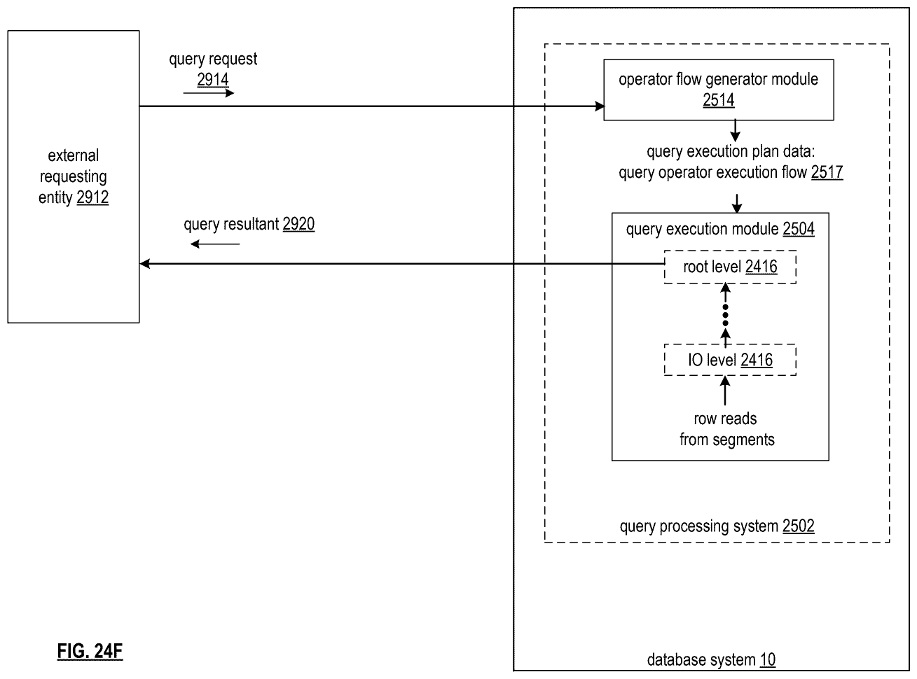

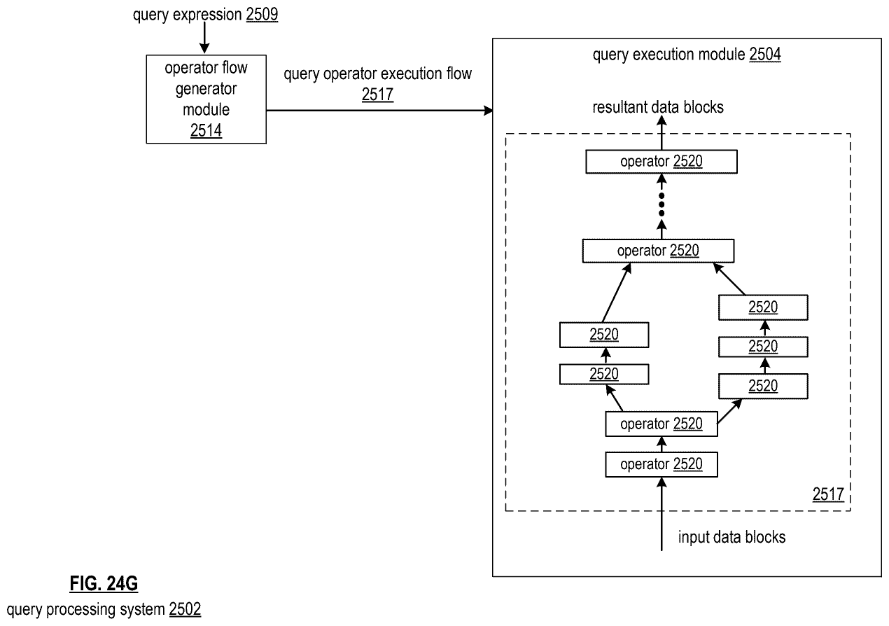

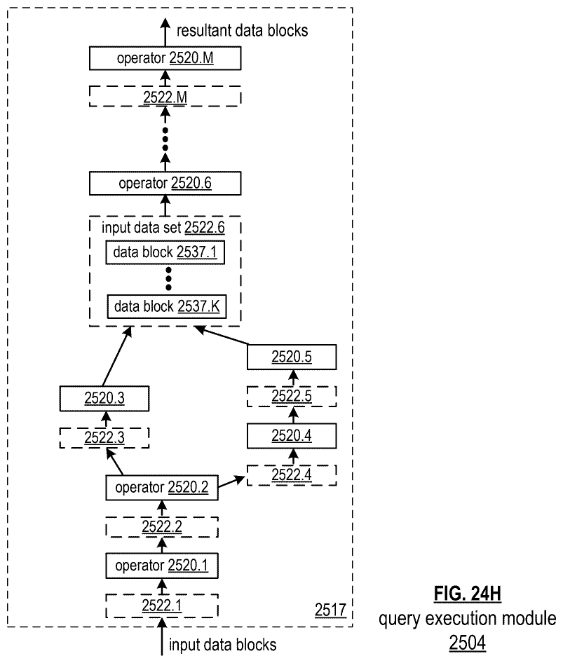

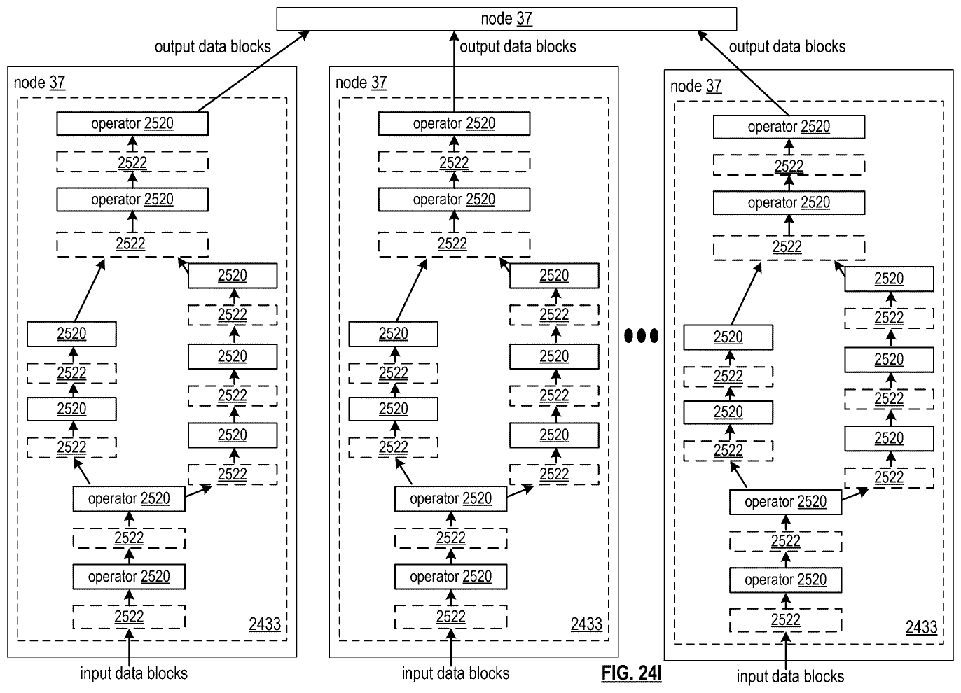

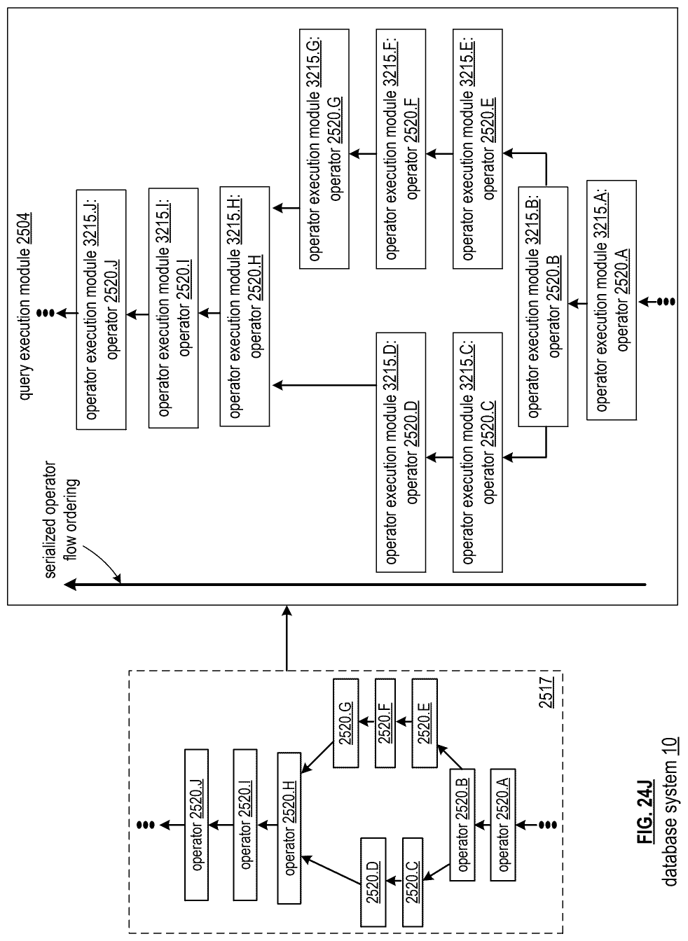

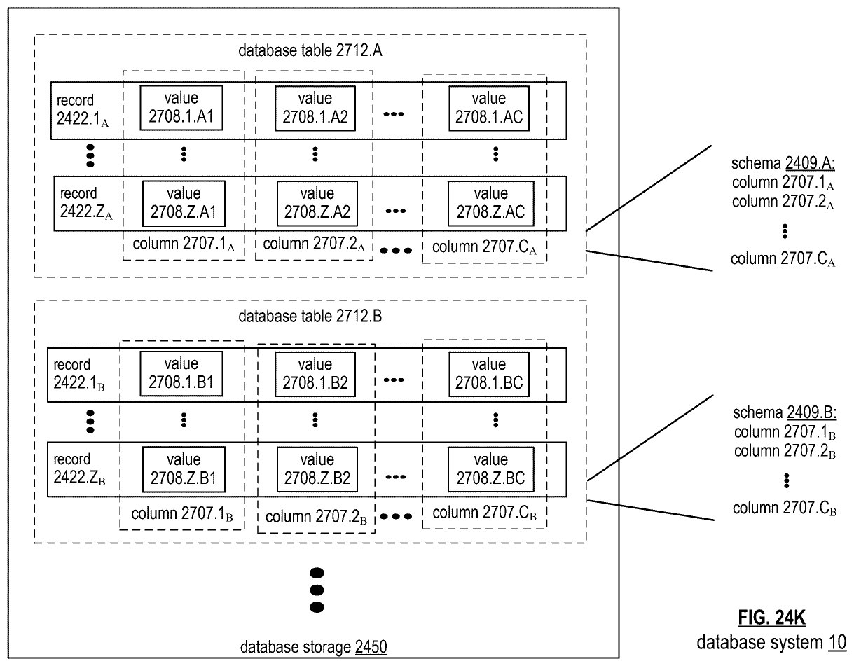

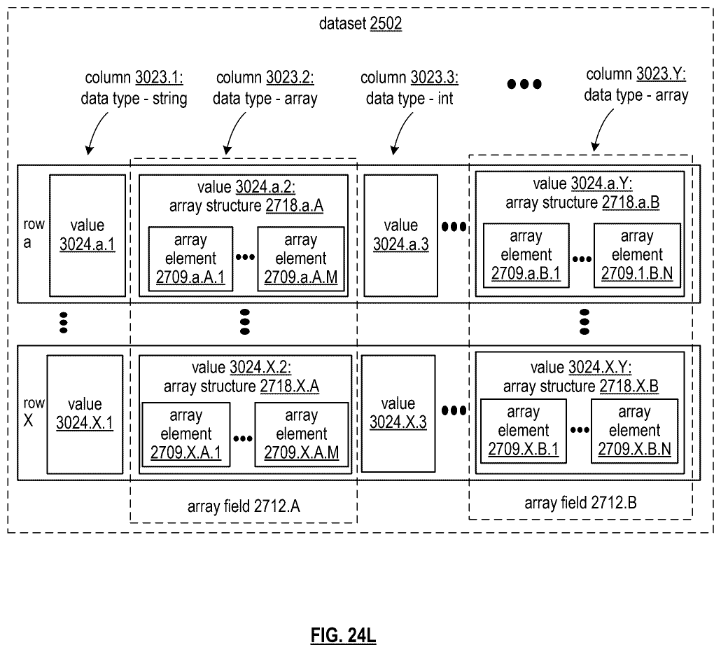

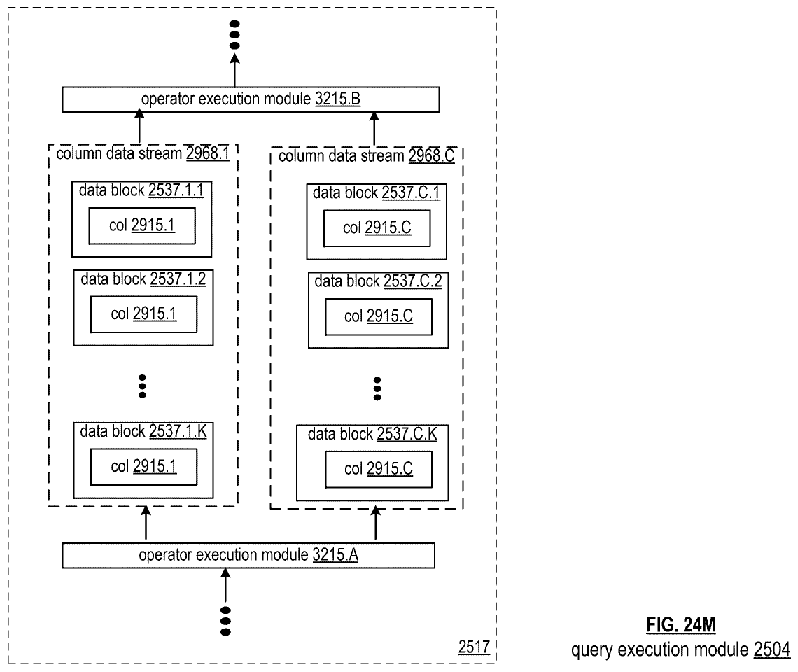

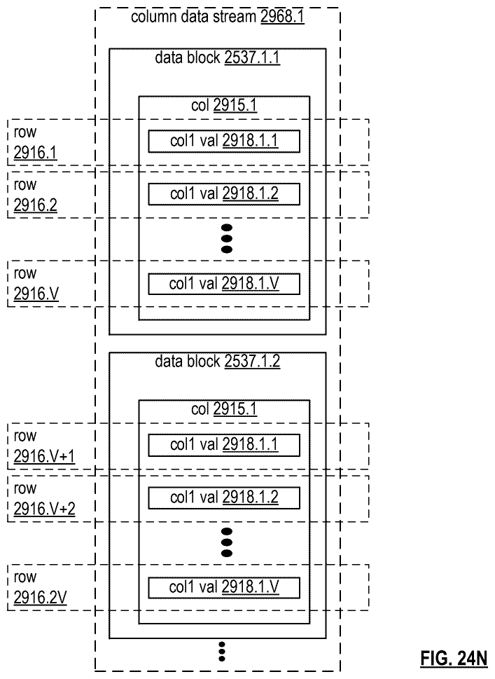

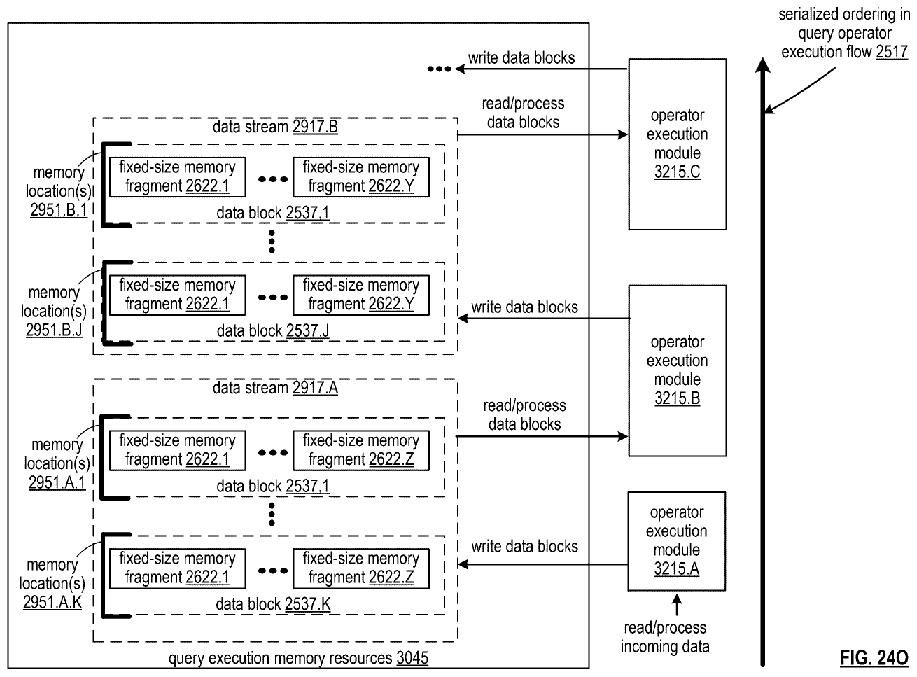

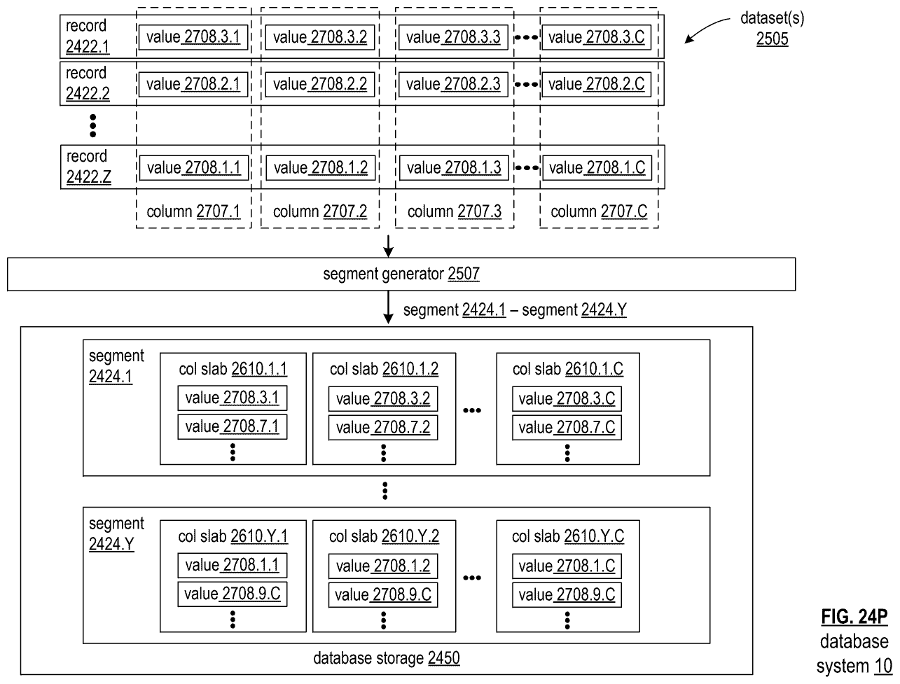

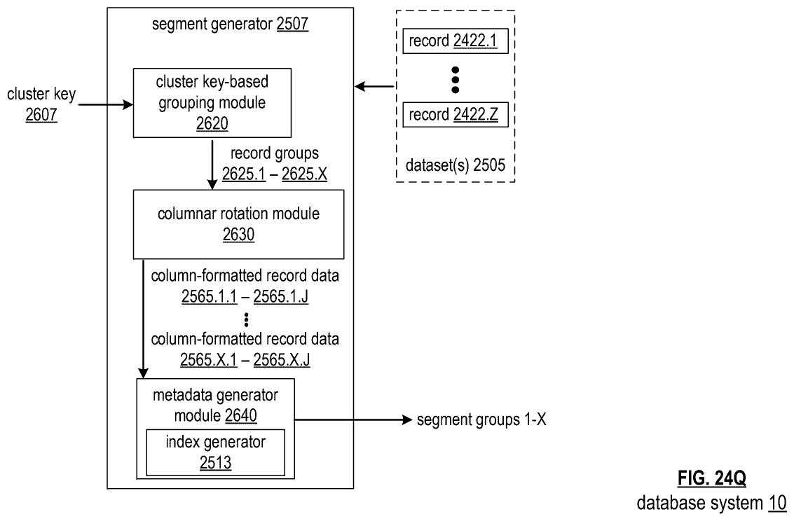

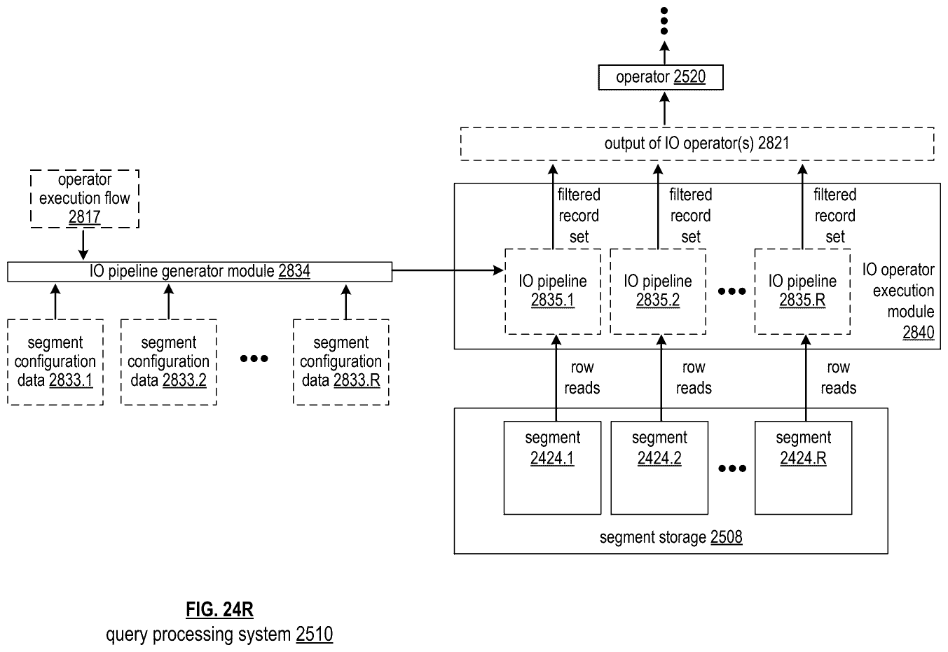

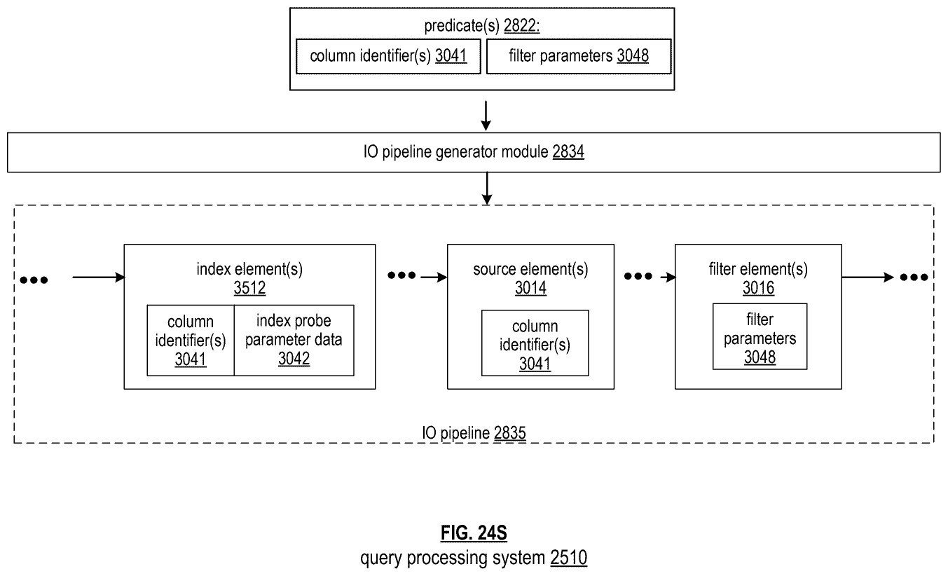

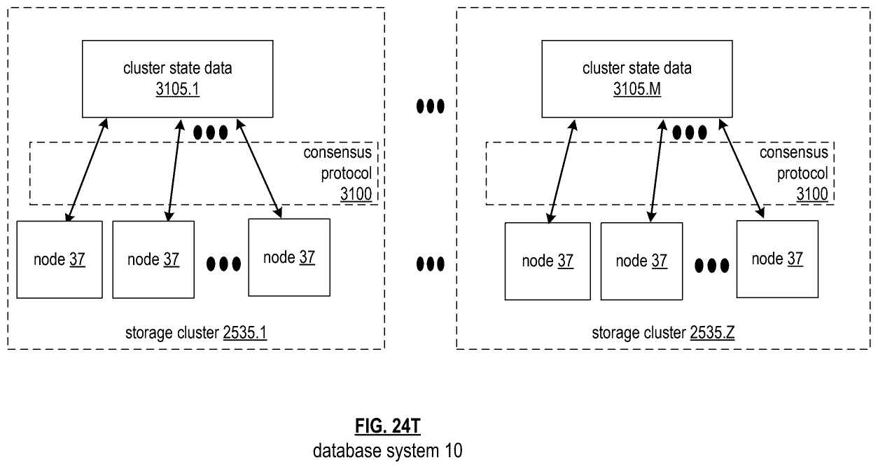

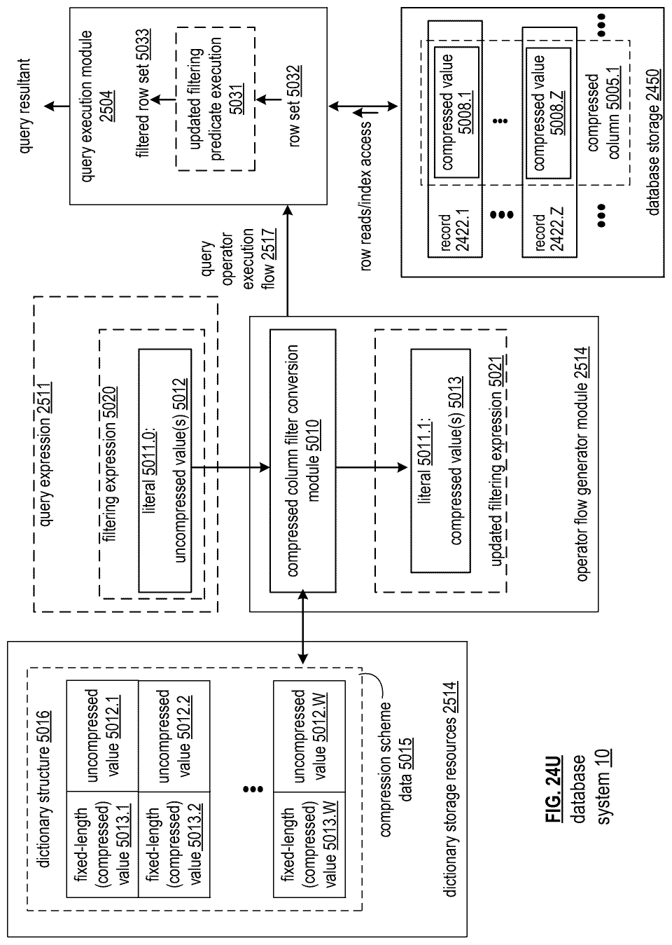

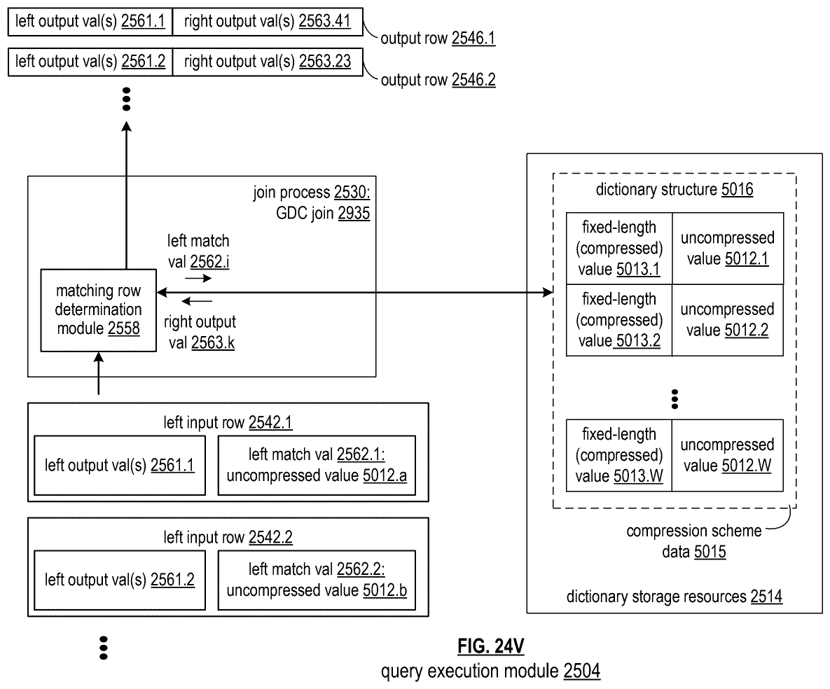

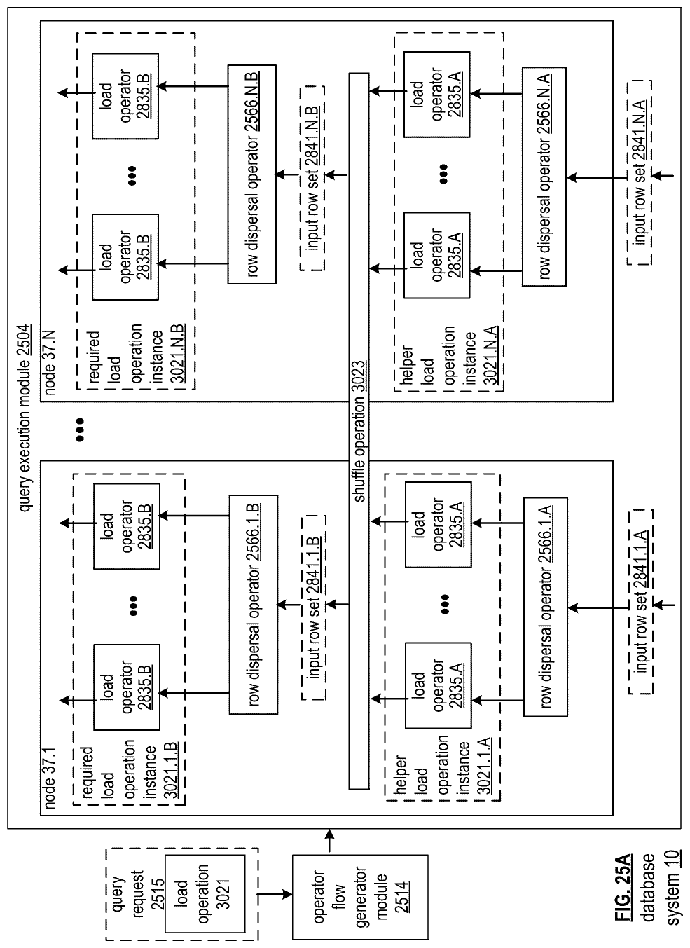

FIG. 24A illustrates an example of a query execution plan 2405 implemented by the database system 10 to execute one or more queries by utilizing a plurality of nodes 37. Each node 37 can be utilized to implement some or all of the plurality of nodes 37 of some or all computing devices 18-1-18-n, for example, of the of the parallelized data store, retrieve, and/or process sub-system 12, and/or of the parallelized query and results sub-system 13. The query execution plan can include a plurality of levels 2410. In this example, a plurality of H levels in a corresponding tree structure of the query execution plan 2405 are included. The plurality of levels can include a top, root level 2412; a bottom, IO level 2416, and one or more inner levels 2414. In some embodiments, there is exactly one inner level 2414, resulting in a tree of exactly three levels 2410.1, 2410.2, and 2410.3, where level 2410.H corresponds to level 2410.3. In such embodiments, level 2410.2 is the same as level 2410.H−1, and there are no other inner levels 2410.3-2410.H−2. Alternatively, any number of multiple inner levels 2414 can be implemented to result in a tree with more than three levels.

This illustration of query execution plan 2405 illustrates the flow of execution of a given query by utilizing a subset of nodes across some or all of the levels 2410. In this illustration, nodes 37 with a solid outline are nodes involved in executing a given query. Nodes 37 with a dashed outline are other possible nodes that are not involved in executing the given query, but could be involved in executing other queries in accordance with their level of the query execution plan in which they are included.

Each of the nodes of IO level 2416 can be operable to, for a given query, perform the necessary row reads for gathering corresponding rows of the query. These row reads can correspond to the segment retrieval to read some or all of the rows of retrieved segments determined to be required for the given query. Thus, the nodes 37 in level 2416 can include any nodes 37 operable to retrieve segments for query execution from its own storage or from storage by one or more other nodes; to recover segment for query execution via other segments in the same segment grouping by utilizing the redundancy error encoding scheme; and/or to determine which exact set of segments is assigned to the node for retrieval to ensure queries are executed correctly.

IO level 2416 can include all nodes in a given storage cluster 35 and/or can include some or all nodes in multiple storage clusters 35, such as all nodes in a subset of the storage clusters 35-1-35-z and/or all nodes in all storage clusters 35-1-35-z. For example, all nodes 37 and/or all currently available nodes 37 of the database system 10 can be included in level 2416. As another example, IO level 2416 can include a proper subset of nodes in the database system, such as some or all nodes that have access to stored segments and/or that are included in a segment set. In some cases, nodes 37 that do not store segments included in segment sets, that do not have access to stored segments, and/or that are not operable to perform row reads are not included at the IO level, but can be included at one or more inner levels 2414 and/or root level 2412.

The query executions discussed herein by nodes in accordance with executing queries at level 2416 can include retrieval of segments; extracting some or all necessary rows from the segments with some or all necessary columns; and sending these retrieved rows to a node at the next level 2410.H−1 as the query resultant generated by the node 37. For each node 37 at IO level 2416, the set of raw rows retrieved by the node 37 can be distinct from rows retrieved from all other nodes, for example, to ensure correct query execution. The total set of rows and/or corresponding columns retrieved by nodes 37 in the IO level for a given query can be dictated based on the domain of the given query, such as one or more tables indicated in one or more SELECT statements of the query, and/or can otherwise include all data blocks that are necessary to execute the given query.

Each inner level 2414 can include a subset of nodes 37 in the database system 10. Each level 2414 can include a distinct set of nodes 37 and/or some or more levels 2414 can include overlapping sets of nodes 37. The nodes 37 at inner levels are implemented, for each given query, to execute queries in conjunction with operators for the given query. For example, a query operator execution flow can be generated for a given incoming query, where an ordering of execution of its operators is determined, and this ordering is utilized to assign one or more operators of the query operator execution flow to each node in a given inner level 2414 for execution. For example, each node at a same inner level can be operable to execute a same set of operators for a given query, in response to being selected to execute the given query, upon incoming resultants generated by nodes at a directly lower level to generate its own resultants sent to a next higher level. In particular, each node at a same inner level can be operable to execute a same portion of a same query operator execution flow for a given query. In cases where there is exactly one inner level, each node selected to execute a query at a given inner level performs some or all of the given query's operators upon the raw rows received as resultants from the nodes at the IO level, such as the entire query operator execution flow and/or the portion of the query operator execution flow performed upon data that has already been read from storage by nodes at the IO level. In some cases, some operators beyond row reads are also performed by the nodes at the IO level. Each node at a given inner level 2414 can further perform a gather function to collect, union, and/or aggregate resultants sent from a previous level, for example, in accordance with one or more corresponding operators of the given query.

The root level 2412 can include exactly one node for a given query that gathers resultants from every node at the top-most inner level 2414. The node 37 at root level 2412 can perform additional query operators of the query and/or can otherwise collect, aggregate, and/or union the resultants from the top-most inner level 2414 to generate the final resultant of the query, which includes the resulting set of rows and/or one or more aggregated values, in accordance with the query, based on being performed on all rows required by the query. The root level node can be selected from a plurality of possible root level nodes, where different root nodes are selected for different queries. Alternatively, the same root node can be selected for all queries.

As depicted in FIG. 24A, resultants are sent by nodes upstream with respect to the tree structure of the query execution plan as they are generated, where the root node generates a final resultant of the query. While not depicted in FIG. 24A, nodes at a same level can share data and/or send resultants to each other, for example, in accordance with operators of the query at this same level dictating that data is sent between nodes.

In some cases, the IO level 2416 always includes the same set of nodes 37, such as a full set of nodes and/or all nodes that are in a storage cluster 35 that stores data required to process incoming queries. In some cases, the lowest inner level corresponding to level 2410.H−1 includes at least one node from the IO level 2416 in the possible set of nodes. In such cases, while each selected node in level 2410.H−1 is depicted to process resultants sent from other nodes 37 in FIG. 24A, each selected node in level 2410.H−1 that also operates as a node at the IO level further performs its own row reads in accordance with its query execution at the IO level, and gathers the row reads received as resultants from other nodes at the IO level with its own row reads for processing via operators of the query. One or more inner levels 2414 can also include nodes that are not included in IO level 2416, such as nodes 37 that do not have access to stored segments and/or that are otherwise not operable and/or selected to perform row reads for some or all queries.

The node 37 at root level 2412 can be fixed for all queries, where the set of possible nodes at root level 2412 includes only one node that executes all queries at the root level of the query execution plan. Alternatively, the root level 2412 can similarly include a set of possible nodes, where one node selected from this set of possible nodes for each query and where different nodes are selected from the set of possible nodes for different queries. In such cases, the nodes at inner level 2410.2 determine which of the set of possible root nodes to send their resultant to. In some cases, the single node or set of possible nodes at root level 2412 is a proper subset of the set of nodes at inner level 2410.2, and/or is a proper subset of the set of nodes at the IO level 2416. In cases where the root node is included at inner level 2410.2, the root node generates its own resultant in accordance with inner level 2410.2, for example, based on multiple resultants received from nodes at level 2410.3, and gathers its resultant that was generated in accordance with inner level 2410.2 with other resultants received from nodes at inner level 2410.2 to ultimately generate the final resultant in accordance with operating as the root level node.

In some cases where nodes are selected from a set of possible nodes at a given level for processing a given query, the selected node must have been selected for processing this query at each lower level of the query execution tree. For example, if a particular node is selected to process a node at a particular inner level, it must have processed the query to generate resultants at every lower inner level and the IO level. In such cases, each selected node at a particular level will always use its own resultant that was generated for processing at the previous, lower level, and will gather this resultant with other resultants received from other child nodes at the previous, lower level. Alternatively, nodes that have not yet processed a given query can be selected for processing at a particular level, where all resultants being gathered are therefore received from a set of child nodes that do not include the selected node.

The configuration of query execution plan 2405 for a given query can be determined in a downstream fashion, for example, where the tree is formed from the root downwards. Nodes at corresponding levels are determined from configuration information received from corresponding parent nodes and/or nodes at higher levels, and can each send configuration information to other nodes, such as their own child nodes, at lower levels until the lowest level is reached. This configuration information can include assignment of a particular subset of operators of the set of query operators that each level and/or each node will perform for the query. The execution of the query is performed upstream in accordance with the determined configuration, where IO reads are performed first, and resultants are forwarded upwards until the root node ultimately generates the query result.

Some or all features and/or functionality of FIG. 24A can be performed via at least one node 37 in conjunction with system metadata applied across a plurality of nodes 37, for example, where at least one node 37 participates in some or all features and/or functionality of FIG. 24A based on receiving and storing the system metadata in local memory of the at least one node 37 as configuration data and/or based on further accessing and/or executing this configuration data to participate in a query execution plan of FIG. 24A as part of its database functionality accordingly. Performance of some or all features and/or functionality of FIG. 24A can optionally change and/or be updated over time, and/or a set of nodes participating in executing some or all features and/or functionality of FIG. 24A can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24B illustrates an embodiment of a node 37 executing a query in accordance with the query execution plan 2405 by implementing a query processing module 2435. The query processing module 2435 can be operable to execute a query operator execution flow 2433 determined by the node 37, where the query operator execution flow 2433 corresponds to the entirety of processing of the query upon incoming data assigned to the corresponding node 37 in accordance with its role in the query execution plan 2405. This embodiment of node 37 that utilizes a query processing module 2435 can be utilized to implement some or all of the plurality of nodes 37 of some or all computing devices 18-1-18-n, for example, of the of the parallelized data store, retrieve, and/or process sub-system 12, and/or of the parallelized query and results sub-system 13.

As used herein, execution of a particular query by a particular node 37 can correspond to the execution of the portion of the particular query assigned to the particular node in accordance with full execution of the query by the plurality of nodes involved in the query execution plan 2405. This portion of the particular query assigned to a particular node can correspond to execution plurality of operators indicated by a query operator execution flow 2433. In particular, the execution of the query for a node 37 at an inner level 2414 and/or root level 2412 corresponds to generating a resultant by processing all incoming resultants received from nodes at a lower level of the query execution plan 2405 that send their own resultants to the node 37. The execution of the query for a node 37 at the IO level corresponds to generating all resultant data blocks by retrieving and/or recovering all segments assigned to the node 37.

Thus, as used herein, a node 37's full execution of a given query corresponds to only a portion of the query's execution across all nodes in the query execution plan 2405. In particular, a resultant generated by an inner level node 37's execution of a given query may correspond to only a portion of the entire query result, such as a subset of rows in a final result set, where other nodes generate their own resultants to generate other portions of the full resultant of the query. In such embodiments, a plurality of nodes at this inner level can fully execute queries on different portions of the query domain independently in parallel by utilizing the same query operator execution flow 2433. Resultants generated by each of the plurality of nodes at this inner level 2414 can be gathered into a final result of the query, for example, by the node 37 at root level 2412 if this inner level is the top-most inner level 2414 or the only inner level 2414. As another example, resultants generated by each of the plurality of nodes at this inner level 2414 can be further processed via additional operators of a query operator execution flow 2433 being implemented by another node at a consecutively higher inner level 2414 of the query execution plan 2405, where all nodes at this consecutively higher inner level 2414 all execute their own same query operator execution flow 2433.

As discussed in further detail herein, the resultant generated by a node 37 can include a plurality of resultant data blocks generated via a plurality of partial query executions. As used herein, a partial query execution performed by a node corresponds to generating a resultant based on only a subset of the query input received by the node 37. In particular, the query input corresponds to all resultants generated by one or more nodes at a lower level of the query execution plan that send their resultants to the node. However, this query input can correspond to a plurality of input data blocks received over time, for example, in conjunction with the one or more nodes at the lower level processing their own input data blocks received over time to generate their resultant data blocks sent to the node over time. Thus, the resultant generated by a node's full execution of a query can include a plurality of resultant data blocks, where each resultant data block is generated by processing a subset of all input data blocks as a partial query execution upon the subset of all data blocks via the query operator execution flow 2433.

As illustrated in FIG. 24B, the query processing module 2435 can be implemented by a single processing core resource 48 of the node 37. In such embodiments, each one of the processing core resources 48-1-48-n of a same node 37 can be executing at least one query concurrently via their own query processing module 2435, where a single node 37 implements each of set of operator processing modules 2435-1-2435-n via a corresponding one of the set of processing core resources 48-1-48-n. A plurality of queries can be concurrently executed by the node 37, where each of its processing core resources 48 can each independently execute at least one query within a same temporal period by utilizing a corresponding at least one query operator execution flow 2433 to generate at least one query resultant corresponding to the at least one query.

Some or all features and/or functionality of FIG. 24B can be performed via a corresponding node 37 in conjunction with system metadata applied across a plurality of nodes 37 that includes the given node, for example, where the given node 37 participates in some or all features and/or functionality of FIG. 24B based on receiving and storing the system metadata in local memory of given node 37 as configuration data and/or based on further accessing and/or executing this configuration data to process data blocks via a query processing module as part of its database functionality accordingly. Performance of some or all features and/or functionality of FIG. 24B can optionally change and/or be updated over time, based on the system metadata applied across a plurality of nodes 37 that includes the given node being updated over time, and/or based on the given node updating its configuration data stored in local memory to reflect changes in the system metadata based on receiving data indicating these changes to the system metadata.

FIG. 24C illustrates a particular example of a node 37 at the IO level 2416 of the query execution plan 2405 of FIG. 24A. A node 37 can utilize its own memory resources, such as some or all of its disk memory 38 and/or some or all of its main memory 40 to implement at least one memory drive 2425 that stores a plurality of segments 2424. Memory drives 2425 of a node 37 can be implemented, for example, by utilizing disk memory 38 and/or main memory 40. In particular, a plurality of distinct memory drives 2425 of a node 37 can be implemented via the plurality of memory devices 42-1-42-n of the node 37's disk memory 38.

Each segment 2424 stored in memory drive 2425 can be generated as discussed previously in conjunction with FIGS. 15-23. A plurality of records 2422 can be included in and/or extractable from the segment, for example, where the plurality of records 2422 of a segment 2424 correspond to a plurality of rows designated for the particular segment 2424 prior to applying the redundancy storage coding scheme as illustrated in FIG. 17. The records 2422 can be included in data of segment 2424, for example, in accordance with a column-format and/or other structured format. Each segments 2424 can further include parity data 2426 as discussed previously to enable other segments 2424 in the same segment group to be recovered via applying a decoding function associated with the redundancy storage coding scheme, such as a RAID scheme and/or erasure coding scheme, that was utilized to generate the set of segments of a segment group.

Thus, in addition to performing the first stage of query execution by being responsible for row reads, nodes 37 can be utilized for database storage, and can each locally store a set of segments in its own memory drives 2425. In some cases, a node 37 can be responsible for retrieval of only the records stored in its own one or more memory drives 2425 as one or more segments 2424. Executions of queries corresponding to retrieval of records stored by a particular node 37 can be assigned to that particular node 37. In other embodiments, a node 37 does not use its own resources to store segments. A node 37 can access its assigned records for retrieval via memory resources of another node 37 and/or via other access to memory drives 2425, for example, by utilizing system communication resources 14.

The query processing module 2435 of the node 37 can be utilized to read the assigned by first retrieving or otherwise accessing the corresponding redundancy-coded segments 2424 that include the assigned records its one or more memory drives 2425. Query processing module 2435 can include a record extraction module 2438 that is then utilized to extract or otherwise read some or all records from these segments 2424 accessed in memory drives 2425, for example, where record data of the segment is segregated from other information such as parity data included in the segment and/or where this data containing the records is converted into row-formatted records from the column-formatted row data stored by the segment. Once the necessary records of a query are read by the node 37, the node can further utilize query processing module 2435 to send the retrieved records all at once, or in a stream as they are retrieved from memory drives 2425, as data blocks to the next node 37 in the query execution plan 2405 via system communication resources 14 or other communication channels.

Some or all features and/or functionality of FIG. 24C can be performed via a corresponding node 37 in conjunction with system metadata applied across a plurality of nodes 37 that includes the given node, for example, where the given node 37 participates in some or all features and/or functionality of FIG. 24C based on receiving and storing the system metadata in local memory of given node 37 as configuration data and/or based on further accessing and/or executing this configuration data to read segments and/or extract rows from segments via a query processing module as part of its database functionality accordingly. Performance of some or all features and/or functionality of FIG. 24C can optionally change and/or be updated over time, based on the system metadata applied across a plurality of nodes 37 that includes the given node being updated over time, and/or based on the given node updating its configuration data stored in local memory to reflect changes in the system metadata based on receiving data indicating these changes to the system metadata.

FIG. 24D illustrates an embodiment of a node 37 that implements a segment recovery module 2439 to recover some or all segments that are assigned to the node for retrieval, in accordance with processing one or more queries, that are unavailable. Some or all features of the node 37 of FIG. 24D can be utilized to implement the node 37 of FIGS. 24B and 24C, and/or can be utilized to implement one or more nodes 37 of the query execution plan 2405 of FIG. 24A, such as nodes 37 at the IO level 2416. A node 37 may store segments on one of its own memory drives 2425 that becomes unavailable, or otherwise determines that a segment assigned to the node for execution of a query is unavailable for access via a memory drive the node 37 accesses via system communication resources 14. The segment recovery module 2439 can be implemented via at least one processing module of the node 37, such as resources of central processing module 39. The segment recovery module 2439 can retrieve the necessary number of segments 1-K in the same segment group as an unavailable segment from other nodes 37, such as a set of other nodes 37-1-37-K that store segments in the same storage cluster 35. Using system communication resources 14 or other communication channels, a set of external retrieval requests 1-K for this set of segments 1-K can be sent to the set of other nodes 37-1-37-K, and the set of segments can be received in response. This set of K segments can be processed, for example, where a decoding function is applied based on the redundancy storage coding scheme utilized to generate the set of segments in the segment group and/or parity data of this set of K segments is otherwise utilized to regenerate the unavailable segment. The necessary records can then be extracted from the unavailable segment, for example, via the record extraction module 2438, and can be sent as data blocks to another node 37 for processing in conjunction with other records extracted from available segments retrieved by the node 37 from its own memory drives 2425.

Note that the embodiments of node 37 discussed herein can be configured to execute multiple queries concurrently by communicating with nodes 37 in the same or different tree configuration of corresponding query execution plans and/or by performing query operations upon data blocks and/or read records for different queries. In particular, incoming data blocks can be received from other nodes for multiple different queries in any interleaving order, and a plurality of operator executions upon incoming data blocks for multiple different queries can be performed in any order, where output data blocks are generated and sent to the same or different next node for multiple different queries in any interleaving order. IO level nodes can access records for the same or different queries any interleaving order. Thus, at a given point in time, a node 37 can have already begun its execution of at least two queries, where the node 37 has also not yet completed its execution of the at least two queries.

A query execution plan 2405 can guarantee query correctness based on assignment data sent to or otherwise communicated to all nodes at the IO level ensuring that the set of required records in query domain data of a query, such as one or more tables required to be accessed by a query, are accessed exactly one time: if a particular record is accessed multiple times in the same query and/or is not accessed, the query resultant cannot be guaranteed to be correct. Assignment data indicating segment read and/or record read assignments to each of the set of nodes 37 at the IO level can be generated, for example, based on being mutually agreed upon by all nodes 37 at the IO level via a consensus protocol executed between all nodes at the IO level and/or distinct groups of nodes 37 such as individual storage clusters 35. The assignment data can be generated such that every record in the database system and/or in query domain of a particular query is assigned to be read by exactly one node 37. Note that the assignment data may indicate that a node 37 is assigned to read some segments directly from memory as illustrated in FIG. 24C and is assigned to recover some segments via retrieval of segments in the same segment group from other nodes 37 and via applying the decoding function of the redundancy storage coding scheme as illustrated in FIG. 24D.

Assuming all nodes 37 read all required records and send their required records to exactly one next node 37 as designated in the query execution plan 2405 for the given query, the use of exactly one instance of each record can be guaranteed. Assuming all inner level nodes 37 process all the required records received from the corresponding set of nodes 37 in the IO level 2416, via applying one or more query operators assigned to the node in accordance with their query operator execution flow 2433, correctness of their respective partial resultants can be guaranteed. This correctness can further require that nodes 37 at the same level intercommunicate by exchanging records in accordance with JOIN operations as necessary, as records received by other nodes may be required to achieve the appropriate result of a JOIN operation. Finally, assuming the root level node receives all correctly generated partial resultants as data blocks from its respective set of nodes at the penultimate, highest inner level 2414 as designated in the query execution plan 2405, and further assuming the root level node appropriately generates its own final resultant, the correctness of the final resultant can be guaranteed.

In some embodiments, each node 37 in the query execution plan can monitor whether it has received all necessary data blocks to fulfill its necessary role in completely generating its own resultant to be sent to the next node 37 in the query execution plan. A node 37 can determine receipt of a complete set of data blocks that was sent from a particular node 37 at an immediately lower level, for example, based on being numbered and/or have an indicated ordering in transmission from the particular node 37 at the immediately lower level, and/or based on a final data block of the set of data blocks being tagged in transmission from the particular node 37 at the immediately lower level to indicate it is a final data block being sent. A node 37 can determine the required set of lower level nodes from which it is to receive data blocks based on its knowledge of the query execution plan 2405 of the query. A node 37 can thus conclude when a complete set of data blocks has been received each designated lower level node in the designated set as indicated by the query execution plan 2405. This node 37 can therefore determine itself that all required data blocks have been processed into data blocks sent by this node 37 to the next node 37 and/or as a final resultant if this node 37 is the root node. This can be indicated via tagging of its own last data block, corresponding to the final portion of the resultant generated by the node, where it is guaranteed that all appropriate data was received and processed into the set of data blocks sent by this node 37 in accordance with applying its own query operator execution flow 2433.

In some embodiments, if any node 37 determines it did not receive all of its required data blocks, the node 37 itself cannot fulfill generation of its own set of required data blocks. For example, the node 37 will not transmit a final data block tagged as the “last” data block in the set of outputted data blocks to the next node 37, and the next node 37 will thus conclude there was an error and will not generate a full set of data blocks itself. The root node, and/or these intermediate nodes that never received all their data and/or never fulfilled their generation of all required data blocks, can independently determine the query was unsuccessful. In some cases, the root node, upon determining the query was unsuccessful, can initiate re-execution of the query by re-establishing the same or different query execution plan 2405 in a downward fashion as described previously, where the nodes 37 in this re-established query execution plan 2405 execute the query accordingly as though it were a new query. For example, in the case of a node failure that caused the previous query to fail, the new query execution plan 2405 can be generated to include only available nodes where the node that failed is not included in the new query execution plan 2405.

Some or all features and/or functionality of FIG. 24D can be performed via a corresponding node 37 in conjunction with system metadata applied across a plurality of nodes 37 that includes the given node, for example, where the given node 37 participates in some or all features and/or functionality of FIG. 24D based on receiving and storing the system metadata in local memory of given node 37 as configuration data and/or based on further accessing and/or executing this configuration data to recover segments via external retrieval requests and performing a rebuilding process upon corresponding segments as part of its database functionality accordingly. Performance of some or all features and/or functionality of FIG. 24D can optionally change and/or be updated over time, based on the system metadata applied across a plurality of nodes 37 that includes the given node being updated over time, and/or based on the given node updating its configuration data stored in local memory to reflect changes in the system metadata based on receiving data indicating these changes to the system metadata.

FIG. 24E illustrates an embodiment of an inner level 2414 that includes at least one shuffle node set 2485 of the plurality of nodes assigned to the corresponding inner level. A shuffle node set 2485 can include some or all of a plurality of nodes assigned to the corresponding inner level, where all nodes in the shuffle node set 2485 are assigned to the same inner level. In some cases, a shuffle node set 2485 can include nodes assigned to different levels 2410 of a query execution plan. A shuffle node set 2485 at a given time can include some nodes that are assigned to the given level, but are not participating in a query at that given time, as denoted with dashed outlines and as discussed in conjunction with FIG. 24A. For example, while a given one or more queries are being executed by nodes in the database system 10, a shuffle node set 2485 can be static, regardless of whether all of its members are participating in a given query at that time. In other cases, shuffle node set 2485 only includes nodes assigned to participate in a corresponding query, where different queries that are concurrently executing and/or executing in distinct time periods have different shuffle node sets 2485 based on which nodes are assigned to participate in the corresponding query execution plan. While FIG. 24E depicts multiple shuffle node sets 2485 of an inner level 2414, in some cases, an inner level can include exactly one shuffle node set, for example, that includes all possible nodes of the corresponding inner level 2414 and/or all participating nodes of the of the corresponding inner level 2414 in a given query execution plan.

While FIG. 24E depicts that different shuffle node sets 2485 can have overlapping nodes 37, in some cases, each shuffle node set 2485 includes a distinct set of nodes, for example, where the shuffle node sets 2485 are mutually exclusive. In some cases, the shuffle node sets 2485 are collectively exhaustive with respect to the corresponding inner level 2414, where all possible nodes of the inner level 2414, or all participating nodes of a given query execution plan at the inner level 2414, are included in at least one shuffle node set 2485 of the inner level 2414. If the query execution plan has multiple inner levels 2414, each inner level can include one or more shuffle node sets 2485. In some cases, a shuffle node set 2485 can include nodes from different inner levels 2414, or from exactly one inner level 2414. In some cases, the root level 2412 and/or the IO level 2416 have nodes included in shuffle node sets 2485. In some cases, the query execution plan 2405 includes and/or indicates assignment of nodes to corresponding shuffle node sets 2485 in addition to assigning nodes to levels 2410, where nodes 37 determine their participation in a given query as participating in one or more levels 2410 and/or as participating in one or more shuffle node sets 2485, for example, via downward propagation of this information from the root node to initiate the query execution plan 2405 as discussed previously.

The shuffle node sets 2485 can be utilized to enable transfer of information between nodes, for example, in accordance with performing particular operations in a given query that cannot be performed in isolation. For example, some queries require that nodes 37 receive data blocks from its children nodes in the query execution plan for processing, and that the nodes 37 additionally receive data blocks from other nodes at the same level 2410. In particular, query operations such as JOIN operations of a SQL query expression may necessitate that some or all additional records that were access in accordance with the query be processed in tandem to guarantee a correct resultant, where a node processing only the records retrieved from memory by its child IO nodes is not sufficient.

In some cases, a given node 37 participating in a given inner level 2414 of a query execution plan may send data blocks to some or all other nodes participating in the given inner level 2414, where these other nodes utilize these data blocks received from the given node to process the query via their query processing module 2435 by applying some or all operators of their query operator execution flow 2433 to the data blocks received from the given node. In some cases, a given node 37 participating in a given inner level 2414 of a query execution plan may receive data blocks to some or all other nodes participating in the given inner level 2414, where the given node utilizes these data blocks received from the other nodes to process the query via their query processing module 2435 by applying some or all operators of their query operator execution flow 2433 to the received data blocks.

This transfer of data blocks can be facilitated via a shuffle network 2480 of a corresponding shuffle node set 2485. Nodes in a shuffle node set 2485 can exchange data blocks in accordance with executing queries, for example, for execution of particular operators such as JOIN operators of their query operator execution flow 2433 by utilizing a corresponding shuffle network 2480. The shuffle network 2480 can correspond to any wired and/or wireless communication network that enables bidirectional communication between any nodes 37 communicating with the shuffle network 2480. In some cases, the nodes in a same shuffle node set 2485 are operable to communicate with some or all other nodes in the same shuffle node set 2485 via a direct communication link of shuffle network 2480, for example, where data blocks can be routed between some or all nodes in a shuffle network 2480 without necessitating any relay nodes 37 for routing the data blocks. In some cases, the nodes in a same shuffle set can broadcast data blocks.

In some cases, some nodes in a same shuffle node set 2485 do not have direct links via shuffle network 2480 and/or cannot send or receive broadcasts via shuffle network 2480 to some or all other nodes 37. For example, at least one pair of nodes in the same shuffle node set cannot communicate directly. In some cases, some pairs of nodes in a same shuffle node set can only communicate by routing their data via at least one relay node 37. For example, two nodes in a same shuffle node set do not have a direct communication link and/or cannot communicate via broadcasting their data blocks. However, if these two nodes in a same shuffle node set can each communicate with a same third node via corresponding direct communication links and/or via broadcast, this third node can serve as a relay node to facilitate communication between the two nodes. Nodes that are “further apart” in the shuffle network 2480 may require multiple relay nodes.

Thus, the shuffle network 2480 can facilitate communication between all nodes 37 in the corresponding shuffle node set 2485 by utilizing some or all nodes 37 in the corresponding shuffle node set 2485 as relay nodes, where the shuffle network 2480 is implemented by utilizing some or all nodes in the nodes shuffle node set 2485 and a corresponding set of direct communication links between pairs of nodes in the shuffle node set 2485 to facilitate data transfer between any pair of nodes in the shuffle node set 2485. Note that these relay nodes facilitating data blocks for execution of a given query within a shuffle node sets 2485 to implement shuffle network 2480 can be nodes participating in the query execution plan of the given query and/or can be nodes that are not participating in the query execution plan of the given query. In some cases, these relay nodes facilitating data blocks for execution of a given query within a shuffle node sets 2485 are strictly nodes participating in the query execution plan of the given query. In some cases, these relay nodes facilitating data blocks for execution of a given query within a shuffle node sets 2485 are strictly nodes that are not participating in the query execution plan of the given query.

Different shuffle node sets 2485 can have different shuffle networks 2480. These different shuffle networks 2480 can be isolated, where nodes only communicate with other nodes in the same shuffle node sets 2485 and/or where shuffle node sets 2485 are mutually exclusive. For example, data block exchange for facilitating query execution can be localized within a particular shuffle node set 2485, where nodes of a particular shuffle node set 2485 only send and receive data from other nodes in the same shuffle node set 2485, and where nodes in different shuffle node sets 2485 do not communicate directly and/or do not exchange data blocks at all. In some cases, where the inner level includes exactly one shuffle network, all nodes 37 in the inner level can and/or must exchange data blocks with all other nodes in the inner level via the shuffle node set via a single corresponding shuffle network 2480.

Alternatively, some or all of the different shuffle networks 2480 can be interconnected, where nodes can and/or must communicate with other nodes in different shuffle node sets 2485 via connectivity between their respective different shuffle networks 2480 to facilitate query execution. As a particular example, in cases where two shuffle node sets 2485 have at least one overlapping node 37, the interconnectivity can be facilitated by the at least one overlapping node 37, for example, where this overlapping node 37 serves as a relay node to relay communications from at least one first node in a first shuffle node sets 2485 to at least one second node in a second first shuffle node set 2485. In some cases, all nodes 37 in a shuffle node set 2485 can communicate with any other node in the same shuffle node set 2485 via a direct link enabled via shuffle network 2480 and/or by otherwise not necessitating any intermediate relay nodes. However, these nodes may still require one or more relay nodes, such as nodes included in multiple shuffle node sets 2485, to communicate with nodes in other shuffle node sets 2485, where communication is facilitated across multiple shuffle node sets 2485 via direct communication links between nodes within each shuffle node set 2485.

Note that these relay nodes facilitating data blocks for execution of a given query across multiple shuffle node sets 2485 can be nodes participating in the query execution plan of the given query and/or can be nodes that are not participating in the query execution plan of the given query. In some cases, these relay nodes facilitating data blocks for execution of a given query across multiple shuffle node sets 2485 are strictly nodes participating in the query execution plan of the given query. In some cases, these relay nodes facilitating data blocks for execution of a given query across multiple shuffle node sets 2485 are strictly nodes that are not participating in the query execution plan of the given query.

In some cases, a node 37 has direct communication links with its child node and/or parent node, where no relay nodes are required to facilitate sending data to parent and/or child nodes of the query execution plan 2405 of FIG. 24A. In other cases, at least one relay node may be required to facilitate communication across levels, such as between a parent node and child node as dictated by the query execution plan. Such relay nodes can be nodes within a and/or different same shuffle network as the parent node and child node, and can be nodes participating in the query execution plan of the given query and/or can be nodes that are not participating in the query execution plan of the given query.

Some or all features and/or functionality of FIG. 24E can be performed via at least one node 37 in conjunction with system metadata applied across a plurality of nodes 37, for example, where at least one node 37 participates in some or all features and/or functionality of FIG. 24E based on receiving and storing the system metadata in local memory of the at least one node 37 as configuration data and/or based on further accessing and/or executing this configuration data to participate in one or more shuffle node sets of FIG. 24E as part of its database functionality accordingly. Performance of some or all features and/or functionality of FIG. 24E can optionally change and/or be updated over time, and/or a set of nodes participating in executing some or all features and/or functionality of FIG. 24E can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24F illustrates an embodiment of a database system that receives some or all query requests from one or more external requesting entities 2912. The external requesting entities 2912 can be implemented as a client device such as a personal computer and/or device, a server system, or other external system that generates and/or transmits query requests 2914. A query resultant 2920 can optionally be transmitted back to the same or different external requesting entity 2912. Some or all query requests processed by database system 10 as described herein can be received from external requesting entities 2912 and/or some or all query resultants generated via query executions described herein can be transmitted to external requesting entities 2912.

For example, a user types or otherwise indicates a query for execution via interaction with a computing device associated with and/or communicating with an external requesting entity. The computing device generates and transmits a corresponding query request 2914 for execution via the database system 10, where the corresponding query resultant 2920 is transmitted back to the computing device, for example, for storage by the computing device and/or for display to the corresponding user via a display device.

As another example, a query is automatically generated for execution via processing resources via a computing device and/or via communication with an external requesting entity implemented via at least one computing device. For example, the query is automatically generated and/or modified from a request generated via user input and/or received from a requesting entity in conjunction with implementing a query generator system, a query optimizer, generative artificial intelligence (AI), and/or other artificial intelligence and/or machine learning techniques. The computing device generates and transmits a corresponding query request 2914 for execution via the database system 10, where the corresponding query resultant 2920 is transmitted back to the computing device, for example, for storage by the computing device, transmission to another system, and/or for display to at least one corresponding user via a display device.

Some or all features and/or functionality of FIG. 24F can be performed via at least one node 37 in conjunction with system metadata applied across a plurality of nodes 37, for example, where at least one node 37 participates in some or all features and/or functionality of FIG. 24F based on receiving and storing the system metadata in local memory of the at least one node 37 as configuration data, and/or based on further accessing and/or executing this configuration data to generate query execution plan data from query requests by implementing some or all of the operator flow generator module 2514 as part of its database functionality accordingly, and/or to participate in one or more query execution plans of a query execution module 2504 as part of its database functionality accordingly. Performance of some or all features and/or functionality of FIG. 24F can optionally change and/or be updated over time, and/or a set of nodes participating in executing some or all features and/or functionality of FIG. 24F can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24G illustrates an embodiment of a query processing system 2502 that generates a query operator execution flow 2517 from a query expression 2509 for execution via a query execution module 2504. The query processing system 2502 can be implemented utilizing, for example, the parallelized query and/or response sub-system 13 and/or the parallelized data store, retrieve, and/or process subsystem 12. The query processing system 2502 can be implemented by utilizing at least one computing device 18, for example, by utilizing at least one central processing module 39 of at least one node 37 utilized to implement the query processing system 2502. The query processing system 2502 can be implemented utilizing any processing module and/or memory of the database system 10, for example, communicating with the database system 10 via system communication resources 14.

As illustrated in FIG. 24G, an operator flow generator module 2514 of the query processing system 2502 can be utilized to generate a query operator execution flow 2517 for the query indicated in a query expression 2509. This can be generated based on a plurality of query operators indicated in the query expression and their respective sequential, parallelized, and/or nested ordering in the query expression, and/or based on optimizing the execution of the plurality of operators of the query expression. This query operator execution flow 2517 can include and/or be utilized to determine the query operator execution flow 2433 assigned to nodes 37 at one or more particular levels of the query execution plan 2405 and/or can include the operator execution flow to be implemented across a plurality of nodes 37, for example, based on a query expression indicated in the query request and/or based on optimizing the execution of the query expression.

In some cases, the operator flow generator module 2514 implements an optimizer to select the query operator execution flow 2517 based on determining the query operator execution flow 2517 is a most efficient and/or otherwise most optimal one of a set of query operator execution flow options and/or that arranges the operators in the query operator execution flow 2517 such that the query operator execution flow 2517 compares favorably to a predetermined efficiency threshold. For example, the operator flow generator module 2514 selects and/or arranges the plurality of operators of the query operator execution flow 2517 to implement the query expression in accordance with performing optimizer functionality, for example, by perform a deterministic function upon the query expression to select and/or arrange the plurality of operators in accordance with the optimizer functionality. This can be based on known and/or estimated processing times of different types of operators. This can be based on known and/or estimated levels of record filtering that will be applied by particular filtering parameters of the query. This can be based on selecting and/or deterministically utilizing a conjunctive normal form and/or a disjunctive normal form to build the query operator execution flow 2517 from the query expression. This can be based on selecting a determining a first possible serial ordering of a plurality of operators to implement the query expression based on determining the first possible serial ordering of the plurality of operators is known to be or expected to be more efficient than at least one second possible serial ordering of the same or different plurality of operators that implements the query expression. This can be based on ordering a first operator before a second operator in the query operator execution flow 2517 based on determining executing the first operator before the second operator results in more efficient execution than executing the second operator before the first operator. For example, the first operator is known to filter the set of records upon which the second operator would be performed to improve the efficiency of performing the second operator due to being executed upon a smaller set of records than if performed before the first operator. This can be based on other optimizer functionality that otherwise selects and/or arranges the plurality of operators of the query operator execution flow 2517 based on other known, estimated, and/or otherwise determined criteria.

A query execution module 2504 of the query processing system 2502 can execute the query expression via execution of the query operator execution flow 2517 to generate a query resultant. For example, the query execution module 2504 can be implemented via a plurality of nodes 37 that execute the query operator execution flow 2517. In particular, the plurality of nodes 37 of a query execution plan 2405 of FIG. 24A can collectively execute the query operator execution flow 2517. In such cases, nodes 37 of the query execution module 2504 can each execute their assigned portion of the query to produce data blocks as discussed previously, starting from IO level nodes propagating their data blocks upwards until the root level node processes incoming data blocks to generate the query resultant, where inner level nodes execute their respective query operator execution flow 2433 upon incoming data blocks to generate their output data blocks. The query execution module 2504 can be utilized to implement the parallelized query and results sub-system 13 and/or the parallelized data store, receive and/or process sub-system 12.

Some or all features and/or functionality of FIG. 24G can be performed via at least one node 37 in conjunction with system metadata applied across a plurality of nodes 37, for example, where at least one node 37 participates in some or all features and/or functionality of FIG. 24G based on receiving and storing the system metadata in local memory of the at least one node 37 as configuration data and/or based on further accessing and/or executing this configuration data to generate query execution plan data from query requests by executing some or all operators of a query operator flow 2517 as part of its database functionality accordingly. Performance of some or all features and/or functionality of FIG. 24G can optionally change and/or be updated over time, and/or a set of nodes participating in executing some or all features and/or functionality of FIG. 24G can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24H presents an example embodiment of a query execution module 2504 that executes query operator execution flow 2517. Some or all features and/or functionality of the query execution module 2504 of FIG. 24H can implement the query execution module 2504 of FIG. 24G and/or any other embodiment of the query execution module 2504 discussed herein. Some or all features and/or functionality of the query execution module 2504 of FIG. 24H can optionally be utilized to implement the query processing module 2435 of node 37 in FIG. 24B and/or to implement some or all nodes 37 at inner levels 2414 of a query execution plan 2405 of FIG. 24A.

The query execution module 2504 can execute the determined query operator execution flow 2517 by performing a plurality of operator executions of operators 2520 of the query operator execution flow 2517 in a corresponding plurality of sequential operator execution steps. Each operator execution step of the plurality of sequential operator execution steps can correspond to execution of a particular operator 2520 of a plurality of operators 2520-1-2520-M of a query operator execution flow 2433.

In some embodiments, a single node 37 executes the query operator execution flow 2517 as illustrated in FIG. 24H as their operator execution flow 2433 of FIG. 24B, where some or all nodes 37 such as some or all inner level nodes 37 utilize the query processing module 2435 as discussed in conjunction with FIG. 24B to generate output data blocks to be sent to other nodes 37 and/or to generate the final resultant by applying the query operator execution flow 2517 to input data blocks received from other nodes and/or retrieved from memory as read and/or recovered records. In such cases, the entire query operator execution flow 2517 determined for the query as a whole can be segregated into multiple query operator execution sub-flows 2433 that are each assigned to the nodes of each of a corresponding set of inner levels 2414 of the query execution plan 2405, where all nodes at the same level execute the same query operator execution flows 2433 upon different received input data blocks. In some cases, the query operator execution flows 2433 applied by each node 37 includes the entire query operator execution flow 2517, for example, when the query execution plan includes exactly one inner level 2414. In other embodiments, the query processing module 2435 is otherwise implemented by at least one processing module the query execution module 2504 to execute a corresponding query, for example, to perform the entire query operator execution flow 2517 of the query as a whole.

A single operator execution by the query execution module 2504, such as via a particular node 37 executing its own query operator execution flows 2433, by executing one of the plurality of operators of the query operator execution flow 2433. As used herein, an operator execution corresponds to executing one operator 2520 of the query operator execution flow 2433 on one or more pending data blocks 2537 in an operator input data set 2522 of the operator 2520. The operator input data set 2522 of a particular operator 2520 includes data blocks that were outputted by execution of one or more other operators 2520 that are immediately below the particular operator in a serial ordering of the plurality of operators of the query operator execution flow 2433. In particular, the pending data blocks 2537 in the operator input data set 2522 were outputted by the one or more other operators 2520 that are immediately below the particular operator via one or more corresponding operator executions of one or more previous operator execution steps in the plurality of sequential operator execution steps. Pending data blocks 2537 of an operator input data set 2522 can be ordered, for example as an ordered queue, based on an ordering in which the pending data blocks 2537 are received by the operator input data set 2522. Alternatively, an operator input data set 2522 is implemented as an unordered set of pending data blocks 2537.

If the particular operator 2520 is executed for a given one of the plurality of sequential operator execution steps, some or all of the pending data blocks 2537 in this particular operator 2520's operator input data set 2522 are processed by the particular operator 2520 via execution of the operator to generate one or more output data blocks. For example, the input data blocks can indicate a plurality of rows, and the operation can be a SELECT operator indicating a simple predicate. The output data blocks can include only proper subset of the plurality of rows that meet the condition specified by the simple predicate.

Once a particular operator 2520 has performed an execution upon a given data block 2537 to generate one or more output data blocks, this data block is removed from the operator's operator input data set 2522. In some cases, an operator selected for execution is automatically executed upon all pending data blocks 2537 in its operator input data set 2522 for the corresponding operator execution step. In this case, an operator input data set 2522 of a particular operator 2520 is therefore empty immediately after the particular operator 2520 is executed. The data blocks outputted by the executed data block are appended to an operator input data set 2522 of an immediately next operator 2520 in the serial ordering of the plurality of operators of the query operator execution flow 2433, where this immediately next operator 2520 will be executed upon its data blocks once selected for execution in a subsequent one of the plurality of sequential operator execution steps.

Operator 2520.1 can correspond to a bottom-most operator 2520 in the serial ordering of the plurality of operators 2520.1-2520.M. As depicted in FIG. 24G, operator 2520.1 has an operator input data set 2522.1 that is populated by data blocks received from another node as discussed in conjunction with FIG. 24B, such as a node at the IO level of the query execution plan 2405. Alternatively these input data blocks can be read by the same node 37 from storage, such as one or more memory devices that store segments that include the rows required for execution of the query. In some cases, the input data blocks are received as a stream over time, where the operator input data set 2522.1 may only include a proper subset of the full set of input data blocks required for execution of the query at a particular time due to not all of the input data blocks having been read and/or received, and/or due to some data blocks having already been processed via execution of operator 2520.1. In other cases, these input data blocks are read and/or retrieved by performing a read operator or other retrieval operation indicated by operator 2520.

Note that in the plurality of sequential operator execution steps utilized to execute a particular query, some or all operators will be executed multiple times, in multiple corresponding ones of the plurality of sequential operator execution steps. In particular, each of the multiple times a particular operator 2520 is executed, this operator is executed on set of pending data blocks 2537 that are currently in their operator input data set 2522, where different ones of the multiple executions correspond to execution of the particular operator upon different sets of data blocks that are currently in their operator queue at corresponding different times.

As a result of this mechanism of processing data blocks via operator executions performed over time, at a given time during the query's execution by the node 37, at least one of the plurality of operators 2520 has an operator input data set 2522 that includes at least one data block 2537. At this given time, one more other ones of the plurality of operators 2520 can have input data sets 2522 that are empty. For example, a given operator's operator input data set 2522 can be empty as a result of one or more immediately prior operators 2520 in the serial ordering not having been executed yet, and/or as a result of the one or more immediately prior operators 2520 not having been executed since a most recent execution of the given operator.

Some types of operators 2520, such as JOIN operators or aggregating operators such as SUM, AVERAGE, MAXIMUM, or MINIMUM operators, require knowledge of the full set of rows that will be received as output from previous operators to correctly generate their output. As used herein, such operators 2520 that must be performed on a particular number of data blocks, such as all data blocks that will be outputted by one or more immediately prior operators in the serial ordering of operators in the query operator execution flow 2517 to execute the query, are denoted as “blocking operators.” Blocking operators are only executed in one of the plurality of sequential execution steps if their corresponding operator queue includes all of the required data blocks to be executed. For example, some or all blocking operators can be executed only if all prior operators in the serial ordering of the plurality of operators in the query operator execution flow 2433 have had all of their necessary executions completed for execution of the query, where none of these prior operators will be further executed in accordance with executing the query.

Some operator output generated via execution of an operator 2520, alternatively or in addition to being added to the input data set 2522 of a next sequential operator in the sequential ordering of the plurality of operators of the query operator execution flow 2433, can be sent to one or more other nodes 37 in a same shuffle node set as input data blocks to be added to the input data set 2522 of one or more of their respective operators 2520. In particular, the output generated via a node's execution of an operator 2520 that is serially before the last operator 2520.M of the node's query operator execution flow 2433 can be sent to one or more other nodes 37 in a same shuffle node set as input data blocks to be added to the input data set 2522 of a respective operators 2520 that is serially after the last operator 2520.1 of the query operator execution flow 2433 of the one or more other nodes 37.

As a particular example, the node 37 and the one or more other nodes 37 in a shuffle node set all execute queries in accordance with the same, common query operator execution flow 2433, for example, based on being assigned to a same inner level 2414 of the query execution plan 2405. The output generated via a node's execution of a particular operator 2520.i this common query operator execution flow 2433 can be sent to the one or more other nodes 37 in a same shuffle node set as input data blocks to be added to the input data set 2522 the next operator 2520.i+1, with respect to the serialized ordering of the query of this common query operator execution flow 2433 of the one or more other nodes 37. For example, the output generated via a node's execution of a particular operator 2520.i is added input data set 2522 the next operator 2520.i+1 of the same node's query operator execution flow 2433 based on being serially next in the sequential ordering and/or is alternatively or additionally added to the input data set 2522 of the next operator 2520.i+1 of the common query operator execution flow 2433 of the one or more other nodes in a same shuffle node set based on being serially next in the sequential ordering.

In some cases, in addition to a particular node sending this output generated via a node's execution of a particular operator 2520.i to one or more other nodes to be input data set 2522 the next operator 2520.i+1 in the common query operator execution flow 2433 of the one or more other nodes 37, the particular node also receives output generated via some or all of these one or more other nodes' execution of this particular operator 2520.i in their own query operator execution flow 2433 upon their own corresponding input data set 2522 for this particular operator. The particular node adds this received output of execution of operator 2520.i by the one or more other nodes to the be input data set 2522 of its own next operator 2520.i+1.

This mechanism of sharing data can be utilized to implement operators that require knowledge of all records of a particular table and/or of a particular set of records that may go beyond the input records retrieved by children or other descendants of the corresponding node. For example, JOIN operators can be implemented in this fashion, where the operator 2520.i+1 corresponds to and/or is utilized to implement JOIN operator and/or a custom-join operator of the query operator execution flow 2517, and where the operator 2520.i+1 thus utilizes input received from many different nodes in the shuffle node set in accordance with their performing of all of the operators serially before operator 2520.i+1 to generate the input to operator 2520.i+1.

Some or all features and/or functionality of FIG. 24H can be performed via at least one node 37 in conjunction with system metadata applied across a plurality of nodes 37, for example, where at least one node 37 participates in some or all features and/or functionality of FIG. 24H based on receiving and storing the system metadata in local memory of the at least one node 37 as configuration data and/or based on further accessing and/or executing this configuration data execute some or all operators of a query operator flow 2517 as part of its database functionality accordingly. Performance of some or all features and/or functionality of FIG. 24H can optionally change and/or be updated over time, and/or a set of nodes participating in executing some or all features and/or functionality of FIG. 24H can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24I illustrates an example embodiment of multiple nodes 37 that execute a query operator execution flow 2433. For example, these nodes 37 are at a same level 2410 of a query execution plan 2405, and receive and perform an identical query operator execution flow 2433 in conjunction with decentralized execution of a corresponding query. Each node 37 can determine this query operator execution flow 2433 based on receiving the query execution plan data for the corresponding query that indicates the query operator execution flow 2433 to be performed by these nodes 37 in accordance with their participation at a corresponding inner level 2414 of the corresponding query execution plan 2405 as discussed in conjunction with FIG. 24G. This query operator execution flow 2433 utilized by the multiple nodes can be the full query operator execution flow 2517 generated by the operator flow generator module 2514 of FIG. 24G. This query operator execution flow 2433 can alternatively include a sequential proper subset of operators from the query operator execution flow 2517 generated by the operator flow generator module 2514 of FIG. 24G, where one or more other sequential proper subsets of the query operator execution flow 2517 are performed by nodes at different levels of the query execution plan.

Each node 37 can utilize a corresponding query processing module 2435 to perform a plurality of operator executions for operators of the query operator execution flow 2433 as discussed in conjunction with FIG. 24H. This can include performing an operator execution upon input data sets 2522 of a corresponding operator 2520, where the output of the operator execution is added to an input data set 2522 of a sequentially next operator 2520 in the operator execution flow, as discussed in conjunction with FIG. 24H, where the operators 2520 of the query operator execution flow 2433 are implemented as operators 2520 of FIG. 24H. Some or operators 2520 can correspond to blocking operators that must have all required input data blocks generated via one or more previous operators before execution. Each query processing module can receive, store in local memory, and/or otherwise access and/or determine necessary operator instruction data for operators 2520 indicating how to execute the corresponding operators 2520.

Some or all features and/or functionality of FIG. 24I can be performed via at least one node 37 in conjunction with system metadata applied across a plurality of nodes 37, for example, where at least one node 37 participates in some or all features and/or functionality of FIG. 24I based on receiving and storing the system metadata in local memory of the at least one node 37 as configuration data and/or based on further accessing and/or executing this configuration data to execute some or all operators of a query operator flow 2517 in parallel with other nodes, send data blocks to a parent node, and/or process data blocks from child nodes as part of its database functionality accordingly. Performance of some or all features and/or functionality of FIG. 24I can optionally change and/or be updated over time, and/or a set of nodes participating in executing some or all features and/or functionality of FIG. 24I can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24J illustrates an embodiment of a query execution module 2504 that executes each of a plurality of operators of a given operator execution flow 2517 via a corresponding one of a plurality of operator execution modules 3215. The operator execution modules 3215 of FIG. 24J can be implemented to execute any operators 2520 being executed by a query execution module 2504 for a given query as described herein.

In some embodiments, a given node 37 can optionally execute one or more operators, for example, when participating in a corresponding query execution plan 2405 for a given query, by implementing some or all features and/or functionality of the operator execution module 3215, for example, by implementing its operator processing module 2435 to execute one or more operator execution modules 3215 for one or more operators 2520 being processed by the given node 37. For example, a plurality of nodes of a query execution plan 2405 for a given query execute their operators based on implementing corresponding query processing modules 2435 accordingly.

FIG. 24K illustrates an embodiment of database storage 2450 operable to store a plurality of database tables 2712, such as relational database tables or other database tables as described previously herein. Database storage 2450 can be implemented via the parallelized data store, retrieve, and/or process sub-system 12, via memory drives 2425 of one or more nodes 37 implementing the database storage 2450, and/or via other memory and/or storage resources of database system 10. The database tables 2712 can be stored as segments as discussed in conjunction with FIGS. 15-23 and/or FIGS. 24B-24D. A database table 2712 can be implemented as one or more datasets and/or a portion of a given dataset, such as the dataset of FIG. 15.

A given database table 2712 can be stored based on being received for storage, for example, via the parallelized ingress sub-system 24 and/or via other data ingress. Alternatively or in addition, a given database table 2712 can be generated and/or modified by the database system 10 itself based on being generated as output of a query executed by query execution module 2504, such as a Create Table As Select (CTAS) query or Insert query.

A given database table 2712 can be in accordance with a schema 2409 defining columns of the database table, where records 2422 correspond to rows having values 2708 for some or all of these columns. Different database tables can have different numbers of columns and/or different datatypes for values stored in different columns. For example, the set of columns 2707.1_{A}-2707.C_{A} of schema 2709.A for database table 2712.A can have a different number of columns than and/or can have different datatypes for some or all columns of the set of columns 2707.1_{B}-2707.C_{B} of schema 2709.B for database table 2712.B. The schema 2409 for a given n database table 2712 can denote same or different datatypes for some or all of its set of columns. For example, some columns are variable-length and other columns are fixed-length. As another example, some columns are integers, other columns are binary values, other columns are Strings, and/or other columns are char types.

Row reads performed during query execution, such as row reads performed at the IO level of a query execution plan 2405, can be performed by reading values 2708 for one or more specified columns 2707 of the given query for some or all rows of one or more specified database tables, as denoted by the query expression defining the query to be performed. Filtering, join operations, and/or values included in the query resultant can be further dictated by operations to be performed upon the read values 2708 of these one or more specified columns 2707.

FIG. 24L illustrates an embodiment of a dataset 2502 having one or more columns 3023 implemented as array fields 2712. Some or all features and/or functionality of the dataset 2502 of FIG. 24L can be utilized to implement one or more of the database tables 2712 of FIG. 24K and/or any embodiment of any database table and/or dataset received, stored, and processed via the database system 10 as described herein.

Columns 3023 implemented as array fields 2712 can include array structures 2718 as values 3024 for some or all rows. A given array structure 2718 can have a set of elements 2709.1-2709.M. The value of M can be fixed for a given array field 2712, or can be different for different array structures 2718 of a given array field 2712. In embodiments where the number of elements is fixed, different array fields 2712 can have different fixed numbers of array elements 2709, for example, where a first array field 2712.A has array structures having M elements, and where a second array field 2712.B has array structures having N elements.

Note that a given array structure 2718 of a given array field can optionally have zero elements, where such array structures are considered as empty arrays satisfying the empty array condition. An empty array structure 2718 is distinct from a null value 3852, as it is a defined structure as an array 2718, despite not being populated with any values. For example, consider an example where an array field for rows corresponding to people is implemented to note a list of spouse names for all marriages of each person. An empty array for this array field for a first given row denotes a first corresponding person was never married, while a null value for this array field for a second given row denotes that it is unknown as to whether the second corresponding person was ever married, or who they were married to.

Array elements 2709 of a given array structure can have the same or different data type. In some embodiments, data types of array elements 2709 can be fixed for a given array field (e.g. all array elements 2709 of all array structures 2718 of array field 2712.A are string values, and all array elements 2709 of all array structures 2718 of array field 2712.B are integer values). In other embodiments, data types of array elements 2709 can be different for a given array field and/or a given array structure.

Some array structures 2718 that are non-empty can have one or more array elements having the null value 3852, where the corresponding value 3024 thus meets the null-inclusive array condition. This is distinct from the null value condition 3842, as the value 3024 itself is not null, but is instead an array structure 2718 having some or all of its array elements 2709 with values of null. Continuing example where an array field for rows corresponding to people is implemented to note a list of spouse names for all marriages of each person, a null value for this array field for the second given row denotes that it is unknown as to whether the second corresponding person was ever married or who they were married to, while a null value within an array structure for a third given row denotes that the name of the spouse for a corresponding one of a set of marriages of the person is unknown.

Some array structures 2718 that are non-empty can have all non-null values for its array elements 2709, where all corresponding array elements 2709 were populated and/or defined. Some array structures 2718 that are non-empty can have values for some of its array elements 2709 that are null, and values for others of its array elements 2709 that are non-null values.

Some array structures 2718 that are non-empty can have values for all of its array elements 2709 that are null. This is still distinct from the case where the value 3024 denotes a value of null with no array structure 2718. Continuing example where an array field for rows corresponding to people is implemented to note a list of spouse names for all marriages of each person, a null value for this array field for the second given row denotes that it is unknown as to whether the second corresponding person was ever married, how many times they were married or who they were married to, while the array structure for the third given row denotes a set of three null values and non-null values, denoting that the person was married three times, but the names of the spouses for all three marriages are unknown.

FIGS. 24M-24N illustrates an example embodiment of a query execution module 2504 of a database system 10 that executes queries via generation, storage, and/or communication of a plurality of column data streams 2968 corresponding to a plurality of columns. Some or all features and/or functionality of query execution module 2504 of FIGS. 24M-24N can implement any embodiment of query execution module 2504 described herein and/or any performance of query execution described herein. Some or all features and/or functionality of column data streams 2968 of FIGS. 24M-24N can implement any embodiment of data blocks 2537 and/or other communication of data between operators 2520 of a query operator execution flow 2517 when executed by a query execution module 2504, for example, via a corresponding plurality of operator execution modules 3215.

As illustrated in FIG. 24M, in some embodiments, data values of each given column 2915 are included in data blocks of their own respective column data stream 2968. Each column data stream 2968 can correspond to one given column 2915, where each given column 2915 is included in one data stream included in and/or referenced by output data blocks generated via execution of one or more operator execution module 3215, for example, to be utilized as input by one or more other operator execution modules 3215. Different columns can be designated for inclusion in different data streams. For example, different column streams are written do different portions of memory, such as different sets of memory fragments of query execution memory resources.

As illustrated in FIG. 24N, each data block 2537 of a given column data stream 2968 can include values 2918 for the respective column for one or more corresponding rows 2916. In the example of FIG. 24N, each data block includes values for V corresponding rows, where different data blocks in the column data stream include different respective sets of V rows, for example, that are each a subset of a total set of rows to be processed. In other embodiments, different data blocks can have different numbers of rows. The subsets of rows across a plurality of data blocks 2537 of a given column data stream 2968 can be mutually exclusive and collectively exhaustive with respect to the full output set of rows, for example, emitted by a corresponding operator execution module 3215 as output.

Values 2918 of a given row utilized in query execution are thus dispersed across different A given column 2915 can be implemented as a column 2707 having corresponding values 2918 implemented as values 2708 read from database table 2712 read from database storage 2450, for example, via execution of corresponding IO operators. Alternatively or in addition, a given column 2915 can be implemented as a column 2707 having new and/or modified values generated during query execution, for example, via execution of an extend expression and/or other operation. Alternatively or in addition, a given column 2915 can be implemented as a new column generated during query execution having new values generated accordingly, for example, via execution of an extend expression and/or other operation. The set of column data streams 2968 generated and/or emitted between operators in query execution can correspond to some or all columns of one or more tables 2712 and/or new columns of an existing table and/or of a new table generated during query execution.

Additional column streams emitted by the given operator execution module can have their respective values for the same full set of output rows across for other respective columns. For example, the values across all column streams are in accordance with a consistent ordering, where a first row's values 2918.1.1-2918.1.C for columns 2915.1-2915.C are included first in every respective column data stream, where a second row's values 2918.2.1-2918.2.C for columns 2915.1-2915.C are included second in every respective column data stream, and so on. In other embodiments, rows are optionally ordered differently in different column streams. Rows can be identified across column streams based on consistent ordering of values, based on being mapped to and/or indicating row identifiers, or other means.

As a particular example, for every fixed-length column, a huge block can be allocated to initialize a fixed length column stream, which can be implemented via mutable memory as a mutable memory column stream, and/or for every variable-length column, another huge block can be allocated to initialize a binary stream, which can be implemented via mutable memory as a mutable memory binary stream. A given column data stream 2968 can be continuously appended with fixed length values to data runs of contiguous memory and/or may grow the underlying huge page memory region to acquire more contiguous runs and/or fragments of memory.

In other embodiments, rather than emitting datablocks with values 2918 for different columns in different column streams, values 2918 for a set of multiple column can be emitted in a same multi-column data stream.

FIG. 24O illustrates an example of operator execution modules 3215.C that each write their output memory blocks to one or more memory fragments 2622 of query execution memory resources 3045 and/or that each read/process input data blocks based on accessing the one or more memory fragments 2622 Some or all features and/or functionality of the operator execution modules 3215 of FIG. 24O can implement the operator execution modules of FIG. 24J and/or can implement any query execution described herein. The data blocks 2537 can implement the data blocks of column streams of FIGS. 24M and/or 24N, and/or any operator 2520's input data blocks and/or output data blocks described herein.

A given operator execution module 3215.A for an operator that is a child operator of the operator executed by operator execution module 3215.B can emit its output data blocks for processing by operator execution module 3215.B based on writing each of a stream of data blocks 2537.1-2537.K of data stream 2917.A to contiguous or non-contiguous memory fragments 2622 at one or more corresponding memory locations 2951 of query execution memory resources 3045.

Operator execution module 3215.A can generate these data blocks 2537.1-2537.K of data stream 2917.A in conjunction with execution of the respective operator on incoming data. This incoming data can correspond to one or more other streams of data blocks 2537 of another data stream 2917 accessed in memory resources 3045 based on being written by one or more child operator execution modules corresponding to child operators of the operator executed by operator execution module 3215.A. Alternatively or in addition, the incoming data is read from database storage 2450 and/or is read from one or more segments stored on memory drives, for example, based on the operator executed by operator execution module 3215.A being implemented as an IO operator.

The parent operator execution module 3215.B of operator execution module 3215.A can generate its own output data blocks 2537.1-2537.J of data stream 2917.B based on execution of the respective operator upon data blocks 2537.1-2537.K of data stream 2917.A. Executing the operator can include reading the values from and/or performing operations toy filter, aggregate, manipulate, generate new column values from, and/or otherwise determine values that are written to data blocks 2537.1-2537.J.

In other embodiments, the operator execution module 3215.B does not read the values from these data blocks, and instead forwards these data blocks, for example, where data blocks 2537.1-2537.J include memory reference data for the data blocks 2537.1-2537.K to enable one or more parent operator modules, such as operator execution module 3215.C, to access and read the values from forwarded streams.

In the case where operator execution module 3215.A has multiple parents, the data blocks 2537.1-2537.K of data stream 2917.A can be read, forwarded, and/or otherwise processed by each parent operator execution module 3215 independently in a same or similar fashion. Alternatively or in addition, in the case where operator execution module 3215.B has multiple children, each child's emitted set of data blocks 2537 of a respective data stream 2917 can be read, forwarded, and/or otherwise processed by operator execution module 3215.B in a same or similar fashion.

The parent operator execution module 3215.C of operator execution module 3215.B can similarly read, forward, and/or otherwise process data blocks 2537.1-2537.J of data stream 2917.B based on execution of the respective operator to render generation and emitting of its own data blocks in a similar fashion. Executing the operator can include reading the values from and/or performing operations to filter, aggregate, manipulate, generate new column values from, and/or otherwise process data blocks 2537.1-2537.J to determine values that are written to its own output data. For example, the operator execution module 3215.C reads data blocks 2537.1-2537.K of data stream 2917.A and/or the operator execution module 3215.B writes data blocks 2537.1-2537.J of data stream 2917.B. As another example, the operator execution module 3215.C reads data blocks 2537.1-2537.K of data stream 2917.A, or data blocks of another descendent, based on having been forwarded, where corresponding memory reference information denoting the location of these data blocks is read and processed from the received data blocks data blocks 2537.1-2537.J of data stream 2917.B enable accessing the values from data blocks 2537.1-2537.K of data stream 2917.A. As another example, the operator execution module 3215.B does not read the values from these data blocks, and instead forwards these data blocks, for example, where data blocks 2537.1-2537.J include memory reference data for the data blocks 2537.1-2537.J to enable one or more parent operator modules to read these forwarded streams.

This pattern of reading and/or processing input data blocks from one or more children for use in generating output data blocks for one or more parents can continue until ultimately a final operator, such as an operator executed by a root level node, generates a query resultant, which can itself be stored as data blocks in this fashion in query execution memory resources and/or can be transmitted to a requesting entity for display and/or storage.

For example, rather than accessing this large data for some or all potential records prior to filtering in a query execution, for example, via IO level 2416 of a corresponding query execution plan 2405 as illustrated in FIGS. 24A and 24C, and/or rather than passing this large data to other nodes 37 for processing, for example, from IO level nodes 37 to inner level nodes 37 and/or between any nodes 37 as illustrated in FIGS. 24A, 24B, and 24C, this large data is not accessed until a final stage of a query. As a particular example, this large data of the projected field is simply joined at the end of the query for the corresponding outputted rows that meet query predicates of the query. This ensures that, rather than accessing and/or passing the large data of these fields for some or all possible records that may be projected in the resultant, only the large data of these fields for final, filtered set of records that meet the query predicates are accessed and projected.

FIG. 24P illustrates an embodiment of a database system 10 that implements a segment generator 2507 to generate segments 2424. Some or all features and/or functionality of the database system 10 of FIG. 24P can implement any embodiment of the database system 10 described herein. Some or all features and/or functionality of segments 2424 of FIG. 24P can implement any embodiment of segment 2424 described herein.

A plurality of records 2422.1-2422.Z of one or more datasets 2505 to be converted into segments can be processed to generate a corresponding plurality of segments 2424.1-2424.Y. Each segment can include a plurality of column slabs 2610.1-2610.C corresponding to some or all of the C columns of the set of records.

In some embodiments, the dataset 2505 can correspond to a given database table 2712. In some embodiments, the dataset 2505 can correspond to only portion of a given database table 2712 (e.g. the most recently received set of records of a stream of records received for the table over time), where other datasets 2505 are later processed to generate new segments as more records are received over time. In some embodiments, the dataset 2505 can correspond to multiple database tables. The dataset 2505 optionally includes non-relational records and/or any records/files/data that is received from/generated by a given data source multiple different data sources.

Each record 2422 of the incoming dataset 2505 can be assigned to be included in exactly one segment 2424. In this example, segment 2424.1 includes at least records 2422.3 and 2422.7, while segment 2424 includes at least records 2422.1 and 2422.9. All of the Z records can be guaranteed to be included in exactly one segment by segment generator 2507. Rows are optionally grouped into segments based on a cluster-key based grouping or other grouping by same or similar column values of one or more columns. Alternatively, rows are optionally grouped randomly, in accordance with a round robin fashion, or by any other means.

A given row 2422 can thus have all of its column values 2708.1-2708.C included in exactly one given segment 2424, where these column values are dispersed across different column slabs 2610 based on which columns each column value corresponds. This division of column values into different column slabs can implement the columnar-format of segments described herein. The generation of column slabs can optionally include further processing of each set of column values assigned to each column slab. For example, some or all column slabs are optionally compressed and stored as compressed column slabs.

The database storage 2450 can thus store one or more datasets as segments 2424, for example, where these segments 2424 are accessed during query execution to identify/read values of rows of interest as specified in query predicates, where these identified rows/the respective values are further filtered/processed/etc., for example, via operators 2520 of a corresponding query operator execution flow 2517, or otherwise accordance with the query to render generation of the query resultant.

FIG. 24Q illustrates an example embodiment of a segment generator 2507 of database system 10. Some or all features and/or functionality of the database system 10 of FIG. 24Q can implement any embodiment of the database system 10 described herein. Some or all features and/or functionality of the segment generator 2507 of FIG. 24Q can implement the segment generator 2507 of FIG. 24P and/or any embodiment of the segment generator 2507 described herein.

The segment generator 2507 can implement a cluster key-based grouping module 2620 to group records of a dataset 2505 by a predetermined cluster key 2607, which can correspond to one or more columns. The cluster key can be received, accessed in memory, configured via user input, automatically selected based on an optimization, or otherwise determined. This grouping by cluster key can render generation of a plurality of record groups 2625.1-2625.X.

The segment generator 2507 can implement a columnar rotation module 2630 to generate a plurality of column formatted record data (e.g. column slabs 2610 to be included in respective segments 2424). Each record group 2625 can have a corresponding set of J column-formatted record data 2565.1-2565.J generated, for example, corresponding to J segments in a given segment group.

A metadata generator module 2640 can further generate parity data, index data, statistical data, and/or other metadata to be included in segments in conjunction with the column-formatted record data. A set of X segment groups corresponding to the X record groups can be generated and stored in database storage 2450. For example, each segment group includes J segments, where parity data of a proper subset of segments in the segment group can be utilized to rebuild column-formatted record data of other segments in the same segment group as discussed previously.

In some embodiments, the segment generator 2507 implements some or all features and/or functionality of the segment generator disclosed by: U.S. Utility application Ser. No. 16/985,723, entitled “DELAYING SEGMENT GENERATION IN DATABASE SYSTEMS”, filed Aug. 5, 2020, which is hereby incorporated herein by reference in its entirety and made part of the present U.S. Utility patent application for all purposes; U.S. Utility application Ser. No. 16/985,957 entitled “PARALLELIZED SEGMENT GENERATION VIA KEY-BASED SUBDIVISION IN DATABASE SYSTEMS”, filed Aug. 5, 2020, which is hereby incorporated herein by reference in its entirety and made part of the present U.S. Utility patent application for all purposes; and/or U.S. Utility application Ser. No. 16/985,930, entitled “RECORD DEDUPLICATION IN DATABASE SYSTEMS”, filed Aug. 5, 2020, issued as U.S. Pat. No. 11,321,288 on May 3, 2022, which is hereby incorporated herein by reference in its entirety and made part of the present U.S. Utility patent application for all purposes. For example, the database system 10 implements some or all features and/or functionality of record processing and storage system of U.S. Utility application Ser. No. 16/985,723, U.S. Utility application Ser. No. 16/985,957, and/or U.S. Utility application Ser. No. 16/985,930.

FIG. 24R illustrates an embodiment of a query processing system 2510 that implements an IO pipeline generator module 2834 to generate a plurality of IO pipelines 2835.1-2835.R for a corresponding plurality of segments 2424.1-2424.R, where these IO pipelines 2835.1-2835.R are each executed by an IO operator execution module 2840 to facilitate generation of a filtered record set by accessing the corresponding segment. Some or all features and/or functionality of the query processing system 2510 of FIG. 24R can implement any embodiment of query processing system 2510, any embodiment of query execution module 2504, and/or any embodiment of executing a query described herein.

Each IO pipeline 2835 can be generated based on corresponding segment configuration data 2833 for the corresponding segment 2424, such as secondary indexing data for the segment, statistical data/cardinality data for the segment, compression schemes applied to the column slabs of the segment, or other information denoting how the segment is configured. For example, different segments 2424 have different IO pipelines 2835 generated for a given query based on having different secondary indexing schemes, different statistical data/cardinality data for its values, different compression schemes applied for some of all of the columns of its records, or other differences.

An IO operator execution module 2840 can execute each respective IO pipeline 2835. For example, the IO operator execution module 2840 is implemented by nodes 37 at the IO level of a corresponding query execution plan 2405, where a node 37 storing a given segment 2424 is responsible for accessing the segment as described previously, and thus executes the IO pipeline for the given segment.

This execution of IO pipelines 2835 by IO operator execution module 2840 correspond to executing IO operators 2421 of a query operator execution flow 2517. The output of IO operators 2421 can correspond to output of IO operators 2421 and/or output of IO level. This output can correspond to data blocks that are further processed via additional operators 2520, for example, by nodes at inner levels and/or the root level of a corresponding query execution plan.

Each IO pipeline 2835 can be generated based on pushing some or all filtering down to the IO level, where query predicates are applied via the IO pipeline based on accessing index structures, sourcing values, filtering rows, etc. Each IO pipeline 2835 can be generated to render semantically equivalent application of query predicates, despite differences in how the IO pipeline is arranged/executed for the given segment. For example, an index structure of a first segment is used to identify a set of rows meeting a condition for a corresponding column in a first corresponding IO pipeline while a second segment has its row values sourced and compared to a value to identify which rows meet the condition, for example, based on the first segment having the corresponding column indexed and the second segment not having the corresponding column indexed. As another example, the IO pipeline for a first segment applies a compressed column slab processing element to identify where rows are stored in a compressed column slab and to further facilitate decompression of the rows, while a second segment accesses this column slab directly for the corresponding column based on this column being compressed in the first segment and being uncompressed for the second segment.

FIG. 24S illustrates an example embodiment of an IO pipeline 2835 that is generated to include one or more index elements 3512, one or more source elements 3014, and/or one or more filter elements 3016. These elements can be arranged in a serialized ordering that includes one or more parallelized paths. These elements can implement sourcing and/or filtering of rows based on query predicates 2822 applied to one or more columns, identified by corresponding column identifiers 3041 and corresponding filter parameters 3048. Some or all features and/or functionality of the IO pipeline 2835 and/or IO pipeline generator module 2834 of FIG. 24S can implement the IO pipeline 2835 and/or IO pipeline generator module 2834 of FIG. 24R, and/or any embodiment of IO pipeline 2835, of IO pipeline generator module 2834, or of any query execution via accessing segments described herein.

In some embodiments, the IO pipeline generator module 2834, 10 pipeline 2835, 10 operator execution module 2840, and/or any embodiment of IO pipeline generation and/or IO pipeline execution described herein, implements some or all features and/or functionality of the IO pipeline generator module 2834, 10 pipeline 2835, 10 operator execution module 2840, and/or pushing of filtering and/or other operations to the IO level as disclosed by: U.S. Utility application Ser. No. 17/303,437, entitled “QUERY EXECUTION UTILIZING PROBABILISTIC INDEXING” and filed May 28, 2021; U.S. Utility application Ser. No. 17/450,109, entitled “MISSING DATA-BASED INDEXING IN DATABASE SYSTEMS” and filed Oct. 6, 2021; U.S. Utility application Ser. No. 18/310,177, entitled “OPTIMIZING AN OPERATOR FLOW FOR PERFORMING AGGREGATION VIA A DATABASE SYSTEM” and filed May 1, 2023; U.S. Utility application Ser. No. 18/355,505, entitled “STRUCTURING GEOSPATIAL INDEX DATA FOR ACCESS DURING QUERY EXECUTION VIA A DATABASE SYSTEM” and filed Jul. 20, 2023; and/or U.S. Utility application Ser. No. 18/485,861, entitled “QUERY PROCESSING IN A DATABASE SYSTEM BASED ON APPLYING A DISJUNCTION OF CONJUNCTIVE NORMAL FORM PREDICATES” and filed Oct. 12, 2023; all of which hereby incorporated herein by reference in its entirety and made part of the present U.S. Utility patent application for all purposes.

FIG. 24T presents an embodiment of a database system 10 that includes a plurality of storage clusters 2535. Storage clusters 2535.1-2535.Z of FIG. 24T can implement some or all features and/or functionality of storage clusters 35-1-35-Z described herein, and/or can implement some or all features and/or functionality of any embodiment of a storage cluster described herein. Some or all features and/or functionality of database system 10 of FIG. 24T can implement any embodiment of database system 10 described herein.

Each storage cluster 2535 can be implemented via a corresponding plurality of nodes 37. In some embodiments, a given node 37 of database system 10 is optionally included in exactly one storage cluster. In some embodiments, one or more nodes 37 of database system 10 are optionally included in no storage clusters (e.g. aren't configured to store segments). In some embodiments, one or more nodes 37 of database system 10 can be included in multiple storage clusters.

In some embodiments, some or all nodes 37 in a storage cluster 2535 participate at the IO level 2416 in query execution plans based on storing segments 2424 in corresponding memory drives 2425, and based on accessing these segments 2424 during query execution. This can include executing corresponding IO operators, for example, via executing an IO pipeline 2835 (and/or multiple IO pipelines 2835, where each IO pipeline is configured for each respective segment 2424). All segments in a given same segment group (e.g. a set of segments collectively storing parity data and/or replicated parts enabling any given segment in the segment group to be rebuilt/accessed as a virtual segment during query execution via access to some or all other segments in the same segment group as described previously) are optionally guaranteed to be stored in a same storage cluster 2535, where segment rebuilds and/or virtual segment use in query execution can thus be facilitated via communication between nodes in a given storage cluster 2535 accordingly, for example, in response to a node failing and/or a segment becoming unavailable.

Each storage cluster 2535 can further mediate cluster state data 3105 in accordance with a consensus protocol mediated via the plurality of nodes 37 of the given storage cluster. Cluster state data 3105 can implement any embodiment of state data and/or system metadata described herein. In some embodiments, cluster state data 3105 can indicate data ownership information indicating ownership of each segments stored by the cluster by exactly one node (e.g. as a physical segment or a virtual segment) to ensure queries are executed correctly via processing rows in each segment (e.g. of a given dataset against which the query is executed) exactly once.

Consensus protocol 3100 can be implemented via the raft consensus protocol and/or any other consensus protocol. Consensus protocol 3100 can be implemented be based on distributing a state machine across a plurality of nodes, ensuring that each node in the cluster agrees upon the same series of state transitions and/or ensuring that each node operates in accordance with the currently agreed upon state transition. Consensus protocol 3100 can implement any embodiment of consensus protocol described herein.

Coordination across different storage clusters 2535 can be minimal and/or non-existent, for example, based on each storage cluster coordinating state data and/or corresponding query execution separately. For example, state data 3105 across different storage clusters is optionally unrelated.

Each storage cluster's nodes 37 can perform various database tasks (e.g. participate in query execution) based on accessing/utilizing the state data 3105 of its given storage cluster, for example, without knowledge of state data of other storage clusters. This can include nodes syncing state data 3105 and/or otherwise utilizing the most recent version of state data 3105, for example, based on receiving updates from a leader node in the cluster, triggering a sync process in response to determining to perform a corresponding task requiring most recent state data, accessing/updating a locally stored copy of the state data, and/or otherwise determining updated state data.

In some embodiments, updating of state data (such as configuration data, system metadata, data shared via a consensus protocol, and/or any other state data described herein), for example, utilized by nodes to perform respective functionality over time, can be performed in conjunction with an event driven model. In some embodiments, such updating of state data over time can be performed in a same or similar fashion as updating of configuration data as disclosed by: U.S. Utility application Ser. No. 18/321,212, entitled COMMUNICATING UPDATES TO SYSTEM METADATA VIA A DATABASE SYSTEM, filed May 22, 2023; and/or U.S. Utility application Ser. No. 18/310,262, entitled “GENERATING A SEGMENT REBUILD PLAN VIA A NODE OF A DATABASE”, filed May 1, 2023; which are hereby incorporated herein by reference in their entirety and made part of the present U.S. Utility patent application for all purposes.

In some embodiments, system metadata can be generated and/or updated over time with different corresponding metadata sequence numbers (MSNs). For example, such generation/updating of metadata over time can be implemented via any features and/or functionality of the generation of data ownership information over time with corresponding OSNs as disclosed by U.S. Utility application Ser. No. 16/778,194, entitled “SERVICING CONCURRENT QUERIES VIA VIRTUAL SEGMENT RECOVERY”, filed Jan. 31, 2020, and issued as U.S. Pat. No. 11,061,910 on Jul. 13, 2021, which is hereby incorporated herein by reference in its entirety and made part of the present U.S. Utility patent application for all purposes. In some embodiments, the system metadata management system 2702 and/or a corresponding metadata system protocol can be implemented via a consensus protocols mediated via a plurality of nodes, for example, to update system metadata 2710, in a via any features and/or functionality of the execution of consensus protocols mediated via a plurality of nodes as disclosed by this U.S. Utility application Ser. No. 16/778,194. In some embodiments, each version of system metadata 2710 can assign nodes to different tasks and/or functionality via any features and/or functionality of assigning nodes to different segments for access in query execution in different versions of data ownership information as disclosed by this U.S. Utility application Ser. No. 16/778,194. In some embodiments, system metadata indicates a current version of data ownership information, where nodes utilize system metadata and corresponding system configuration data to determine their own ownership of segments for use in query execution accordingly, and/or to execute queries utilizing correct sets of segments accordingly, based on processing the denoted data ownership information as U.S. Utility application Ser. No. 16/778,194.

FIGS. 24U and 24V illustrate embodiments of a database system 10 that utilizes a dictionary structure to store compressed columns. Some or all features and/or functionality of the dictionary structure 5016 of FIGS. 24U and/or 24V can implement any compression scheme data and/or means of generating and/or accessing compressed columns described herein. Any other features and/or functionality of database system 10 of FIGS. 24U and/or 24V can implement any other embodiment of database system 10 described herein.

In some embodiments, columns are compressed as compressed columns 5005 based on a globally maintained dictionary (e.g. dictionary structure 5016), for example, in conjunction with applying Global Dictionary Compression (GDC). Applying Global Dictionary Compression can include replaces variable length column values with fixed length integers on disk (e.g. in database storage 2450), where the globally maintained dictionary is stored elsewhere, for example, via different (e.g. slower/less efficient) memory resources of a different type/in a different location from the database storage 2450 that stores the compressed columns 5005 accessed during query execution.

The dictionary structure can store a plurality of fixed-length, compressed values 5013 (e.g. integers) each mapped to a single uncompressed value 5012 (e.g. variable-length values, such as strings). The mapping of compressed values 5013 to uncompressed values 5012 can be in accordance with a one-to-one mapping. The mapping of compressed values 5013 to uncompressed values 5012 can be based on utilizing the fixed-length values 5013 as keys of a corresponding map and/or dictionary data structure, and/or can be based on utilizing the uncompressed values 5012 as keys of a corresponding map and/or dictionary data structure.

A given uncompressed value 5012 that is included in many rows of one or more tables can be replaced (i.e. “compressed”) via a same corresponding compressed value 5013 mapped to this uncompressed value 5012 as the compressed value 5008 for these rows in compressed column 5005 in database storage. As new rows are received for storage over time, their column values for one or more compressed columns 5005 can be replaced via corresponding compressed values 5008 based on accessing the dictionary structure and determining whether the uncompressed value 5012 of this column is stored in the dictionary structure 5016. If yes, the compressed value 5013 mapped to the uncompressed value 5012 in this existing entry is stored as compressed value 5008 in the compressed column 5005 in the database storage 2450. If no, the dictionary structure 5016 can be updated to include a new entry that includes the uncompressed value 5012 and a new compressed value 5013 (e.g. different from all existing compressed values in the structure) generated for this uncompressed value 5012, where this new compressed value 5013 is stored as is applied as compressed value 5008 in the database storage 2450.

The dictionary structure 5016 can be stored in dictionary storage resources 2514, which can be different types of resources from and/or can be stored in a different location from the database storage 2450 storing the compressed columns for query execution. In some embodiments, the dictionary storage resources 2514 storing dictionary structure 5016 can be considered a portion/type of memory as of database storage 2450 that are accessed during query execution as necessary for decompressing column values. In some embodiments, the dictionary storage resources 2514 storing dictionary structure 5016 can be implemented as metadata storage resources, for example, implemented by a metadata consensus state mediated via a metadata storage cluster of nodes maintaining system metadata such as GDCs of the database system 10.

The dictionary structure 5016 can correspond to a given column 5005, where different columns optionally have their own dictionary structure 5016 build and maintained. Alternatively, a common dictionary structure 5016 can optionally be maintained for multiple columns of a same table/same dataset, and/or for multiple columns across different tables/different datasets. For example, a given uncompressed value 5012 appearing in different columns 5005 of the same or different table is compressed via the same fixed-length value 5013 as dictated by the dictionary structure 5016.

This dictionary structure 5016 can be globally maintained (e.g. across some or all nodes, indicating fixed length values mapped across one or more segments stored in conjunction with storing one or more relational database tables) and can be updated overtime (e.g. as more data is added with new variable length values requiring mapping to fixed length values). For example, the dictionary structure 5016 is maintained/stored in state data that is mediated/accessible by some or all nodes 37 of the database system 10 via the dictionary structure 5016 being included in any embodiment of state data described herein.

In some embodiments, dictionary compression via dictionary structure 5016 can implement the compression scheme utilized to generate (e.g. compress/decompress the values of) compressed columns 5005 of FIG. 24U based on implementing some or all features and/or functionality of the compression of data during ingress via a dictionary as disclosed by U.S. Utility application Ser. No. 16/985,723, entitled “DELAYING SEGMENT GENERATION IN DATABASE SYSTEMS”, filed Aug. 5, 2020, which is hereby incorporated herein by reference in its entirety and made part of the present U.S. Utility patent application for all purposes.

In some embodiments, dictionary compression via dictionary structure 5016 can implement the compression scheme utilized to generate (e.g. compress/decompress the values of) compressed columns 5005 of FIG. 24U based on implementing some or all features and/or functionality of global dictionary compression as disclosed by U.S. Utility application Ser. No. 16/220,454, entitled “DATA SET COMPRESSION WITHIN A DATABASE SYSTEM”, filed Dec. 14, 2018, issued as U.S. Pat. No. 11,256,696 on Feb. 22, 2022, which is hereby incorporated herein by reference in its entirety and made part of the present U.S. Utility patent application for all purposes.

In some embodiments, dictionary compression via dictionary structure 5016 can be utilized in performing GDC join processes during query execution to enable recovery of uncompressed values during query execution, for example, based on implementing some or all features and/or functionality of GDC joins as disclosed by U.S. Utility application Ser. No. 18/226,525, entitled “SWITCHING MODES OF OPERATION OF A ROW DISPERSAL OPERATION DURING QUERY EXECUTION”, filed Jul. 26, 2023, which is hereby incorporated herein by reference in its entirety and made part of the present U.S. Utility patent application for all purposes.

In some embodiments, queries performing GDC joins and/or accessing compressed values can be generated and/or executed based on implementing some or all features and/or functionality of generating and executing such queries, for example, based on via rewriting corresponding filter expressions, as disclosed by U.S. Utility application Ser. No. 18/485,861, entitled “QUERY PROCESSING IN A DATABASE SYSTEM BASED ON APPLYING A DISJUNCTION OF CONJUNCTIVE NORMAL FORM PREDICATES”, filed Oct. 12, 2023, which is hereby incorporated herein by reference in its entirety and made part of the present U.S. Utility patent application for all purposes.

FIG. 24U illustrates an embodiment of database system 10 where a compressed column filter conversion module 5010 accesses a dictionary structure 5016 to generate an updated filtering expression 5021 in conjunction with query execution.

The compressed column filter conversion module 5010 can generate updated filtering expression 5021 based on updating one or more literals 5011.1 from corresponding literals 5011.0 based on replacing uncompressed values 5012 with compressed values 5013 mapped to these compressed values based on accessing dictionary structure 5016 and determining which fixed-length compressed value 5013 is mapped to each given uncompressed value 5012. Such functionality can be implemented for one or more queries executed by database system 10 to reduce access to the dictionary structure during query execution in conjunction with performing one or more optimizations of the query operator execution flow to improve query performance.

FIG. 24V illustrates an embodiment of executing a join process 2530 that is implemented as a global dictionary compression (GDC) join. This can include applying a matching row determination module 2558 via access to a dictionary structure 5016,

In some embodiments, unlike hash maps generated during query execution for access in conjunction with executing other types of JOIN operations (e.g. as described in U.S. Utility application Ser. No. 18/266,525), the dictionary structure 5016 can optionally be accessed during GDC join processes based on being globally maintained, and thus being generated prior to execution of the corresponding query. In particular, the dictionary structure 5016 can be implemented in conjunction with compressing one or more columns, such as a variable length values stored in one or more variable length columns, by mapping these variable length, uncompressed values (e.g. strings, other large values of a given column) to corresponding fixed-length, compressed values 5013 (e.g. integers or other fixed length values).

For example, segments can store the fixed length values to improve storage efficiency and/or queries can access and process these fixed length values, where the uncompressed variable length values are only required via access to dictionary structure 5016 to emit an uncompressed value 5012 for a given fixed-length value 5013 of a given input row. This functionality can be achieved via performing a corresponding join as described herein, where the matching condition 2519 is implemented for a compressed column and indicates matching by the value of the compressed column, such as simply emitting the uncompressed value mapped to the compressed column as the right output value 2563 for a given input row, implemented as a left input row 2542 of a join operation.

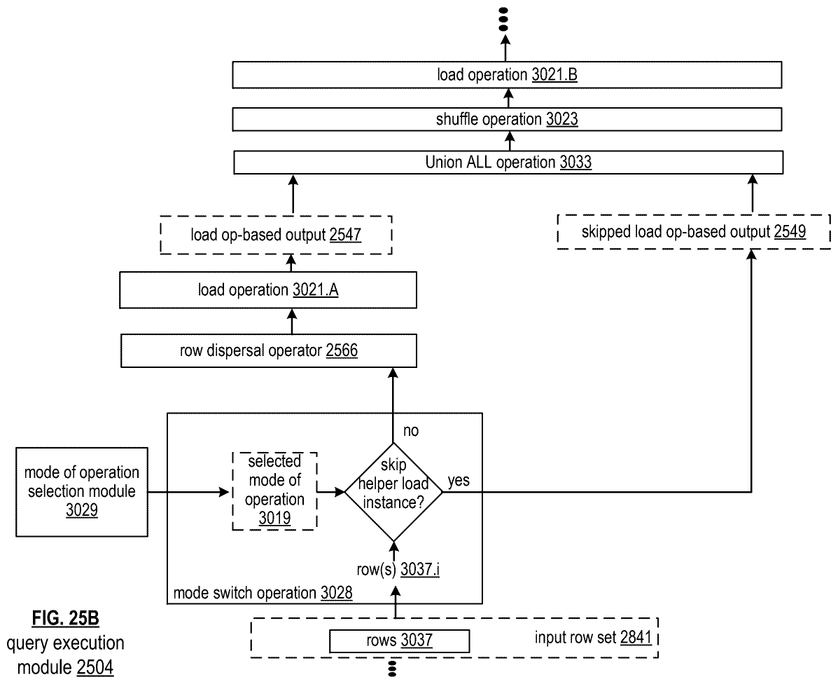

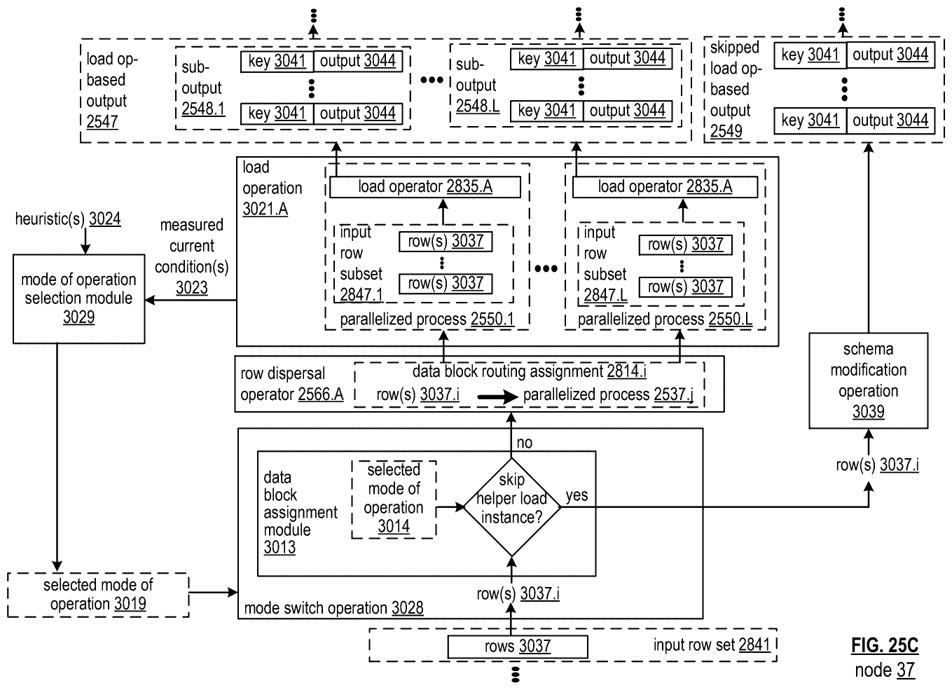

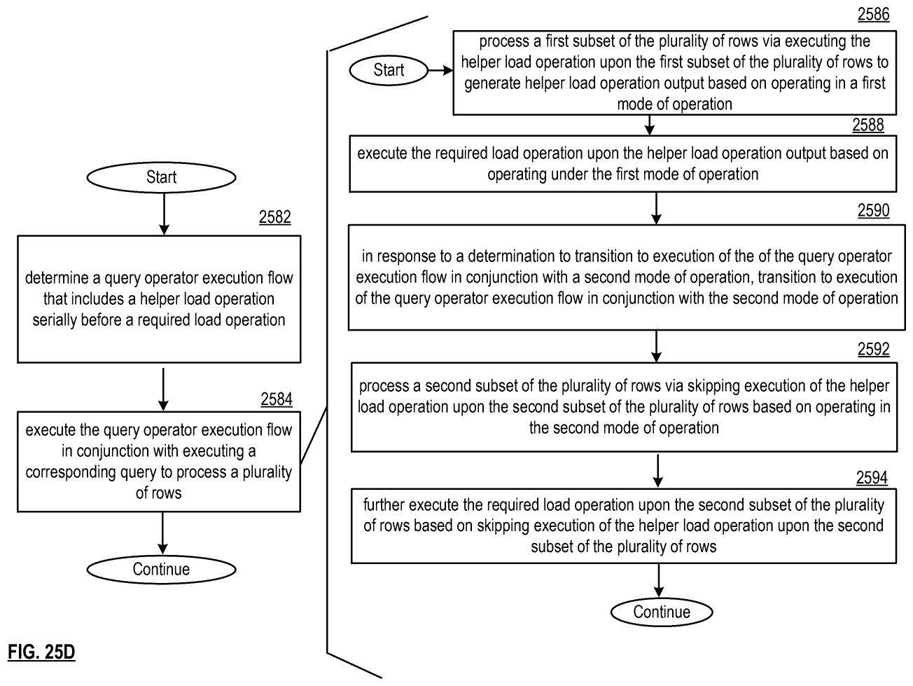

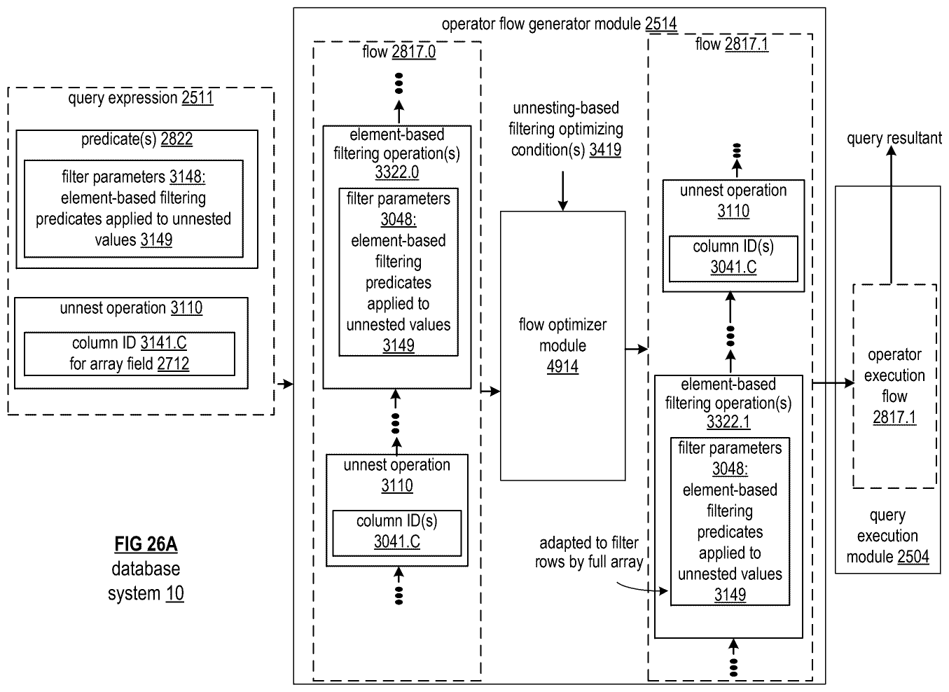

FIGS. 25A-25C illustrate embodiments where a query execution module determines whether to skip lower, helper implementation of a given load operation during query runtime, for example, after some rows have already been processed. The embodiments illustrated in 25A-25C can be utilized to implement one or more nodes 37 of one or more computing devices 18 implementing database system 10. Some or all features and/or functionality of FIGS. 25A-25C can be utilized to implement any embodiment of database system 10 described herein.

In some embodiments, grouped aggregations (aggs), union distincts, and/or other types of load operations can be correctly implemented multiple ways in a query plan. It can be difficult to predetermine which is best during optimization. Most of these approaches (e.g. assuming all aggregation calculations are commutative and associative can involve multiple lower operator instances where the load operations that appear lower in the plan/earlier in execution are not strictly needed for query correctness. For example, a first, “lower” grouped aggregation instance is placed serially before a shuffle on the keys of output of the grouped aggregation instance, which is serially before a hash-multiplexer on the keys of output of the shuffle, which is serially before a second, “higher” grouped aggregation instance. This plan can be distributed across a set of multiple nodes, such as 13 nodes or any number of nodes. Each grouped aggregation can be further distributed across multiple cores on a single node. Union distinct multiplexing can be handled in a same or similar fashion.

In some embodiments, the lower (e.g. “helper”) agg may speed up the query because it removes rows with duplicate grouping keys as it calculates its aggregation function, so there may be less data passing through the shuffle operator. However, the lower agg does not necessarily speed up the query. For example, consider the extreme case when every row has a unique group key. The multiplexer (or lack thereof) can be irrelevant. The helper aggregation can compute “partial” aggregations first, and then the higher, final aggregation can compute reaggregations on one row per group. In this case, the helper aggregation did not reduce the row cardinality at all, and was pointless.

In some embodiments, any implementing of grouped aggregation and/or union distinct multiplexing, and/or optimizing a query plan for implementing grouped aggregation and/or union distinct multiplexing described herein, can be implemented via some or all features and/or functionality of implementing of grouped aggregation and/or union distinct multiplexing, and/or optimizing a query plan for implementing grouped aggregation and/or union distinct multiplexing, as disclosed by U.S. Utility application Ser. No. 18/226,525, entitled “SWITCHING MODES OF OPERATION OF A ROW DISPERSAL OPERATION DURING QUERY EXECUTION”, filed Jul. 26, 2023, which is hereby incorporated herein by reference in its entirety and made part of the present U.S. Utility patent application for all purposes.

FIGS. 25A-25C present embodiments where such lower, helper aggregation (or similarly, lower, helper union distinct) can be skipped during runtime based on a determination that this step is not helpful/renders execution less efficient than if this optional step were skipped. Such switching of modes of query execution can be determined and performed in a same or similar fashion of switching modes of row dispersal disclosed in U.S. Utility application Ser. No. 18/226,525.

FIG. 25A illustrates an example embodiment of such as plan, where the load operation instances 3021.A and 3021.B implement the first and second load operators (e.g. grouped aggregation or union distinct), respectively. A shuffling operation 3023 can occur after the load operation instances 3021.A, for example, by implementing any features and/or functionality of the shuffling of FIG. 24E and/or any other embodiment of shuffling described herein. The row dispersal operator 2566 can be implemented via any embodiment of multiplexing and/or row dispersal operator 2566 described herein. The load operator 2835 can be implemented via any load operation such as an aggregation, a union distinct, a join, a blocking operation, and/or any other query operation performed in parallel based on rows first being dispersed across parallelized instances.

The lower (e.g. “helper”) load operation (e.g. lower agg or lower union distinct) may speed up the query because it removes rows with duplicate grouping keys as it calculates its aggregation function, so there may be less data passing through the shuffle operator. These lower load operations are not needed, as the corresponding aggregation will be completed correctly by the higher instance after the hash-multiplexing is performed (e.g. via the required multiplexer operation 3021.B and the required load operation instance 3021.B).

Because the lower load operations are not necessary, mode selection performed during runtime (e.g. selected in a same or similar fashion as disclosed in U.S. Utility application Ser. No. 18/226,525) can be implemented to determine whether to skip the lower load operation entirely. For example, such mode switching can be evaluated/performed during runtime instead of or in addition to the mode switching to switch between hash based multiplexing or round robin-based multiplexing as disclosed in U.S. Utility application Ser. No. 18/226,525, for example, based on current condition of the load operator 3021 (e.g. whether its able to use hash-based multiplexing and/or whether the helper loading is effective in grouping rows in the case of a group aggregation/eliminating duplicates in the case of union distinct, for example, based on the row distribution/corresponding key distribution of input rows (e.g. whether there are many duplicate keys or few duplicate keys in the incoming rows).

FIG. 25B illustrates an embodiment where a mode switch operation 3028 is implemented to determine whether incoming rows are processed via the lower load operation 3021.A (e.g. first via corresponding row dispersal operator 2566 which sends rows to different parallelized instances of the load operation 3021.A as illustrated in FIG. 30A), or skips this lower load operation entirely. Some or all features and/or functionality of FIG. 30B can implement the query execution module of FIG. 30A and/or any embodiment of database system 10 described herein.

FIG. 25C illustrates an embodiment where mode switch operation 3028 is implemented, illustrating the dispersal of rows to a given parallelized processes 2550.1-2550.L via row dispersal operator 2566.A when in the first mode of operation 3019.1. Some or all features and/or functionality of FIG. 25C can implement the query execution module of FIG. 30A (E.g. can implement processing performed by a given node 37 of FIG. 30A), can implement the operations of FIG. 30B, and/or can implement any embodiment of database system 10 described herein.

The mode switch operation 3028 (e.g. “smart switch” operator) can be operable to forward its input to exactly one of its parents. For example, such switching can be implemented whenever the helper load operator failed to eliminate/group enough unique rows even with hash multiplexing. The mode of operation selection module 3029 can be operable to identify when such conditions to switch to from utilizing the helper load operator to skipping the helper load operator are satisfied (e.g. based on a corresponding heuristic). For example, a first mode of operation 3019.1 can correspond to not skipping (e.g. forwarding to) the helper load instance, and a second mode of operation 3019.2 can correspond to skipping the helper load instance.

Any rows processed via the first mode of operation 3019.1 are processed via load operation 3021.A (the lower, helping load operation), for example, based on first being dispersed via row dispersal operator 2566 for processing via a selected operator 2835 of a plurality of parallelized operators 2835 as illustrated in FIG. 25A, rendering load op-based output 2547 generated across all of the parallelized operators 2835 implementing the given load operation 3021.A. For example, load op-based output 2547 includes ones of these input rows processed under the first mode of operation 3019 that were not eliminated (e.g. via union distincts implemented as operators 2835) and/or includes rows grouping multiple ones of these input rows via a same key (e.g. via grouping aggregation implemented as operators 2835).

Any rows processed via the second mode of operation 3019.2 are not processed via load operation 3021.A, for example, based on being forwarded directly to a parent operator of the load operation 3021.A as rows included in skipped load op-based output 2549. For example, skipped load op-based output 2549 includes all input rows processed under the second mode of operation 3019.2 (e.g. optionally after having had their schemas modified to match schema of load op-based output 2547).

Thus the parent operator of load operation 3021.A can process all rows of load op-based output 2547 and skipped load op-based output 2549. This can include a union ALL operation 3033 first union-ing all rows included in these respective outputs output 2547 and skipped load op-based output 2549, a shuffle operation 3023, and/or the load operation 3021.B. In some embodiments, the union ALL operation 3033 is optionally omitted, for example, if already included in a lower level of the query execution plan (e.g. within the load operation 3021.A and/or row dispersal operator 2566, and/or prior to the load operation 3021.A and/or row dispersal operator 2566) and/or if the load operator 3021.B is operable process multiple inputs (e.g. based on being implemented as a union distinct). In some embodiments, the shuffle operation 3023 is optionally omitted, for example, if already included in a lower level of the query execution plan (e.g. within the load operation 3021.A and/or row dispersal operator 2566, and/or prior to the load operation 3021.A and/or row dispersal operator 2566).

The mode of operation selection module 3029 can optionally switch from the first mode of operation 3019.1 to the second mode of operation 3019.2, when deemed more efficient/otherwise determined. For example, the query is executed via first attempting use of the first mode of operation 3019.1, and the mode of operation selection module 3029 triggers switching from the first mode of operation 3019.1 to the second mode of operation 3019.2 at some point mid-query after at least one row is processed via the first mode of operation 3019.1, where all remaining rows are processed via the second mode of operation 3019.2 (e.g. based on the mode of operation selection module 3029 never determining to switch back to the first mode of operation for the remainder of query execution, and/or based on the mode of operation selection module 3029 being operable to always maintain execution via the second mode of operation 3019.2 once operating under the second mode of operation 3019.2). In some embodiments, the mode of operation selection module 3029 can optionally further switch back from the second mode of operation 3019.2 to the first mode of operation 3019.1, and/or can optionally switch between modes any number of times, for example, based on corresponding conditions being met/heuristics being satisfied during execution of the given query.

This switch can be signaled via an event signaling mechanism, for example, in a same or similar fashion as optionally switching from runtime degenerate (e.g. round robin multiplex) to hash multiplex switch, for example, as disclosed in U.S. Utility application Ser. No. 18/226,525. For example, the mode of operation selection module 3029 can be implemented as/similarly to the row dispersal mode of operation selection module of U.S. Utility application Ser. No. 18/226,525 and/or the selected mode of operation 3019 can be implemented as/similarly to the selected mode of operation of U.S. Utility application Ser. No. 18/226,525. In some embodiments, the mode switch operation 3028 can be implemented as part of the row dispersal operator 2566.A (e.g. determines which load operator 2835 of L parallelized processes 2550.1-2550.L is selected to process an incoming row via a corresponding load operator 2835.A when in the first mode of operation 3019.1, optionally based on whether the mode of operation further specifies whether round robin or hash-based dispersal is being performed; and skips routing to any of these parallelized processes 2550.1-2550.L to route to a parent operator serially after the load operation 3021.A implementing these parallelized processes when in the second mode of operation 3019.2).

In some embodiments, different nodes 37 implement their own mode of operation selection module 3029 and thus determine whether to switch from the first mode of operation 3019.1 to the second mode of operation 3019.2 (or vice versa) independently from other nodes. For example, different nodes 37 executing a given query in parallel switch from the first mode of operation 3019.1 to the second mode of operation 3019.2 at different times. As another example, a first node of multiple different nodes 37 executing a given query in parallel switch from the first mode of operation 3019.1 to the second mode of operation 3019.2 at some point during its execution of the query, while a second node of these multiple different nodes 37 executing the given query in parallel never switches from the first mode of operation 3019.1 to the second mode of operation 3019.2 during execution of the query, and operates under the first mode of operation 3019.1 for the entirely of the query. This independent switching selection via different nodes can be useful in cases where distribution of rows processed via different nodes has different properties (e.g. more duplicate keys processed by one node and less duplicate keys processed by another).

In some embodiments, the mode of operation selection module 3029 triggers switching of mode of operation by multiple nodes, such as some or all nodes 37 executing a corresponding query in parallel. In such cases, current condition data is optionally received from multiple nodes, or a single node's current condition data is considered representative of all nodes. This triggering of switching across multiple different nodes can be useful in cases where distribution of rows processed via different nodes is expected/known to have similar/same properties (e.g. based on input rows having already been shuffled after being read in IO, and/or otherwise based on such distribution of rows across different nodes being random/independent of key).

In some embodiments, aggregation is more complex than union distinct because it inherently changes the schema of the data. For example, it preserves the group keys, adds various output columns based on aggregation operations and input columns, and otherwise discards the rest. Such appending of columns can correspond to appending of output 3044 to a row having key 3041 in generating corresponding sub-output 2548, for example as disclosed by U.S. Utility application Ser. No. 18/226,525. Executing a load operator 2835 to implement grouped aggregation, and/or any embodiment of executing queries to perform grouped aggregation described herein, can be implemented via some or all features and/or functionality of grouped aggregation disclosed by U.S. Utility application Ser. No. 18/310,177, entitled “OPTIMIZING AN OPERATOR FLOW FOR PERFORMING AGGREGATION VIA A DATABASE SYSTEM”, filed May 1, 2023, which is hereby incorporated herein by reference in its entirety and made part of the present U.S. Utility patent application for all purposes.

In such embodiments, the higher aggregation 3021.B can thus expect this schema with additional columns that would be generated via the lower aggregation 3021.A, even if the lower aggregation 3021.A is skipped for some or all incoming rows. The query execution can be further adapted when in the second mode of operation 3019.2 to ensure the schema of rows are first modified (e.g. additional columns are added and/or appropriate output 3044 is otherwise appended to the corresponding key for the given row).

This case can be informed by the notion that “skipping” the lower aggregation here means aggregating as though each row was its own group. For example, instead of passing the output directly to the higher aggregation, the rows are first passed through a modify schema operation 3039 which preserves the aggregation grouping keys (e.g. as keys 3041), and then for each aggregation input, extends a degenerate aggregation output column depending on the operation (E.g. as output 3044).

The aggregation grouping keys can correspond to/be based on the value of one or more columns indicated in a GROUP BY clause. For example, rows are grouped by the value of a given column (or optionally a set of multiple columns), where rows with the same value of the given column (or all of the set of multiple columns) are assigned a same corresponding key 3041 dictating placement in the same group and/or rows with different values of the given column (or at least one of the set of multiple columns) are assigned different corresponding keys 3041 dictating placement in in different groups. In the case of union distinct, keys 3041 optionally correspond to the value of the full row (e.g. duplicate rows containing matching values for all columns are assigned a same key 3041, while distinct rows containing non-matching values for at least one column are assigned different keys 3041).

Thus, while respective output includes a plurality of rows with keys 3041 and output 3044, the number of rows included in the output can be equal to the number of rows processed via the second mode of operation 3019.2, for example, based on a corresponding row having a given keys 3041 and output 3044 pairing being generated for each given row processed by modify schema operation 3039. Multiple of the rows in the output 2549 can have identical keys 3041 based on these rows not having been processed via a corresponding load operator.

Meanwhile, the number of rows with keys 3041 and output 3044 across all sub-outputs 3041.1-3041.L may include less than the number of rows processed via the first mode of operation 3019.1, for example, based on multiple input rows processed via a given operator 2835 of a given parallelized process 2550 having a same key, and thus being “grouped”/represented together via a single row in the corresponding output having this key (e.g. the output 3044 for this key is the count of the number of rows with this key in the case of a count operation; the output 3044 for this key is the sum of values of a particular column across these multiple rows with this key in the case of a sum operation; etc.). Furthermore, a given output 3041 of a given operator 2835 of a given parallelized process 2550 can be guaranteed to have no duplicate keys across its rows (e.g. in a given output block or all output blocks of this output) based on all rows with a given key being represented in a given row's pairing of key and corresponding output due to being processed by the corresponding load operator 2835.

The load operation 3021.B can receive the rows included in load op-based output 2547 and skipped load op-based output 2549, optionally without knowledge of which output 2547 vs. 2549 and/or without distinction in their processing. For example, a given aggregation for a given key 3041 needs to be computed by load operation 3021.B across all rows having this given key, which may include rows generated and received from one or more parallelized processes 2550, having outputs 3044 representing some form of partial aggregation already performed for this key (e.g. a sum/count for multiple rows having this key processed by the given parallelized process 2550), and/or which may include rows that skipped aggregation by load operation 3021.A having outputs 3044 representative of the single corresponding row (e.g. a representation of the “running aggregation” for this single row only, such as its value for the respective value in the case of a sum or value of 1 in the case of an aggregation, generated by modify schema operation 3039). Thus, despite different inputs to load operation 3021.B optionally corresponding to rows included in outputs 2547 or 2549 generated under different modes of operation (e.g. skipping vs. not skipping the helper load operation), these rows are still processed collectively, irrespective of which output 2547 vs. 2549 they were included in, to generate correct output for the corresponding load operation (e.g. the corresponding type of aggregation or a corresponding union distinct).

The modify schema operation 3039 can be implemented for a given query based on the type of aggregation being performed. This can include configuring of the modify schema operation 3039 based on the type of aggregation to generate an output key 3031 and output 3044 fora given row that would be equivalent to the output key 3031 and output 3044 that would be generated for a given row by an operator 2835 of this type of aggregation, if this row were the only row to be processed by the operator 2835 having its key (e.g. the output 3044 generated by modify schema for a given row operation 3039 is the count of the number of rows with this key in the case of a count operation; the output 3044 for this key is the sum of values of a particular column across these multiple rows with this key in the case of a sum operation; etc.).

In particular, the modify schema operation 3039 can be operable to generate the output 3044 based on the value of aggregation input (e.g. how the input for the row to the aggregation operator would be processed if only one row in the respective group). For example, in a grouped aggregation (e.g. called via a GROUP BY clause), the aggregation input for a given corresponds to this row's column value for a first given column, where the grouped aggregation generates aggregation output values for each of a set of groups based on aggregating the column values for the first given column (e.g. based on being indicated in the query expression for use in the aggregation). The set of groups can correspond to groupings of rows by a column value of a second given column (e.g. all rows with same column value for this second column are included in the same group). For example, the value of the column value for the second given column can be implemented as key values utilized to sort the rows into groups, within which the values of the first column are aggregated to render aggregation on a per-group basis.

In particular, the key 3031 can be set for the given row as the given row's column value of the second column, and the output 3044 can be set for the given row as some function of the given row's column value of the second column, as dictated by the type of aggregation.

As a particular example, when the modify schema operation 3039 is configured in conjunction with a type of aggregation corresponding to MIN, MAX, SUM, or PRODUCT (e.g. to compute minimum value, maximum value, a sum, or a product, respectfully), the output can be generated based on extending the aggregation input (e.g. as a column implemented as output 3044). This can include setting output 3044 for a given row as the column value of the first column.

As another particular example, when the modify schema operation 3039 is configured in conjunction with a type of aggregation corresponding to HLL (e.g. a HyperLogLog operation), the output can be generated based on extending a computed hash (e.g. as a column implemented as output 3044). This can include first computing a hash value for a given row as a function of the given row's column value of the first column, and then setting output 3044 for the given row as this hash value.

As another particular example, when the modify schema operation 3039 is configured in conjunction with a type of aggregation corresponding to COUNT, the output can be generated based on extending 0 if the column is NULL, or 1 otherwise (e.g. as a column implemented as output 3044). This can include setting output 3044 for the given row as 0 when the given row's column value of the first column is null, and setting output 3044 for the given row as 1 when the given row's column value of the first column is non-null.

As another particular example, when the modify schema operation 3039 is configured in conjunction with a type of aggregation corresponding to ARRAY_AGG (e.g. an array aggregation operation), the output can be generated based on extending an array with one element containing the aggregation input (e.g. as a column implemented as output 3044). This can include setting output 3044 for a given row as an array with an element (e.g. exactly one element) containing the given row's column value of the first column, or containing some portion/function of the given row's column value of the first column.

As another particular example, when the modify schema operation 3039 is configured in conjunction with a type of aggregation corresponding to STRING_AGG (e.g. a string aggregation operation), the output can be generated based on converting the aggregation input into a string (e.g. extended as a column implemented as output 3044). This can include first converting the given row's column value of the first column into a string value, and then setting output 3044 for the given row as this string value.

In some embodiments, a reorder may be required via the modify schema operation 3038. For example, a reordering of existing columns of the given row can be performed in emitting a corresponding row as output, alternatively or in addition to performing an extend operation to append at least one new column corresponding to the output 3044. Such reordering can be required, for example, due to keys coming before aggregation outputs, and/or the order of keys potentially not matching the order of the columns coming into the helper aggregation operation.

As all of the rows across both the load op-based output 2547 and skipped load op-based output 2549 have the same schema that satisfies the rules of the given type of aggregation (e.g. where a given row is represented in skipped load op-based output 2549 in an equivalent manner as it would be represented in load op-based output 2547 if it were to have a unique key across keys processed by a corresponding operator 2835 of a given parallelized process 2550), the further processing of the load op-based output 2547 and skipped load op-based output 2549 by the load operation 3021.B (e.g. after optional union ALL and shuffling is performed) can render correct aggregation results in ultimately generating the query resultant for the given query.

FIG. 25D illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 25D, for example, based on participating in execution of a query being executed by the database system 10. Some or all of the method of FIG. 25D can be performed by nodes executing a query in conjunction with a query execution, for example, via one or more nodes 37 implemented as nodes of a query execution module 2504 implementing a query execution plan 2405. In some embodiments, a node 37 can implement some or all of FIG. 25D based on implementing some or all of a plurality of processing modules 2610.1-2610.W, for example, as a corresponding plurality of processing core resources 48.1-48.W. Some or all of the steps of FIG. 25D can optionally be performed by any other one or more processing modules of the database system 10. Some or all of the steps of FIG. 25D can be performed to implement some or all of the functionality of the database system 10 as described in conjunction with FIGS. 25A-25C, for example, by implementing some or all of the functionality of query execution module 2504, mode switch operation 3028, load operation 3021.A, and/or load operation 3021.B. Some or all steps of FIG. 25D can be performed by database system 10 in accordance with other embodiments of the database system 10 and/or nodes 37 discussed herein. Some or all of the steps of FIG. 25D can be performed in conjunction with performing some or all steps of any other method described herein.

Step 2582 includes determining a query operator execution flow that includes a helper load operation (e.g. load operation 3021.A) serially before a required load operation (e.g. load operation 3021.B). Step 2584 includes executing the query operator execution flow in conjunction with executing a corresponding query to process a plurality of rows.

Performing step 2584 can include performing some or all of steps 2586-2594. Step 2586 includes processing a first subset of the plurality of rows via executing the helper load operation upon the first subset of the plurality of rows to generate helper load operation output based on operating in a first mode of operation (e.g. mode of operation 3019.1 corresponding to not skipping the helper load operation 3021.A). Step 2588 includes executing the required load operation upon the helper load operation output based on operating under the first mode of operation. In various examples, steps 2586 and 2588 are performed during a first temporal period of execution of the query operator execution flow in conjunction with the first mode of operation.

Step 2590 includes, in response to a determination to transition to execution of the of the query operator execution flow in conjunction with a second mode of operation (e.g. mode of operation 3019.2 corresponding to skipping the helper load operation 3021.A), transitioning to execution of the query operator execution flow in conjunction with the second mode of operation. In various examples, performing step 2590 includes entering a second temporal period of execution of the query operator execution flow in conjunction with the second mode of operation (e.g. the second temporal period is strictly after the first temporal period).

Step 2592 includes process a second subset of the plurality of rows via skipping execution of the helper load operation upon the second subset of the plurality of rows based on operating in the second mode of operation. Step 2594 includes further executing the required load operation upon the second subset of the plurality of rows based on skipping execution of the helper load operation upon the second subset of the plurality of rows. In various examples, steps 2592 and 2594 are performed during the second temporal period of execution of the query operator execution flow in conjunction with the second mode of operation.

In various examples, query resultant of the query is generated based on output of the required load operation generated via processing both the helper load operation output and the second subset of the plurality of rows.

In various examples, the corresponding query indicates performance of an aggregation operation. In various examples, the helper load operation corresponds to a first instance of the aggregation operation and/or the required load operation corresponds to a second instance of the aggregation operation.

In various examples, the corresponding query indicates performance of a union distinct operation. In various examples, the helper load operation corresponds to a first instance of union distinct and/or the required load operation corresponds to a second instance of the union distinct.

In various examples, the helper load operation is implemented via a plurality of parallelized instances of a load operator (e.g. load operator 2835). In various examples, a multiplexer operation (e.g. row dispersal operator 2566.A) disperses the first subset of rows across the plurality of parallelized instances of the load operator during the first temporal period.

In various examples, the multiplexer operation disperses at least some of the first subset of the plurality of rows in conjunction with implementing a hash key-based row dispersal mode. In various examples, rows of the plurality of rows each have a key of a plurality of keys utilized by the helper load operation. In various examples, the hash key-based row dispersal mode guarantees that all rows having a same key of the plurality of keys are sent to a same parallelized load operator instance of the plurality of parallelized instances of the load operator based on dispersing rows based on the key of each row.

In various examples, the helper load operation is a grouped aggregation operation executed based on each parallelized load operator instance generating a plurality of aggregation values by key. In various examples, the key of the each row is based on a subset of column values of the each row (e.g. a single column value of one column, or multiple column values of multiple columns) by which the grouped aggregation operation groups rows for separate aggregation. In various examples, each of the plurality of aggregation values corresponds to a different one of the plurality of keys.

In various examples, the helper load operation is a union distinct operation executed based on each parallelized load operator instance emitting a single row for duplicate rows having the same key. In various examples, the key of the each row is based on a set of column values of the each row.

In various examples, the helper load operation output includes a set of helper load output rows that each include one key and at least one corresponding aggregation value. In various examples, the method further includes, based on operating under the second mode of operation, applying a schema modification operator (e.g. modify schema operation 3039) to the second subset of the plurality of rows to generate a set of modified rows from the second subset of the plurality of rows based on processing each row of the second subset of the plurality of rows to generate a corresponding modified row of the set of modified rows that includes a corresponding key for the each row and at least one corresponding value for the each row. In various examples, schemas of the set of modified rows and the set of helper load output rows match based on applying the schema modification operator (e.g. the set of modified rows and the set of helper load output rows include the same set of columns in the same order based on applying the schema modification operator).

In various examples, the helper load operation corresponds to a first instance of grouped aggregation operation in the query operator execution flow. In various examples, the required load operation corresponds to a second instance of the grouped aggregation operation in the query operator execution flow. In various examples, the required load operation is configured to process input rows having a schema corresponding the schemas of the set of modified rows and the set of helper load output rows.

In various examples, the schema modification operator determines the at least one corresponding value for the each row based on adhering to a type of aggregation of the grouped aggregation operation.

In various examples, the plurality of rows include a plurality of columns. In various examples, the grouped aggregation operation is configured to generate aggregation output, via processing column values of a first column of the plurality of columns in conjunction with the type of aggregation, for each of a plurality of groups of rows in the plurality of rows grouped by values for a second column of the plurality of columns.

In various examples, applying the schema modification operator includes setting the at least one corresponding value for the each row as a corresponding column value of the first column of the each row based on the type of aggregation being implemented as one of: a MIN operation, a MAX operation, a SUM operation, or a PRODUCT operation.

In various examples, applying the schema modification operator includes setting the at least one corresponding value for the each row as a corresponding hash value computed from the corresponding column value of the first column of the each row based on the type of aggregation being implemented as a HyperLogLog (HLL) operation.

In various examples, applying the schema modification operator includes, based on the type of aggregation being implemented as a COUNT operation, setting the at least one corresponding value for the each row as one of: one when the corresponding column value of the first column of the each row is non-null, or zero when the corresponding column value of the each row is NULL.

In various examples, applying the schema modification operator includes setting the at least one corresponding value for the each row as a corresponding array containing one element based on the corresponding column value of the first column of the each row based on the type of aggregation being implemented as an array aggregation operation (e.g. ARRAY_AGG).

In various examples, applying the schema modification operator includes setting the at least one corresponding value for the each row as a corresponding string based on converting the corresponding column value of the first column of the each row into a string based on the type of aggregation being implemented as a string aggregation operation (e.g. STRING_AGG).

In various examples, the query operator execution flow includes a mode switch operation (e.g. mode switch operation 3028) serially before the helper load operation. In various examples, the mode switch operation sends each of the plurality of rows for processing to one of a set of possible parent operations based on a current selected mode of operation based on: sending the each of the plurality of rows for processing via execution of the helper load operation when the current selected mode of operation is the first mode of operation; or skipping of the helper load operation when the current selected mode of operation is the first mode of operation.

In various examples, executing the helper load operation further includes, in response to determining to transition to determining to transition to operation in conjunction with a second mode of operation, sending a signal indicating an instruction to transition to the second mode of operation to the mode switch operation based on the mode switch operation being a child operator of the helper load operation. In various examples, the mode switch operation routes subsequent rows to one of the set of possible parent operations corresponding to skipping of the helper mode operation based on transitioning to operating in accordance with the second mode of operation based on receiving the signal from the helper load operation.

In various examples, the helper load operation is executed separately via a plurality of nodes in conjunction with executing a corresponding query. In various examples, the helper load operation executed via each node of the plurality of nodes is implemented via a corresponding plurality of parallelized instances of a load operator via a plurality of corresponding processing core resources of the each node. In various examples, different nodes of the plurality of nodes independently determine whether to transition from the first mode of operation to the second mode of operation.

In various examples, a first node of the plurality of nodes processes the first subset of the plurality of rows in accordance with the first mode of operation during the first temporal period and processes the second subset of the plurality of rows in accordance with the second mode of operation during the second temporal period based on the determination to transition from the first mode of operation to the second mode of operation being determined by the first node at a first corresponding time. In various examples, a second node of plurality of nodes a third subset of a second plurality of rows in accordance with the first mode of operation during a third temporal period and processes a fourth subset of the second plurality of rows in accordance with the second mode of operation during a fourth temporal period based on the second node determining transition from the first mode of operation to the second mode of operation a second corresponding time. In various examples, the fourth temporal period overlaps with both the first temporal period and the second temporal period based on the second corresponding time being different from the first corresponding time based on the different nodes of the plurality of nodes independently determining whether to transition from the first mode of operation to the second mode of operation.

In various examples, determining whether to transition to execution in conjunction with a second mode of operation instead of the first mode of operation is based on applying at least one heuristic based on processing at least some of the first subset of the plurality of rows. In various examples, the at least one heuristic includes: a local memory heuristic for query execution memory resources utilized to execute the query operator execution flow; and/or a row cardinality heuristic for rows in the plurality of rows.

In various examples, executing the helper load operation includes grouping rows into a plurality of row groups to generate the helper load operation output based on maintaining a hash map indicating the plurality of row groups. In various examples, new entries are added to the hash map over time based on new groups indicated in corresponding new incoming rows. In various examples, applying the at least one heuristic is based on a current state of the hash map.

In various examples, the determination to transition from the first mode of operation to the second mode of operation is based on determining a measured amount of available memory of query execution memory resources is below a memory threshold. In various examples, the determination to transition from the first mode of operation to the second mode of operation is based on determining a proportion of unique key values of rows in the first subset of the plurality of rows already processed during the first temporal period is above a threshold proportion.

In various examples, the method further includes executing the helper load operation over a plurality of time slices to process incoming rows. In various examples, the method further includes evaluating the at least one heuristic during each of the plurality of time slices based on processing the incoming rows. In various examples, the method further includes determining, based on evaluating the at least one heuristic during each of the plurality of time slices, whether to maintain a current mode of operation of or to transition to a different mode of operation. In various examples, over the plurality of time slices, execution of the query operator execution flow transitions from the first mode of operation to the second mode of operation at least one time. In various examples, execution of the query operator execution flow further transitions from the second mode of operation back to the first mode of operation at least one time.

In various examples, output of the helper load operation is generated via executing based on grouping rows into a plurality of row groups. In various examples, evaluating the at least one heuristic during at least some of the plurality of time slices includes: measuring a ratio of non-duplicate groups of plurality of row groups to duplicate groups of plurality of row groups; and/or comparing the ratio to a configured threshold to determine whether to maintain a current mode of operation or to transition to a different mode of operation.

In various examples, the configured threshold changes over the at least some of the plurality of time slices as a configured coefficient of a logarithm of a total number of entries in the set of entries in the current hash map based on the total number of entries in the set of entries in the current hash map increasing over time.

In various examples, grouping rows into a plurality of row groups to generate the output of the helper load operation via executing the helper load operation is based on maintaining a hash map indicating the plurality of row groups. In various examples, new entries are added to the hash map over time based on new groups indicated in corresponding new incoming rows.

In various examples, measuring the ratio of non-duplicate groups of plurality of row groups to duplicate groups of plurality of row groups for a given time slice of the at least some of the plurality of time slices is based on a set of entries in a current hash map at the given time slice.

In various examples, evaluating the at least one heuristic during the at least some of the plurality of time slices is based on determining when to reevaluate the at least one heuristic after a most recent evaluation of the at least one heuristic as an exponentially increasing function of a total number of rows received so far over all prior ones of the plurality of time slices. In various examples, a first amount of time between a first given evaluation of the at least one heuristic and a second given evaluation of the at least one heuristic corresponding to a next evaluation after the first given evaluation is less than a second amount of time between the second given evaluation of the at least one heuristic and a third given evaluation of the at least one heuristic corresponding to another next evaluation after the second given evaluation.

In various examples, the query operator execution flow is selected from a plurality of semantically equivalent query operator execution flow options. In various examples, another one of the plurality of semantically equivalent query operator execution flow options includes only the required load operation and not the helper load operation based on duplicate instances of the load operation applied in series being semantically equivalent with the exactly one instance of the load operation.

In various examples, the query operator execution flow further includes a union ALL operation serially after the helper load operation and serially before the required load operation. In various examples, the query operator execution flow further includes a shuffle operation serially after the helper load operation and serially before the required load operation. In various examples, the union ALL operation is executed upon the helper load operation output and the second subset of the plurality of rows. In various examples, the shuffle operation is executed upon the helper load operation output and the second subset of the plurality of rows based on the query operator execution flow not including the union ALL operation serially after the helper load operation and serially before the required load operation. In various examples, the query operator execution flow further includes the shuffle operation is executed serially after the shuffle operation based on the query operator execution flow including the union ALL operation serially before the shuffle operation.

In various examples, executing the query operator execution flow further includes executing optimized unnesting-based filtering structuring of a query plan implemented via the query operator execution flow to implement filtering based on unnested values of an array column based on: generating a filtered subset of the plurality of rows based on element-based filtering predicates; further processing only rows in the filtered subset of the plurality of rows by generating a filtered array structure for each row in the filtered subset of the plurality of rows based on the array column; and/or performing an unnest operation only upon the filtered array structure generated for the each row in the filtered subset of the plurality of rows.

In various examples, the query operator execution flow includes a scatter operator. In various examples, output generated by a node participating at an upper level of a hierarchical query plan in conjunction with execution of the corresponding query is dispersed across a set of nodes at a lower level of the hierarchical query plan for processing. In various examples, the set of nodes generate a corresponding plurality of subsequent output based on processing corresponding portions of the output. In various examples, the query resultant is based on the corresponding plurality of subsequent output.

In various embodiments, any one of more of the various examples listed above are implemented in conjunction with performing some or all steps of FIG. 25D. In various embodiments, any set of the various examples listed above can be implemented in tandem, for example, in conjunction with performing some or all steps of FIG. 25D, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 25D described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 25D, for example, in conjunction with further implementing any one or more of the various examples described above.

In various embodiments, the operational instructions, when executed by the at least one processor, cause the database system to: determine a query operator execution flow that includes a helper load operation serially before a required load operation; and/or execute the query operator execution flow in conjunction with executing a corresponding query to process a plurality of rows. In various examples, executing the query operator execution flow is based on, during a first temporal period of execution of the query operator execution flow in conjunction with a first mode of operation: processing a first subset of the plurality of rows via executing the helper load operation upon the first subset of the plurality of rows to generate helper load operation output based on operating in the first mode of operation; and/or executing the required load operation upon the helper load operation output based on operating under the first mode of operation. In various examples, executing the query operator execution flow is further based on, in response to a determination to transition to execution of the of the query operator execution flow in conjunction with a second mode of operation, entering a second temporal period of execution of the query operator execution flow in conjunction with the second mode of operation. In various examples, executing the query operator execution flow is further based on, during the second temporal period, processing a second subset of the plurality of rows via skipping execution of the helper load operation upon the second subset of the plurality of rows based on operating in the second mode of operation; and/or executing the required load operation upon the second subset of the plurality of rows based on skipping execution of the helper load operation upon the second subset of the plurality of rows. In various examples, a query resultant of the query is generated based on output of the required load operation generated via processing the helper load operation output and the second subset of the plurality of rows.

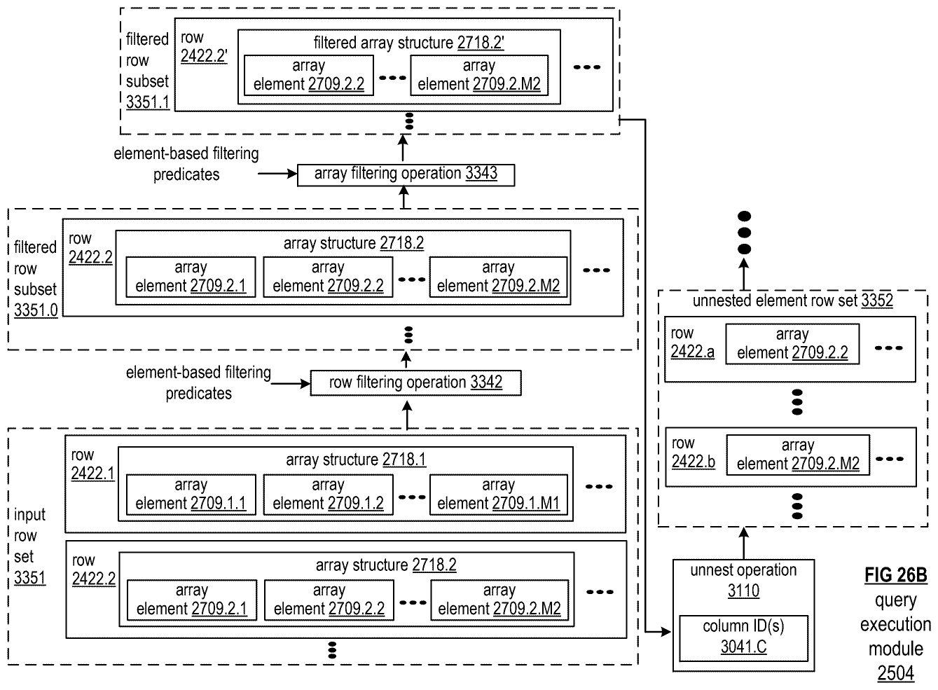

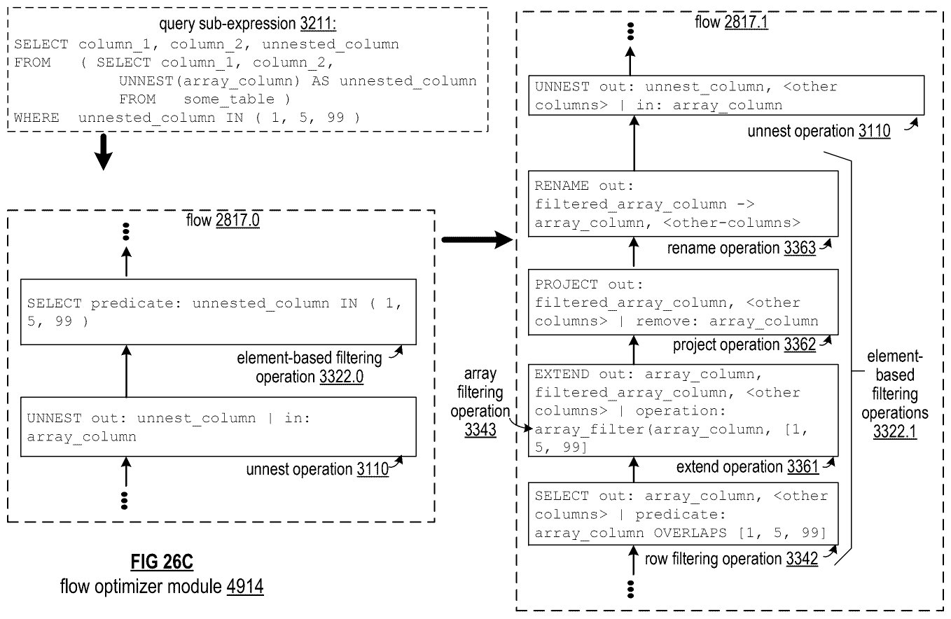

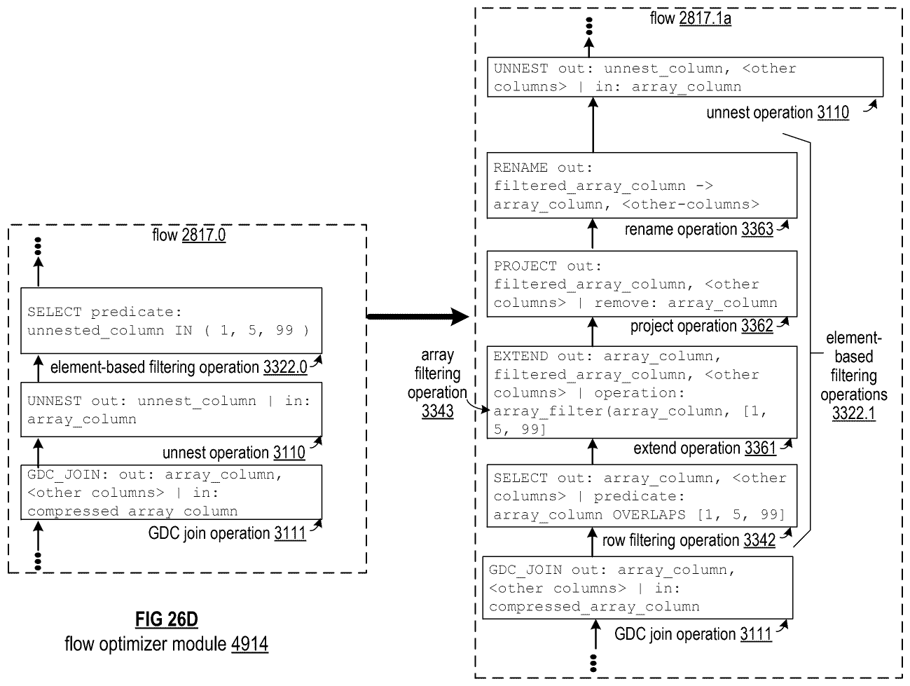

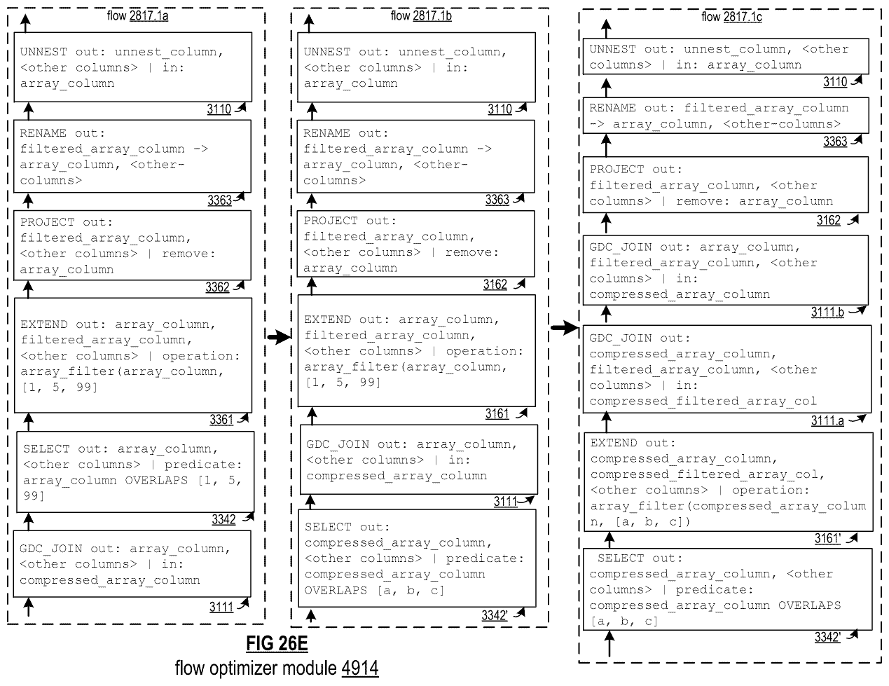

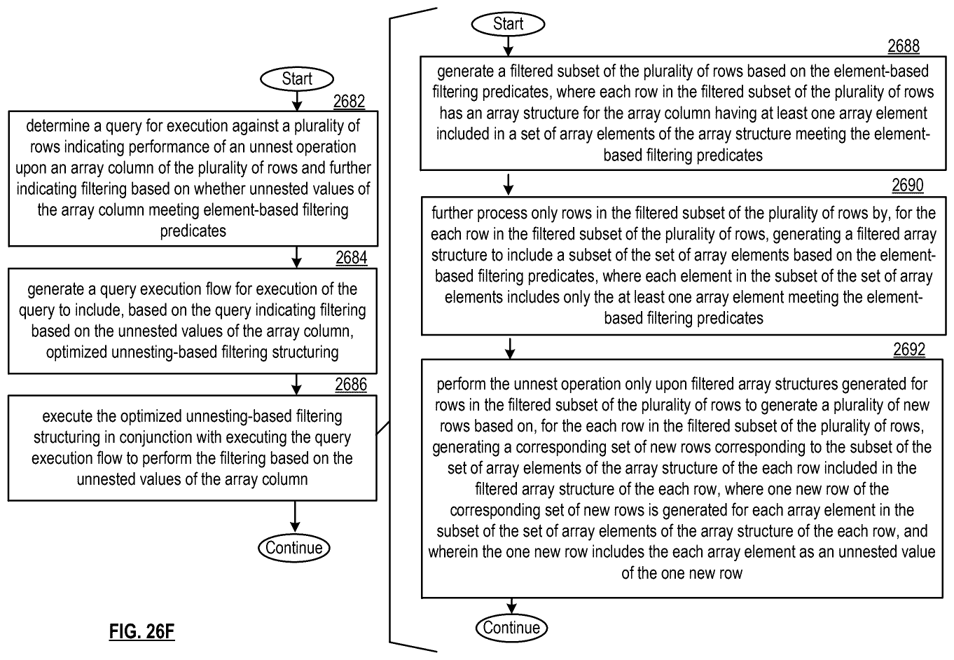

FIGS. 26A-26E present embodiments of database system 10 operable to optimize query execution flows when processing queries calling an unnest function upon an array column and filtering corresponding output by element-based filtering predicates for the array elements of the array column. Some or all features and/or functionality of query optimization and/or execution of FIGS. 26A-26E can implement any embodiment of database system 10 described herein.

In some embodiments, queries accessing array structures often use an unnest operation (e.g. the SQL UNNEST( ) function for queries structured in accordance with SQL) to expand array contents into rows.

For example, consider the following example query (or portion of a larger query) for to unnest an array and then to filter on the unnested values:

| SELECT column_1, column_2, unnested_column | |
|---|---|
| FROM ( | SELECT column_1, column_2, |
| | UNNEST(array_column) AS |

unnested_column

FROM some_table )

WHERE unnested_column IN ( 1, 5, 99 )

In some embodiments (e.g. in cases where some or all query requests are generated automatically by tools rather than by human input), it is not uncommon to have 100s or 1000s of elements in the array and/or the filtering IN-predicate in the WHERE clause. In some embodiments of execution of such queries, the unnest operation is performed and rows are thus built for each of the elements in the arrays from “array_column”. However this can result in a potentially huge intermediate result, which is subsequently reduced by the IN-predicate.

FIGS. 26A-26E present functionality in executing such a query that generates an extended/derived column, containing the arrays but filtered down to the element from the select operator. This can include utilizing an optimizer that is responsible for detecting above outlined situations and transforming the query plan accordingly to exploit the array-filter functionality.

FIG. 26A illustrates an embodiment of a database system 10 that implements a flow optimizer module 4914 (e.g. implementing an optimizer) that is applied via operator flow generator module 2514 in processing some or all query expressions 2511 for execution via query execution module. In particular, an initial query execution flow 2817.0 can be transformed into a semantically equivalent query execution flow 2817.1 (e.g. that is known/expected to be more efficient than query execution flow 2817.0) for execution of the corresponding query. Some or all features and/or functionality of either query execution flow 2817 and/or the operator flow generator module 2514 of FIG. 26A can implement any embodiment of query execution flows (e.g. operator execution flow 2517 and/or 2433) and/or operator flow generator module 2514 described herein.

The operator flow generator module 2514 can be adapted to apply flow optimizer module 4914 to some or all such queries with filtering upon rows emitted by unnest functions. For example, consider a query expression indicating an unnest operation 3110 indicating a column identifier 3141.C for a corresponding array field 2712 storing array structures 2718, and further indicating one or more predicates 2822 to filter rows emitted as output of the unnest operation via element-based filtered predicates to be applied to corresponding unnested values 3149 (e.g. elements of the array structures 2718 unnested into different rows).

An initial flow 2817.0 can indicate that the unnest operation 3110 be performed upon an input plurality of rows first to generate new rows via unnesting array elements of each given array structure 2718 of each row in the input plurality of rows into their own rows. An initial flow 2817.0 can indicate that the new rows be processed via element-based filtering operations 3220.0 via applying the filtering parameters 3048 to perform the element-based filtering predicates applied to unnested values 3149.

The flow optimizer module 4914 can generate an updated flow 2817.1 for execution, for example, based on detecting unnesting-based filtering optimizing conditions 3419 and/or otherwise determining that the flow can be optimized via the strategy discussed herein. This can include first performing one or more element-based filtering operations 3322.1 to apply the filtering parameters 3048, which can be adapted to filter the plurality of rows by their full array structure 2718, as the new rows generated via unnesting the array elements into different rows will not have yet been performed. Next, after the input plurality of rows has been filtered, the unnest operation can be performed, resulting in a smaller set of new rows being generated in the case where at least one of the plurality of input rows is filtered out, which can improve query efficiency over the case of the initial flow where more new rows are unnecessarily generated only to be filtered out in accordance with the filter parameters 3048 later.

FIG. 26B illustrates an example embodiment of query execution module 2504 executing the query execution flow 2817.1 of FIG. 26A, for example, generated via the transformation of query execution flow 2817.0 via the flow optimizer module 4914. Some or all features and/or functionality of the query execution module 2504 of FIG. 26B can implement the query execution module 2504 of FIG. 26A and/or any other embodiment of query execution module described herein. The row filtering operation 3342 and the array filtering operation 3343 of FIG. 26B can implement the element based filtering operations 3322.1 of FIG. 26A and/or any other embodiment of the element based filtering operations, row filtering operation, and/or array filtering operation described herein. The unnest operation 3110 of FIG. 26B can implement the unnest operation of FIG. 26A and/or any other embodiment of unnest operation 3110 described herein.

A plurality of rows 2422 included in input row set 3351 can be processed via a row filtering operation 3342. The input row set 3351 can be accessed from storage resources and/or can be emitted by prior operators in the query execution plan. Each row 2422 can include an array structure 2718 (or null value) of an array field 2712 (e.g. a corresponding column having column ID 3041.C) and each array structure 2718 can include a set of array elements 2709 (e.g. different rows have same or different number M of elements).

The row filtering operation 3342 can filter rows by applying element-based filtering predicates to generate a filtered row subset 3351.0 that include only rows 2422 of the input row set 3351 having array structures 2718 that include at least one array element 2709 meeting the element based filtering predicates of the filter parameters 3048. In this example, filtered row subset 3351.0 does not include row 2422.1 based on its array structure 2718.1 having no array elements meeting the element-based filtering predicates, and/or the filtered row subset 3351.1 does include row 2422.2 based on its array structure 2718.2 having at least one array element meeting the element-based filtering predicates. In some embodiments, the row filtering operation 3342 can optionally implement probabilistic filtering to generate filtered row subset 3351 as a superset of the true set of rows having array structures 2718 that include at least one array element 2709 meeting the element based filtering predicates of the filter parameters 3048, for later filtering.

An array filtering operation can filter elements within array structures 2718 of the filtered row subset 3351.0 to generate a filtered row subset 3351.1. In particular, rows are not further filtered (e.g. the same set/number of rows are included in filtered row subset 3351.0 and 3351.1), but their array structures 2718 undergo filtering under element based filtering predicates of the filter parameters 3048 to render filtered array structures 2718′, where each array structure 2718 is filtered to include only array elements 2709 meeting the meeting the element based filtering predicates of the filter parameters 3048. In this example, filtered array structure 2718.2′ does not include array element 2709.1 based on array element 2709.1 not meeting the element-based filtering predicates, and/or the filtered array structure 2718.2′ does include array element 2709.2 and/or array element 2708.M2 based on array elements 2709.2 and 2709.M2 meeting the element-based filtering predicates. All array structures 2718 of rows 2422 of filtered row subset 3351.1 can be guaranteed to include at least one array element based on the filtered row subset 3351.0 being generated based on including only rows with array structures 2718 having at least one such array element meeting the filtering parameters 3048. In some embodiments, the array filtering operation 3343 can optionally implement probabilistic filtering to generate each filtered array structure 2718 as a superset of the true set of elements meeting the element based filtering predicates of the filter parameters 3048, for later filtering.

An unnest operation can be performed upon filtered row subset 3551.1 to generate a new set of rows corresponding to an unnested element row set 3352, where each row includes an array element 2709 of one of the filtered array structures 2718′ of the filtered row subset 3351.1 (e.g. in a column of the new set of rows corresponding to unnested values of the filtered array structure 2718′). Thus, each array element 2709 across filtered array structures 2718′ of various rows 2422 of filtered row subset 3351.1 include can be included in its own new row 2422 of the unnested element row set 3352. For example, at least rows 2422.a and 2422.b are generated from row 2422.2, where row 2422.a includes array element 2709.2.2 and/or where row 2422.b includes array element 2709.2.M2. The unnested element row set 3352 is optionally further processed and/is included in the query resultant, for example, as specified by the query and/or corresponding query execution flow 2817.1.

These array elements 2709 of the new rows can correspond to the unnested value 3149, which can be guaranteed to already meet the element-based filtered predicates of the filtered parameters 3148 of predicates 2822 based on having already performed the row filtering operation 3342 and array filtering operation 3343. In the case where probabilistic filtering was applied, further filtering can be applied to unnested element row set 3352.

FIG. 26C illustrates a particular example flow 2817.1 generated from an example flow 2817.0 by a flow optimizer module 4914 in conjunction with operator flow generator module 2514 processing an example query expression 3211 for execution. Some or all features and/or functionality of the flow 2817.0, flow 2718.1, and/or flow optimizer module 4914 of FIG. 26C can implement the flow 2817.0, flow 2718.1, and/or flow optimizer module 4914 of FIG. 26A, and/or any embodiment of operator execution flows and/or their corresponding generation/optimization described herein.

The example query sub-expression 3211 of FIG. 26C corresponds to the example query fragment presented above, which can be implemented via some or all of the following logic:

| SELECT column_1, column_2, unnested_column | |
|---|---|
| FROM ( | SELECT column_1, column_2, |
| | UNNEST(array_column) AS |

unnested_column

FROM some_table )

WHERE unnested_column IN ( 1, 5, 99 )

This query sub-expression can correspond to a portion of, or all of, the query expression 2511 of FIG. 26A.

An initial flow 2817.0 generated from this query sub-expression can be generated, which can be implemented via some or all of the following logic:

SELECT predicate: unnested_column IN ( 1, 5, 99 )
UNNEST out: unnest_column | in: array_column

The select operation can include an IN-list predicate, indicating selection of only new rows having unnested values 3149 contained in the corresponding list (in this example, the list (1, 5, 99)), thus indicating the unnested values 3149 must be equal to one of the values in the list (in this example, must be equal to 1 or 5 or 99). This IN-list predicate can thus correspond to the filter parameters 3148.

Note that the select operation can optionally indicate additional predicates, e.g.:
SELECT predicate: unnested_column IN (1, 5, 99) AND . . .

For example, transforming the above query plan fragment results in a new fragment, which can be implemented via some or all of the following logic:

```
SELECT ... -- only kept if there are other predicates
  UNNEST out: unnest_column, <other columns> | in: array_column
    RENAME out: filtered_array_column −> array_column,
    <other-columns>
      PROJECT out: filtered_array_column, <other columns> |
      remove: array_column
        EXTEND out: array_column, filtered_array_column, <other
      columns> | operation: array_filter(array_column, [1, 5, 99])
          SELECT out: array_column, <other columns> | predicate:
          array_column
        OVERLAPS [1, 5, 99]
```

The bottommost SELECT operation can be implemented as row filtering operation 3342. Continuing upwards in the plan: the EXTEND operation can be implemented as extend operation 3361, where the array_filter( ) function within this EXTEND operation can be implemented as the array filtering operation 3343; the PROJECT operation can be implemented as project operation 3362; the RENAME operation can be implemented as rename operation 3363; and/or the UNNEST operation can be implemented as the unnest operation 3110. While the topmost SELECT operation can be implemented in flow 2817, serially after the unnest operation 3110, for example, in the case where there are additional predicates.

Note that in applying this strategy, the filter predicate from the original SELECT operator is removed. In fact, the whole SELECT operator is removed, unless it has other predicates that are unrelated to “unnest_column”—or check different conditions on “unnest_column” that cannot be expressed via a value-based filter. Removing the IN-list predicate works because the array_filter( ) function produces arrays that only contains elements that would have passed the original predicate in the SELECT operator.

In the new transformed plan, a new SELECT operator can be added to test whether the arrays actually contain any of the values in the IN-list (e.g. in accordance with SQL syntax/functionality) implemented as the filter parameters 3148. For example, an array (stored in “army column”) with [0, 2, 4, 8, 16] does not have any element that would satisfy the predicate “IN (1, 5, 99)”. Therefore, it is not necessary to apply the array filter on it as the filter would only return an empty army.

Note that this new SELECT operator is mandatory if the unnest operator is instructed to emit a NULL value for empty arrays or if the army itself is NULL. This can be implemented as the default behavior, and/or can optionally be controlled clause NULL_INPUT [NO], which can translates to an internal flag emitNullInputArrays. If the SELECT operator were omitted, such an empty filtered array would be converted to a NULL value. Thus, a row comprised of the values for <other columns> and this NULL value is created. This is different semantics compared to applying the original IN-list predicate, which filters out rows having such a NULL value.

The EXTEND operator can implement the filtering in such embodiments applying this strategy, for example, based on receiving the column (“array_column”) as input, and probes each element in each array against the filter criteria. A hash map can be used for this probing in some embodiments.

The EXTEND operator can be implemented to merely add a new column (for the filtered arrays). Therefore, a new PROJECT operator optionally needs to be added to remove the original “array_column” so that only the filtered army column remains. Further, the RENAME operator can be implemented to ensure that “filtered_array_columns” (added by the EXTEND) is renamed to “array_column”. This can be needed because there may be other upstream operators in the plan expecting a column named “array_column” as input. In some embodiments, it would be possible to traverse all upstream-operators and rename the input columns there. However, RENAME operators can exist for the purpose of not having to do such a traversal.

In some embodiments, the type of filter predicates 3148 required to apply this strategy (e.g. required to meet unnesting-based filtering optimizing conditions 3419) correspond to equality comparisons. This can cover covers IN-list predicates like shown in this example, and/or predicates indicating equality, such as:
unnest_column=1 OR unnest_column=5 OR unnest_column=99

In some embodiments, Predicates that always evaluate to “false” (i.e. a tautology) may exist temporarily in the query plan when the transformation is done. Such predicates can be ignored as they have no effect, e.g.
. . . OR 1=0 . . .

In other embodiments, other types of predicates such as inequality and/or between predicates can be supported in applying this strategy.

FIGS. 26D and 26E illustrate embodiments where GDC is supported, for example, in the case where the array column is implemented as a compressed column compressed via global dictionary compression (e.g. each array structure has compressed array elements compressed via GDC). In particular, FIGS. 26D and 26E illustrates other particular example flows 2817.1a, 2817.1b, and 2817.1.c generated from an example flow 2817.0 by a flow optimizer module 4914 in conjunction with operator flow generator module 2514 processing an example query expression 3211 for execution. Some or all features and/or functionality of the flow 2817.0, flow 2718.1a, flow 2817.1b, flow 2817.1c, and/or flow optimizer module 4914 of FIG. 26C can implement the flow 2817.0, flow 2718.1, and/or flow optimizer module 4914 of FIG. 26A, and/or any embodiment of operator execution flows and/or their corresponding generation/optimization described herein. Some or all features and/or functionality of GDC join operation 3111 of FIGS. 26D and/or 26C can implement any embodiment of GDC joins and/or any decompressing of compressed values described herein.

As discussed previously herein, in some embodiments, Global Dictionary Compression (GDC) can be implemented as a mechanism to encode values using a short, fixed-length representation. This mapping is stored in the dictionary. If arrays are compressed with GDC, the mapping applies to the elements within the array (potentially recursive in case of arrays-of-arrays) and not the array itself. In some embodiments, it is beneficial to perform database operations like joins or filters on the dictionary-encoded values and decode them as late as possible during query processing.

Filtering arrays as described here can be done on dictionary-encoded values. This can requires rewriting the filter array ([1, 5, 99] in the running example) into code space. In cases where the IN-list predicate is comprised of literals, the filter-array can be implemented as a literal value as well. Converting that to code space can be implemented as a one-time operation that can be done during optimization of the SQL statement (e.g. via flow optimizer module 4914).

An intermediate plan can have structure as illustrated in flow 2817.0 of FIG. 26D, which can include implementing some or all of the following logic:

```
SELECT out: unnest_column, <other columns> | predicate:
unnested_column IN ( 1, 5, 99 ) AND
...
  UNNEST out: unnest_column, <other columns> | in: array_column
    GDC_JOIN: out: array_column, <other columns> | in:
    compressed_array_column
```

The GDC join 3111 can be implemented to replace “compressed_array_column” with “array_column” (which is uncompressed), which can be implemented as a “replacement join”.

The goal in optimization can be to add an EXTEND operator for the array filtering below the GDC_JOIN operator. The first step can be to apply the transformation described in conjunction with FIGS. 26A-26C, adapted for GDC joins, resulting in the structure illustrated in flow 2817.1a of FIGS. 26D, which can include implementing some or all of the following logic:

```
SELECT ... -- only kept if there are other predicates
  UNNEST out: unnest_column, <other columns> | in: array_column
    RENAME out: filtered_array_column −> array_column,
    <other-columns>
      PROJECT out: filtered_array_column, <other columns> |
      remove: array_column
        EXTEND out: array_column, filtered_array_column, <other
      columns> | operation: array_filter(array_column, [1, 5, 99])
          SELECT out: array_column, <other columns> | predicate:
        array_column OVERLAPS [1, 5, 99]
            GDC_JOIN out: array_column, <other columns> | in:
          compressed_array_column
```

In some embodiments, subsequent steps are performed in optimizing such flows, for example, as illustrated in FIG. 26E. This can include further optimizing the flow to push select and/or extend operations beneath the GDC join, for example, via implementing some or all features and/or functionality of optimizing flows and corresponding pushing down of operators as described in U.S. Utility patent application Ser. No. 18/485,861.

A subsequent step can be performed (e.g. via flow optimizer module 4914) to push-down the lower SELECT operator (e.g. row filtering operation 3342) with the army filter below the GDC join. This can be utilized to translates array ([1, 5, 99]) to code space (denoted as [a, b, c] in the following plan fragment), swaps GDC_JOIN and SELECT, and then changes the SELECT to work on “compressed_array_column”. This can result in the structure illustrated in flow 2817.1b of FIGS. 26E, which can include implementing some or all of the following logic:

```
SELECT ... -- only kept if there are other predicates
  UNNEST out: unnest_column, <other columns> | in:
  array_column
    RENAME out: filtered_array_column −> array_column,
    <other-columns>
      PROJECT out: filtered_array_column, <other columns> |
      remove:
    array_column
        EXTEND out: array_column, filtered_array_column, <other
      columns> | operation: array_filter(array_column, [1, 5, 99])
          GDC_JOIN out: array_column, <other columns> | in:
        compressed_array_column
            SELECT out: compressed_array_column, <other
            columns> |
          predicate: compressed_array_column OVERLAPS
          [a, b, c]
```

A further subsequent step can be performed (e.g. via the flow optimizer module 4914) to push the EXTEND operator below the GDC_JOIN. In some cases, it may not be semantically correct to simply modify the GDC_JOIN to work on “filtered_array_column”. The reason is that “array_column” is also passed upstream in some embodiments. In the example shown here, “array column” can be filtered out by the PROJECT operator, but there can be other operators between EXTEND operator and PROJECT operator in some embodiments, and such operators may reference “array_column”! Such operators may have been placed there intermediately due to other plan optimization and rewrite rules, for example, based on the corresponding query expression.

In such embodiments, it can be necessary to add a new GDC_JOIN operator specifically handling the extended column “filtered_aray_column”. This can result in the structure illustrated in flow 2817.1c of FIGS. 26E, which can include implementing some or all of the following logic:

```
SELECT ... -- only kept if there are other predicates
  UNNEST out: unnest_column, <other columns> | in: array_column
    RENAME out: filtered_array_column −> array_column,
    <other-columns>
      PROJECT out: filtered_array_column, <other columns> | remove:
    array_column
        GDC_JOIN out: array_column, filtered_array_column, <other
      columns> | in: compressed_array_column
          GDC_JOIN out: compressed_array_column,
        filtered_array_column, <other columns> | in:
        compressed_filtered_array_column
            EXTEND out: compressed_array_column,
          compressed_filtered_array_column, <other columns> |
          operation: array_filter(compressed_array_column, [a, b, c])
              SELECT out: compressed_array_column, <other
            columns> | predicate: compressed_array_column
            OVERLAPS [a, b, c]
```

Although, this results in another join to the plan (which is often not desired in some embodiments), in some embodiments, it is not a problem in this case. Subsequent optimizations can be implemented to push down any operator between the PROJECT and the GDC_JOIN again. Thus, the optimizer can finds that “array_column” is projected-out and the GDC_JOIN for it is no longer needed. This can result in the optimizer removing the GDC_JOIN operator for “array_column” as well.

Although, this adding a new GDC_JOIN and later removing the original one can be complicated, it has its benefits: pushing an array filter EXTEND below a GDC JOIN can be done independent of any other optimizations algorithm and independent of the placement of any other operators in the plan. So more flexibility and opportunities during optimizations are achieved—and that comes with much reduced complexity due to fewer dependencies between optimization algorithms. At the same time, the plan remains consistent after pushing down the EXTEND.

In some embodiments, a special situation is, for example, a predicate like “IN (1, 5, 99, 9876)” where there is no dictionary-mapping for value 9876. This can happen in case none of the array values in “array column” contains an element with this value. Depending on the query semantics, this unmapped value can either be omitted when GDC-encoding the filter array, or this value can be added to the dictionary (during optimization). In some embodiments, if the database system provides snapshot isolation, where a query will see only those rows that existed when the query (or its transaction) started, it can be impossible that new values may come into existence during query execution. Thus, the unmapped value can be omitted. However, if the database system has more loose isolation requirements, it can be possible that a concurrent transactions inserts/loads new data. This new data may be processed during query execution, and it could potentially contain an array with value 9876. Thus, it can be necessary to GDC-encode the value found in the IN-list predicate in these cases (e.g. during optimization via optimizer 4914).

In some embodiments, an array filter extend operation can be avoided. For example, the new SELECT operator adding the OVERLAP is needed for semantical reasons, but it also comes with improved performance. In some embodiments, for any array value that does not overlap with the values in the IN-list, no extended column value will be built.

In some embodiments, processing an array filter EXTEND operator during query execution (e.g. inside an extendOperatorInstance) can come with processing overhead. For example, of the arrays stored in “array_column” are generally short (e.g. just a few values), adding such an EXTEND operator may not be beneficial at all. Unnesting the arrays can scale with the number of array elements.

In some embodiments, statistics are available like the average number (or a distribution) of elements for the values in “array column”. In some embodiments, this information can be exploited to make a decision whether an EXTEND operator adding “filtered_array_column” shall be used or not (e.g. via optimizer 4914).

In some embodiments, the size of the filter array, which can be derived from the IN-list predicate, does not matter. In some embodiments, a hash table is built for this filter array, which is a one-time operation. In some embodiments, this can be efficient, for example, because lookup into a hash table has constant complexity (O(1)), typically.

In some embodiments, the implementation of the runtime operator for adding the filtered array column can be straight-forward. The plan compiler (e.g. the operator flow generator module 2514) can receive the filter array ([1, 5, 99]) as input and can build a hash table, which can be accessed by the corresponding operator at runtime. The corresponding operator can iterate over all elements in each array, probing into the hash table to determine whether each given element can be found. If so, the element is added to the new array that is built for the extended/derived column.

In some embodiments, the operator flow generator module is configured to implement such strategy when handling GDC-Encoded Tuples. In some embodiments, for unencoded tuples, array-filtering can be implemented without special considerations, for example, via same or similar functionality discussed in conjunction with FIGS. 26A-26C. However, for encoded tuples, array-filtering can be performed via further adapting the strategy for this case.

In particular, in some embodiments, tuple values (e.g. tuple<<int,char,double>>) can be GDC-encoded in storage. GDC-encoded tuples can be decoded via multiple GDC joins. Each GDC join optionally handles exactly one tuple element only. As discussed previously, pushing an EXTEND operator doing the array-filtering below a GDC join can be a more complex plan transformation. This plan transformation can thus need to be done for each tuple element, and it can be very well possible that the GDC joins for the tuple elements may: be placed wide apart in the plan due to other optimizations steps that have taken place before; some tuple elements may not even have a GDC join for decompression (anymore) in case the optimizer already detected that the tuple element is not used and purged it from the plan already.

In some embodiments, the operator flow generator module is configured to implement such strategy only when handling a single column to be unnested. In some embodiments, the operator flow generator module is configured to implement such strategy when handling multiple columns to be unnested. While multiple unnest columns are not so frequently used in query expressions in some embodiments, it is possible to extend the mechanism to multiple columns, for example, where each column need to be inspected separately to determine whether an array filter is beneficial. In some embodiments, it is not an option to decompose an “UNNEST(column_1, column_2)” into two stacked UNNEST operators in a plan, for example, due to the semantics of a multi-column unnest, which can processes the elements in the arrays in “column_1” and “column_2” in step-lock.

In some embodiments, only equality predicates (=) are handled in applying this strategy during query optimization. For example, IN-list predicates like “column IN (1, 5, 99)” are rewritten, for example, as:
column=1 OR column=5 OR column=99

This can lend itself directly to using a hash table for the lookup of array elements, for example, as discussed previously.

In other embodiments, other predicates (e.g. inequality predicates) like BETWEEN, ‘<’, ‘<=’, ‘>=’, or ‘>’ can be supported as well. This can require enhancements during the runtime to check efficiently for each element of an array whether it satisfies the predicate. In some embodiments, the GDC compression adds another layer of complexity. For example, if the dictionary-based compressed is not order-preserving, predicates like less-than may produce wrong results in code space.

In some embodiments, the optimizer can be configured to pushing down the array filter extend into the pipeline io operator for execution in conjunction with executing the IO pipeline. In some embodiments, the array filter extent is optionally not implemented in the IO pipeline, for example, because arrays are implemented as variable length values, and/or because the pipeline IO only supports extends that generate fixed-length columns.

In some embodiments, the unnest operator allows specification of an ordinal clause in the query expression (e.g. the ORDINAL clause in the SQL UNNEST( ) function). In such embodiments, when unnesting an array, each array element is populated in the unnested column, and another column is added, which stores the position of the element in the original array. For example, array [4, 8, 2] results in table:

| Element | Ordinal |
|---|---|
| 4 | 1 |
| 8 | 2 |
| 2 | 3 |

In some embodiments, when an array is filtered, the ordinal position of elements changes. For example, filtering this array by predicate “IN (2, 8)” gives:

| Element | Ordinal |
|---|---|
| 8 | 1 |
| 2 | 2 |

In some embodiments, ordinals can be preserved based on the filtered array in the extended column storing not only the element itself but also its original ordinal. Upstream operators can be aware of this adaptation to the extended column to properly process such data. This can affect many operators that deal with array values in some way. In such cases, the additional information can optionally be encapsulated into arrayType_t (e.g. object type for array structures 2718) itself. Alternatively or in addition, the extend operator can be adapted (e.g. via a new type of extend operator) that emits two new columns—one containing the element value, and the other containing the ordinal value.

FIG. 26F illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 26F, for example, based on participating in execution of a query being executed by the database system 10. Some or all of the method of FIG. 26F can be performed by nodes executing a query in conjunction with a query execution, for example, via one or more nodes 37 implemented as nodes of a query execution module 2504 implementing a query execution plan 2405. In some embodiments, a node 37 can implement some or all of FIG. 26F based on implementing some or all of a plurality of processing modules 2610.1-2610.W, for example, as a corresponding plurality of processing core resources 48.1-48.W. Some or all of the steps of FIG. 26F can optionally be performed by any other one or more processing modules of the database system 10. Some or all of the steps of FIG. 26F can be performed to implement some or all of the functionality of the database system 10 as described in conjunction with FIGS. 26A-26E, for example, by implementing some or all of the functionality of query execution module 2504, flow optimizer module 4914, row filtering operation 3342, array filtering operation 3343, and/or unnest operation 3110. Some or all steps of FIG. 26F can be performed by database system 10 in accordance with other embodiments of the database system 10 and/or nodes 37 discussed herein. Some or all of the steps of FIG. 26F can be performed in conjunction with performing some or all steps of any other method described herein.

Step 2682 includes determining a query for execution against a plurality of rows indicating performance of an unnest operation upon an array column of the plurality of rows and further indicating filtering based on whether unnested values of the array column meeting element-based filtering predicates. Step 2684 includes generating a query execution flow for execution of the query to include, based on the query indicating filtering based on the unnested values of the array column, optimized unnesting-based filtering structuring. 2686 includes executing the optimized unnesting-based filtering structuring in conjunction with executing the query execution flow to perform the filtering based on the unnested values of the array column.

Performing step 2686 can include performing step 2688, 2690, and/or 2692. Step 2688 includes generating a filtered subset of the plurality of rows based on the element-based filtering predicates. In various examples, each row in the filtered subset of the plurality of rows has an array structure for the array column having at least one array element included in a set of array elements of the array structure meeting the element-based filtering predicates. Step 2690 includes further processing only rows in the filtered subset of the plurality of rows by, for the each row in the filtered subset of the plurality of rows, generating a filtered array structure to include a subset of the set of array elements based on the element-based filtering predicates. In various examples, each element in the subset of the set of array elements includes only the at least one array element meeting the element-based filtering predicates. Step 2692 includes performing the unnest operation only upon filtered array structures generated for rows in the filtered subset of the plurality of rows to generate a plurality of new rows based on, for the each row in the filtered subset of the plurality of rows, generating a corresponding set of new rows corresponding to the subset of the set of array elements of the array structure of the each row included in the filtered array structure of the each row. In various examples, one new row of the corresponding set of new rows is generated for each array element in the subset of the set of array elements of the array structure of the each row. In various examples, the one new row includes the each array element as an unnested value of the one new row.

In various examples, a query resultant for the query is generated based on the plurality of new rows.

In various examples, an initial query execution flow is generated to include initial structuring indicating the unnest operation be performed upon array structures of the array column for every row in the plurality of rows. In various examples, the query execution flow is generated based on optimizing the initial query execution flow to include the optimized unnesting-based filtering structuring instead of the initial structuring. In various examples, the optimized unnesting-based filtering structuring is semantically equivalent with the initial structuring.

In various examples, the method further includes performing an optimizing step to generate the query execution flow based on evaluating the initial query execution flow to determine whether an unnesting-based filtering condition is met. In various examples, the query execution flow is generated based on transforming the initial query execution flow to include the optimized unnesting-based filtering structuring based on detecting the unnesting-based filtering condition being met in the initial query execution flow.

In various examples, performing an optimizing step further includes evaluating whether to apply the optimized unnesting-based filtering structuring after determining the unnesting-based filtering condition based on further comparing at least one array size metric corresponding to number of elements included in array structures of the array column to a minimum array size threshold. In various examples, the query execution flow is generated based on transforming the initial query execution flow to include the optimized unnesting-based filtering structuring based on further determining the array size metric for the array column exceeds the minimum array size threshold.

In various examples, the filtered subset of the plurality of rows is generated based on applying a SELECT operation indicated in the optimized unnesting-based filtering structuring. In various examples, the filtered array structure is generated for the each row in the filtered subset of the plurality of rows based on applying an array filter function indicated in the optimized unnesting-based filtering structuring.

In various examples, further processing the only rows in the filtered subset of the plurality of rows further includes: generating a new column for the filtered subset of the plurality of rows to include the filtered array structure for the each row in the filtered subset of the plurality of rows; and/or after generating the new column, removing the array structure for the each row in the filtered subset of the plurality of rows based on removing the array column from the filtered subset of the plurality of rows.

In various examples, the new column is generated based on applying an EXTEND operation indicated in the optimized unnesting-based filtering structuring. In various examples, the array column is removed based on applying a PROJECT operation indicated in the optimized unnesting-based filtering structuring.

In various examples, the array column is identified via a corresponding array column name. In various examples, further processing the only rows in the filtered subset of the plurality of rows further includes: temporarily setting a temporary name for the new column prior to removing the array column; renaming the new column based on replacing the temporary name for the new column with the corresponding array column name.

In various examples, the new column is renamed based on applying a RENAME operation indicated in the optimized unnesting-based filtering structuring.

In various examples, the element-based filtering predicates indicates a set of values and requires that unnested values of the array column be equal to one of the set of values.

In various examples, the element-based filtering predicates indicates the set of values as an IN list predicate.

In various examples, the element-based filtering predicates indicates at least one of: a less than condition, a greater than condition, a less than or equal to condition, a greater than or equal to condition, or a BETWEEN condition.

In various examples, the each of set of array elements of the array structure of the each row of the filtered subset of the plurality of rows has a corresponding placement in the array structure based on the array structure being an ordered structuring of the set of array elements. In various examples, generating the filtered array structure includes preserving a set of ordinal values each indicating the corresponding placement of a corresponding one of the subset of the set of array elements in the array structure. In various examples, the plurality of new rows include an element column and an ordinal column. In various examples, the each array element of the one new row is included in the element column. In various examples, an ordinal value preserved for the each array element is included in the ordinal column.

In various examples, further processing the only rows in the filtered subset of the plurality of rows further includes: generating a first new column for the filtered subset of the plurality of rows to include the filtered array structure for the each row in the filtered subset of the plurality of rows; and/or generating a second new column for the filtered subset of the plurality of rows to include the a set of ordinal values for the subset of the set of elements included in the filtered array structure for the each row in the filtered subset of the plurality of rows.

In various examples, the array column is stored as a compressed column in conjunction with implementing of a global dictionary compression (GDC) strategy via maintaining of a global dictionary structure. In various examples, the query execution flow is generated based on pushing at least one operation implementing the generating of the filtered subset and the generating of the filtered array structure for the each row in the filtered subset below a GDC join operation based on applying coded element-based filtering predicates to compressed array elements of the array structure implement enforcement of the element-based filtering predicates based on a mapping indicated in the global dictionary structure. In various examples, further processing the only rows in the filtered subset of the plurality of rows further includes performing the GDC join operation upon the filtered array structure to render generation of an uncompressed filtered subset of the plurality of rows.

In various examples, the unnest operation corresponds to an UNNEST function of the structured query language (SQL).

In various examples, the query further indicates performance of a load operation. In various examples, the query execution flow includes a first instance of the load operation serially before a second instance of the load operation. In various examples, executing the query execution flow is further based on, after processing at least one row of the plurality of rows, switching from a first mode of operation that includes executing the first instance of the load operation to a second mode of operation that includes skipping execution of the first instance of the load operation.

In various examples, the query execution flow includes a scatter operator. In various examples, output generated by a node participating at an upper level of a hierarchical query plan in conjunction with execution of the corresponding query is dispersed across a set of nodes at a lower level of the hierarchical query plan for processing. In various examples, the set of nodes generate a corresponding plurality of subsequent output based on processing corresponding portions of the output. In various examples, the query resultant is based on the corresponding plurality of subsequent output.

In various embodiments, any one of more of the various examples listed above are implemented in conjunction with performing some or all steps of FIG. 26F. In various embodiments, any set of the various examples listed above can be implemented in tandem, for example, in conjunction with performing some or all steps of FIG. 26F, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 26F described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 26F, for example, in conjunction with further implementing any one or more of the various examples described above.

In various embodiments, the operational instructions, when executed by the at least one processor, cause the database system to: determine a query for execution against a plurality of rows indicating performance of an unnest operation upon an array column of the plurality of rows and further indicating filtering based on whether unnested values of the array column meeting element-based filtering predicates; generate a query execution flow for execution of the query to include, based on the query indicating filtering based on the unnested values of the array column, optimized unnesting-based filtering structuring; and/or execute the optimized unnesting-based filtering structuring in conjunction with executing the query execution flow to perform the filtering based on the unnested values of the array column. In various examples, executing the optimized unnesting-based filtering structuring in conjunction with executing the query execution flow to perform the filtering based on the unnested values of the array column is based on: generating a filtered subset of the plurality of rows based on the element-based filtering predicates, where each row in the filtered subset of the plurality of rows has an array structure for the array column having at least one array element included in a set of array elements of the array structure meeting the element-based filtering predicates; further processing only rows in the filtered subset of the plurality of rows by, for the each row in the filtered subset of the plurality of rows, generating a filtered array structure to include a subset of the set of array elements based on the element-based filtering predicates. In various examples, each element in the subset of the set of array elements includes only the at least one array element meeting the element-based filtering predicates; and/or perform the unnest operation only upon filtered array structures generated for rows in the filtered subset of the plurality of rows to generate a plurality of new rows based on, for the each row in the filtered subset of the plurality of rows, generating a corresponding set of new rows corresponding to the subset of the set of array elements of the array structure of the each row included in the filtered array structure of the each row, where one new row of the corresponding set of new rows is generated for each array element in the subset of the set of array elements of the array structure of the each row, and/or where a query resultant for the query is generated based on the plurality of new rows.

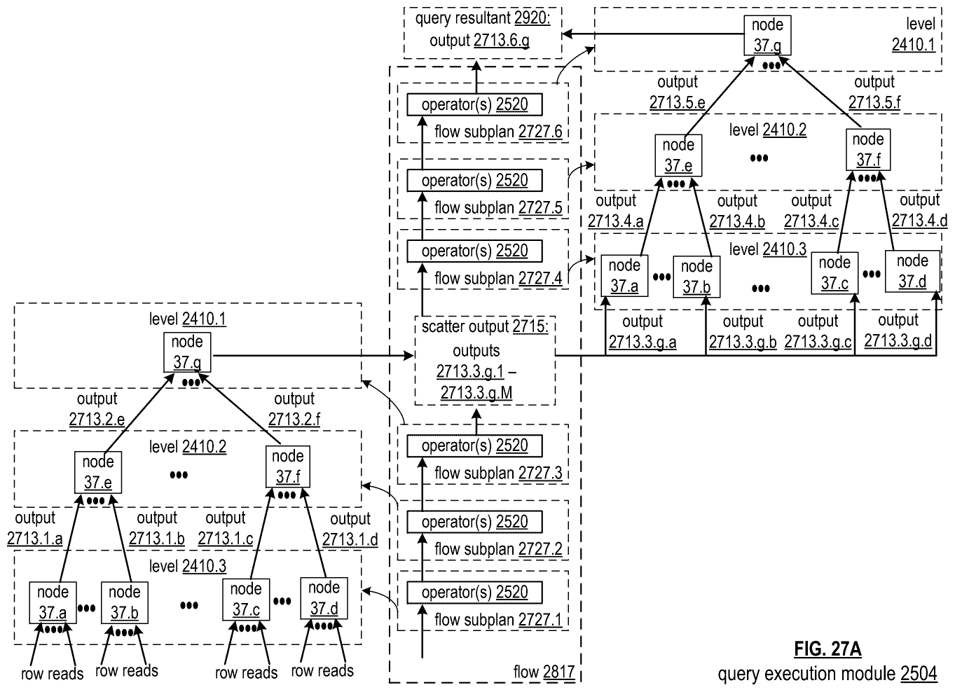

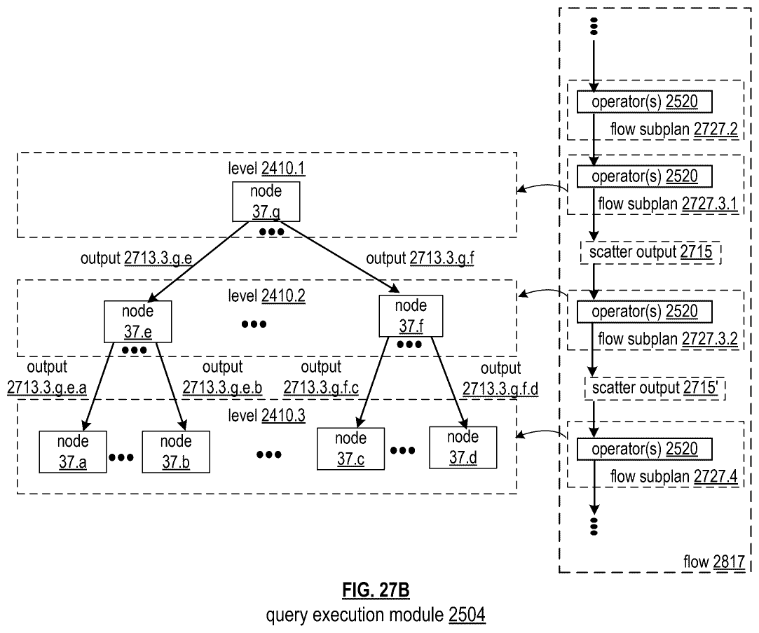

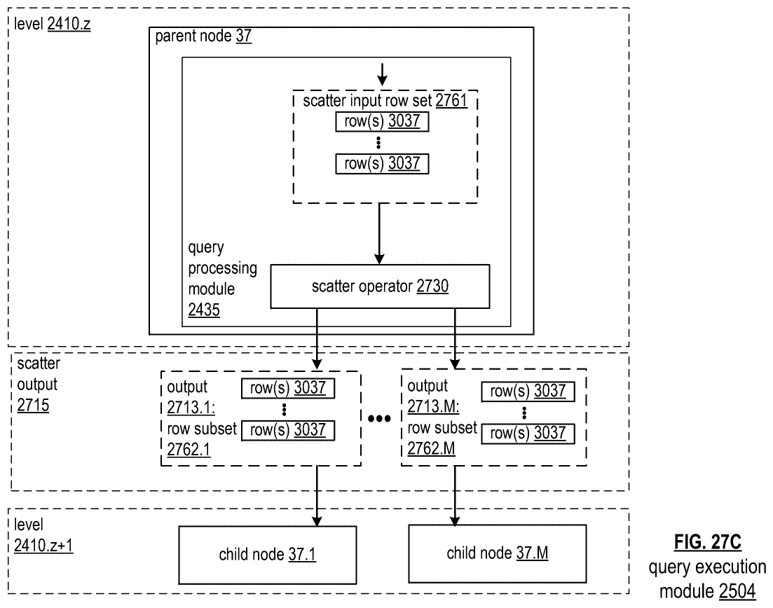

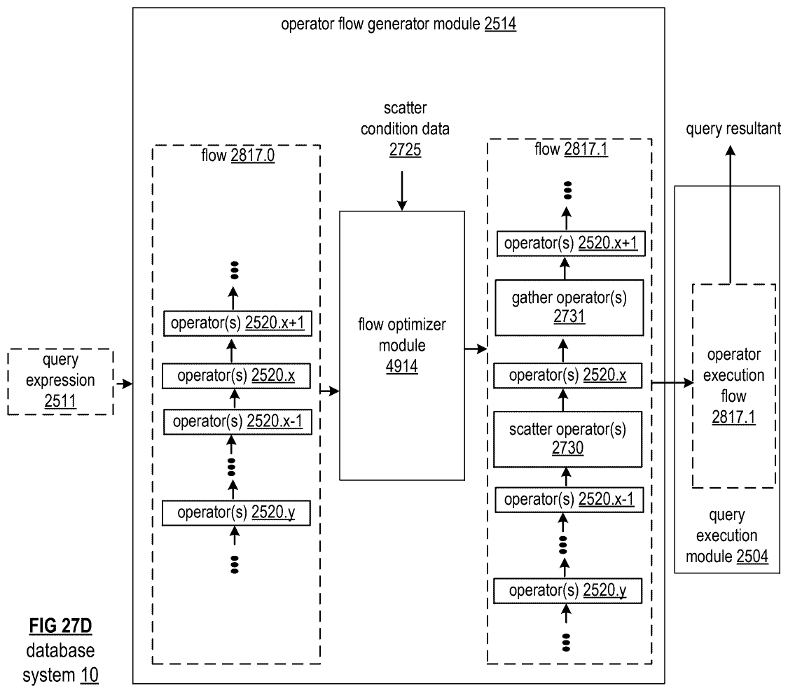

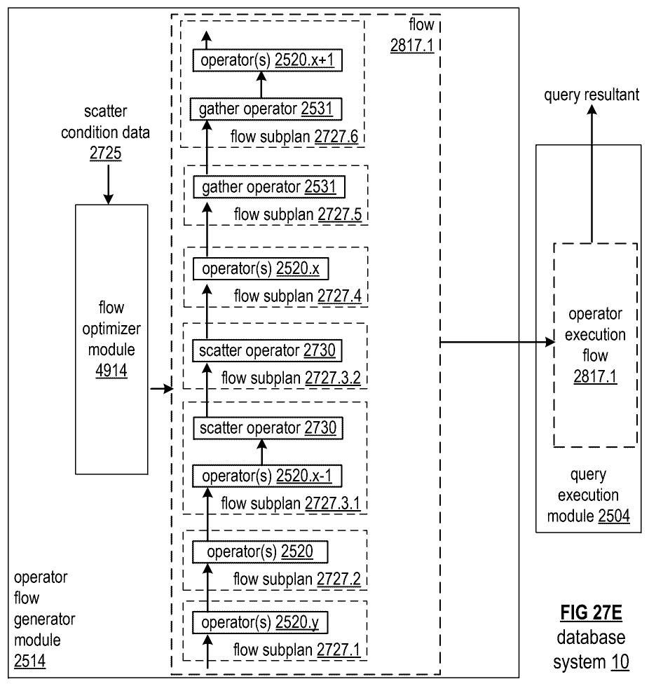

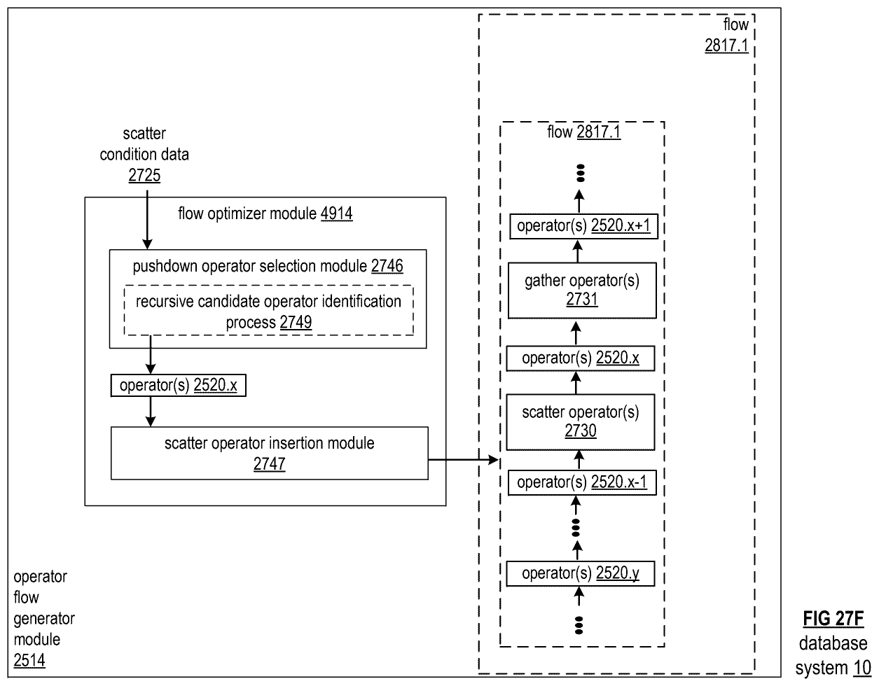

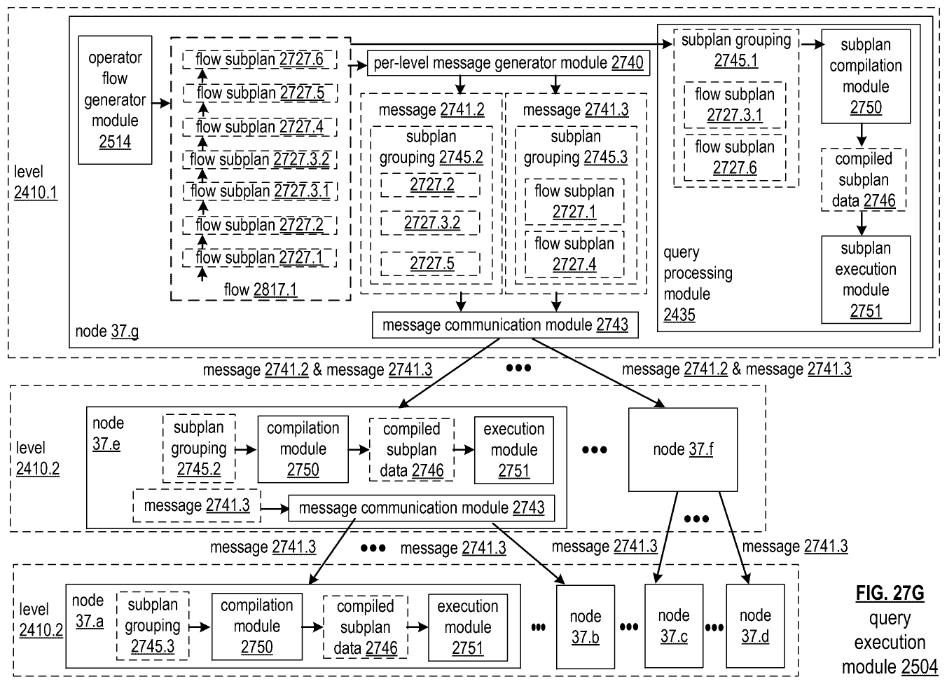

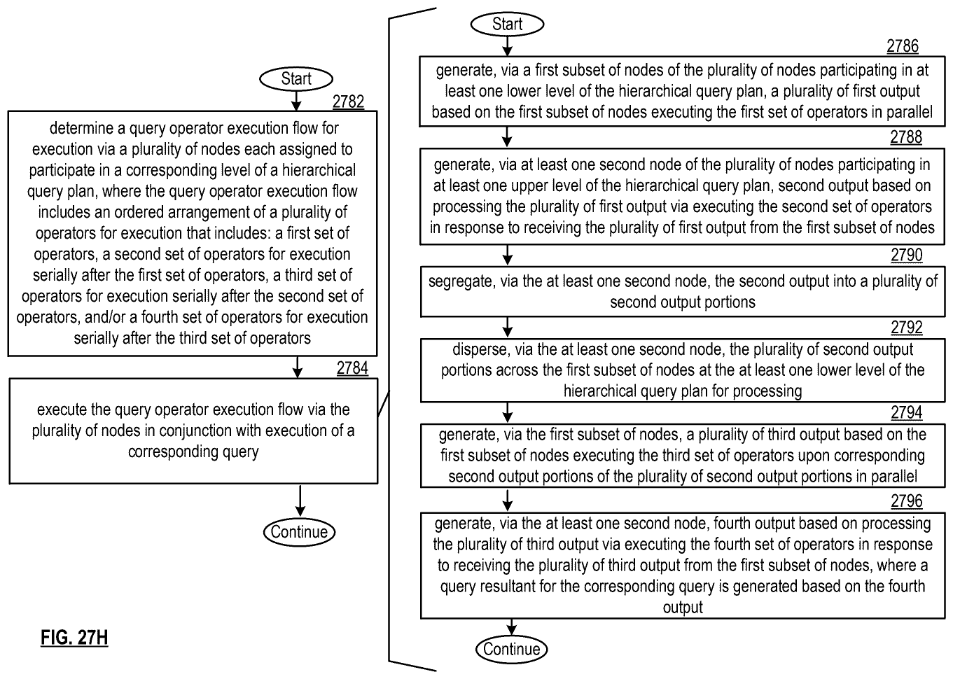

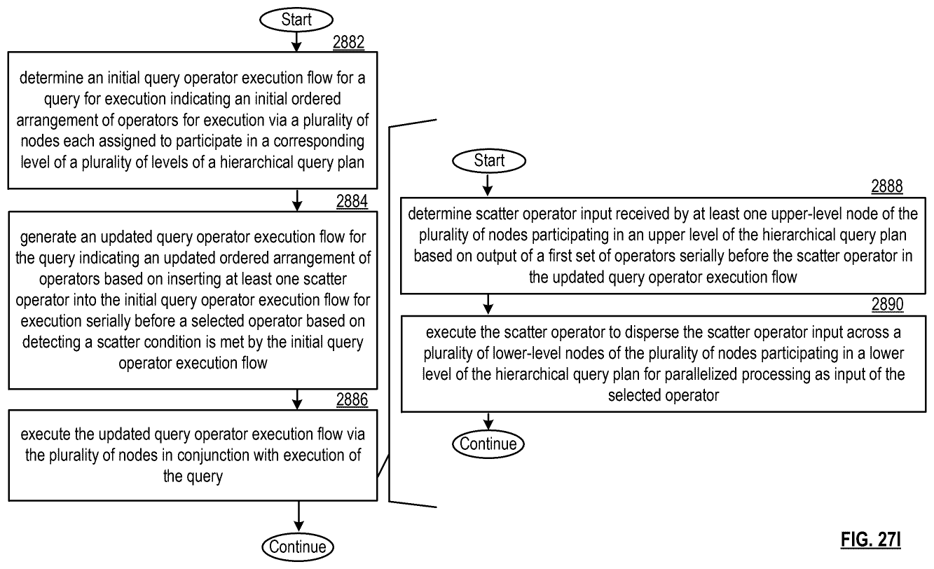

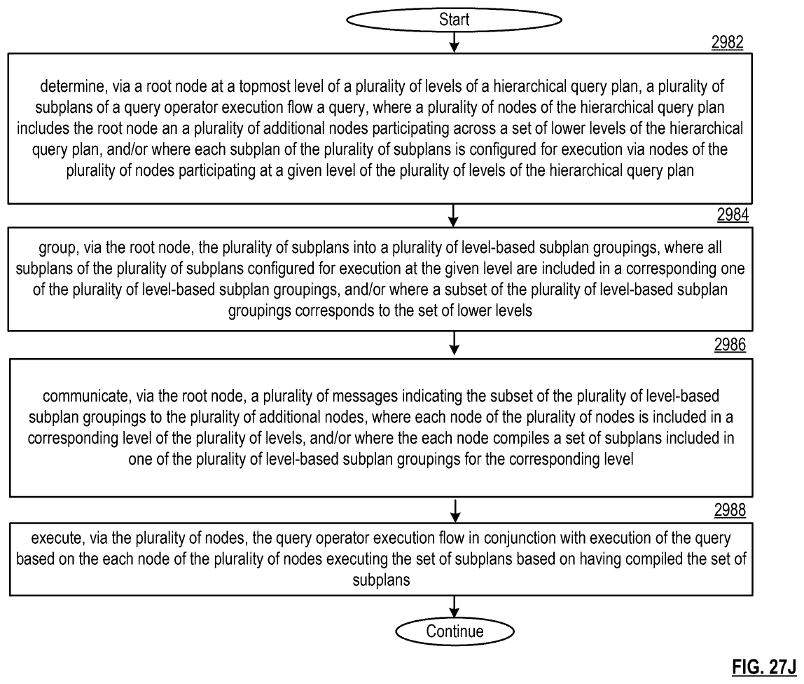

FIGS. 27A-27G illustrate embodiments of a database system 10 operable to execute queries via a hierarchical query execution plan based on enabling generation of output data generated via execution of operators via respective nodes to be “scattered” down to a lower level for parallelized processing, for example, in addition to “normal” upward propagation of output data from leaf nodes to the root node. Some or all features and/or functionality presented in FIGS. 27A-27G can implement any embodiment of query plan 2405, query execution module 2504, query operator execution flow 2433, 2517, and/or 2817, operator execution flow generator module 2514, and/or database system 10 described herein.

In some embodiments of executing queries via database system 10, data flows from a more parallel data-adjacent level of execution with many nodes (e.g. IO level 2416 that includes leaf level nodes, which can be implemented as a third level “L3” in a three level plan as discussed in conjunction with the examples of FIGS. 27A-27G) to a less parallel level of execution running on a single non-storage node (e.g. root level 2412 that includes a root node, which can be implemented as a first level “L1” in a three level plan), passing through at least one intermediate level which typically doesn't do much/any computation (e.g. one or more inner levels 2414, which can be implemented as a second level “L2” in a three level plan). In some embodiments, data strictly moves up the levels (L3→L1), for example, via gather operators, and optionally cannot move back down. For example, such functionality is discussed in conjunction with FIG. 24A.

It can be ideal to do as much work as possible at L3 to take advantage of the higher parallelism offered at this level, but certain operations (e.g. ungrouped aggregations) can only occur at L1 (e.g. based on requiring input generated based on all rows of the query having been processed). In the case where data can only flow upwards, any work occurring after one of these operations would then be stuck at L1, potentially including expensive operations which would benefit significantly from parallelization.

In particular, one problem that can occur when database system 10 is implemented via strictly upwards data propagation through the query plan as that we hit over and over in working on new customer workloads is when computations get stuck at the root level (e.g. “SQL node level”). Common causes for this can include input to such computations being an ungrouped aggregate (e.g. which are required to be performed at the root level) and/or input to such computations involving an unpartitioned window function. This motivates a need for a mechanism to return partial results to the bottom of the level hierarchy—i.e. a way to “push down”/“scatter” results from L1 back down to L3. Such functionality is presented in conjunction with FIGS. 27A-27G.

As a particular example, consider a query requiring first identifying a set of distinct values, and then do an unpartitioned window function on them. In some embodiments, this is performed three times and then used as input to core logic, such as a join operation and filter operation. For example, if the query is written and/or executed with such window functions as common table expressions (CTEs), it can then force the entire join logic of the query to run on the root SQL node in the case where purely upwards data propagation is enabled. However, if Create Table as Select (CTAS) is applied to save the results of these CTEs, then the output of those steps can be implemented back on L3, which can render a query runtime on the order of seconds rather than minutes, and/or can decrease query runtime by an order of magnitude.

Rather than resorting to forcing a CTAS clause be written by the user/implemented in generating a corresponding query flow, such functionality of pushing operator output back to L3 can be employed to yield similar improvements to query efficiency.

Database system 10 can be configured to enable such functionality. For example, when evaluating a given query and generating/executing a corresponding query operator execution flow (e.g. at the end of heuristic optimization), database system 10 can determine which expensive operations are stuck on the SQL node. If the database system 10 detects a case where there is an operations that must be executed on the SQL node, with expensive thus operations performed on the SQL node afterwards that otherwise wouldn't be required to execute on the SQL node, then such operations are ideally pushed back down to L3 to render greater parallelization and thus improved query efficiency. FIGS. 27A-27F present embodiments enabling such functionality.

In particular, such functionality can be implemented via a scatter operation (e.g. a “shuffle data back to leaf level” operator, which can be implemented via scatter operator 2730 discussed in further detail in conjunction with FIG. 27C). This can emulate the effect of taking the result set at that point and making it look like a CTAS table (e.g. because the data is on the leaf level) without ever needing to materialize new tables, while rendering the improved query efficiency discussed in the example cases above. In some cases this could be a random (e.g. round robin) shuffle. In other cases, it could be a keyed shuffle (e.g. where, if first step after sending the data back to L3 would be a keyed shuffle, the keyed shuffle is optionally performed as part of sending the data down).

In some embodiments, this functionality can be implemented based on making a copy of the query operator execution flow (e.g. it can be ideal to keep the original, as it may turn out to be more expensive to send the data back to L3). In the copy, a scatter operator can be inserted into the plan, and an appropriate number of gathers can be inserted above it (e.g. two gathers, for example, in the case of a three level plan where L1 results are sent down to L3). The optimizer can be configured to treat the scatter operator as a leaf node, and a whole separate optimization can be run for the plan that's above the scatter operator. In some cases, there can be many places that only know they've hit a leaf when it has no children, so in some embodiments the query execution module 2504 can be configured to enable, capturing the data on the scatter operator such that it can recreate its metadata at will, and then sever the connection to its child and only re-attach it after optimization returns.

In some embodiments, this process of root node results being scattered back down to the leaf level nodes for processing could happen multiple times during a given query—the new query being optimizing could also have its own operator output “stuck” at the SQL node that could also be more efficiently processed in parallel at a lower level, and the flow can thus be “split” again for separate optimization in this fashion. In some embodiments, the database system 10 is configured to evaluate which splits cause lower costs and then unwind and piece it all back together as appropriate.

In some embodiments, implementing type of approach via database system 10 can greatly reduce the complexity of enabling such functionality, for example, based on adapting functionality discussed previously (e.g. and corresponding code) to render such performance. In some embodiments, implementing this type of approach via database system 10 involves corresponding adapting of networking between nodes (e.g. identification of shuffle target nodes, virtual machine (VM) protocol messaging, etc.) to handle this passage of data. Embodiments for signaling between nodes is discussed in further detail herein.

FIG. 27A presents an embodiment of a query execution module 2504 that executes a given query operator execution flow 2817 in conjunction with executing a given query based on implementing such performance of a scatter operation at a node at an upper level of the query execution plan 2405 to render scatter output being dispersed for processing by nodes at a lower level of the query execution plan 2405. Some or all features and/or functionality of operator execution flow 2817 of FIG. 27A can implement any embodiment of a query operator execution flow described herein. Some or all features and/or functionality of execution of a query via the hierarchical query plan that includes multiple levels 2410 of FIG. 27A can implement any embodiment of a query execution plan 2405 executing a query described herein.

For the purposes of example, consider a three level hierarchical query plan that includes levels 2410.1, 2410.2, and 2410.3 (e.g. bottommost level 2410.3 is implemented as leaf level/IO level 2416; where level 2410.2 is implemented as an intermediate level 2414; and/or topmost level 2410.1 is implemented as root level 2412). Root node 37.g at level 2410.1 has a set of children nodes at level 2410.2 that includes at least nodes 37.e and 37.f Node 37.e has a set of child nodes at level 2410.3 that includes at least nodes 37.a and 37.b. Node 37.f has a set of child nodes at level 2410.3 that includes at least nodes 37.c and 37.d.

The query operator execution flow 2817 can be dispersed into a plurality of subplans for execution via nodes at respective levels of query execution plan 2405. For example, a given subplan 2727 can be implemented as a query operator execution flow 2433 executed via a given node (e.g. via query processing module 2435, for example, via implementing one or more operator execution modules 3215).

As illustrated in FIG. 27A, execution of the query operator execution flow 2817 includes first facilitating execution of a first portion of the operator execution flow 2817 (e.g. during a first temporal period) via “normal” upwards propagation of data through the query execution plan 2405. For example, this first portion of the query operator execution flow 2817 includes subplans 2727.1, 2727.3, and 2727.3, which are executed via nodes at levels 2410.3, 2410.2, and 2410.1, respectively. For example, in executing this first portion of the operator execution flow 2817, first, each of the leaf level nodes 37 at level 2410.3 generate their respective output 2713.1 based on executing operators of subplan 2727.1 upon rows read via row reads (e.g. in conjunction with executing a corresponding IO pipeline); next, each of the intermediate level nodes 37 generate their respective output 2713.2 based on executing operators of subplan 2727.2 upon rows included in outputs 2413.1 received from respective child nodes at level 2410.3; and/or finally, the root level node 37 at root level 2713.1 generates its respective output 2713.3 based on executing operators of subplan 2727.3 upon rows included in outputs 2413.2 received from respective child nodes at level 2410.2.

Performing subplan 2727.3 can include generating scatter output 2715 that includes a plurality of M outputs 2713.3.g.1-2713.3.g.M. For example, output of at least one operator of subplan 2727.3 is then segregated into M outputs via execution of a corresponding scatter operation, rendering dispersal of the output 2727.3 across nodes at level 2410.3 (e.g. each leaf level node receives a corresponding subset of rows of output 2727.3, where each row is sent to exactly one node, where outputs 2713.3.g.1-2713.3.g.M are mutually exclusive and collectively exhaustive with respect to this output 2727.3, and/or where the respective outputs 2727.3.g.a, 2727.3.g.b, 2727.3.g.c, and 2727.g.d are mutually exclusive. An embodiment of propagating this scatter output down from the root node at level 2410.1 to leaf level nodes at level 2410.3 is illustrated in FIG. 27B.

As illustrated in FIG. 27A, after this scatter output is generated and dispersed back down to nodes at the leaf level 2410.3, execution of the query operator execution flow 2817 includes next facilitating execution of a second portion of the operator execution flow 2817 (e.g. during a second temporal period strictly after the first temporal period), again, via “normal” upwards propagation of data through the query execution plan 2405. For example, this second portion of the query operator execution flow 2817 includes subplans 2727.4, 2727.5, and 2727.6, which are executed via nodes at levels 2410.3, 2410.2, and 2410.1, respectively. For example, in executing this second portion of the operator execution flow 2817, each of the leaf level nodes 37 at level 2410.3 generate their respective output 2713.4 based on executing operators of subplan 2727.4 upon rows included in the outputs 2713.3 of the scatter output 2715 propagated down from the root level 2410.1; next, each of the intermediate level nodes 37 generate their respective output 2713.5 based on executing operators of subplan 2727.5 upon rows included in outputs 2413.4 received from respective child nodes at level 2410.3; and/or where finally, the root level node 37 at root level 2713.1 generates its respective output 2713.6 based on executing operators of subplan 2727.6 upon rows included in outputs 2413.5 received from respective child nodes at level 2410.2.

The query resultant can correspond to/be based on output 2727.6. In some embodiments, the output 2727.6 is optionally again scattered into multiple corresponding scatter outputs 2713.6.g.1-2713.6.g.M for propagation back down to leaf level, where additional subplans of the flow 2817 are executed to render upward propagation in this fashion, where such scattering can be performed any number of times.

FIG. 27B illustrates an embodiment of propagating scatter output 2715 from level 2410.1 down to level 2410.3 via generation of multiple corresponding scatter output at multiple levels. Some or all features and/or functionality of executing query operator execution flow 2817 of FIG. 27B can implement executing query operator execution flow 2817 of FIG. 27A and/or any execution of query operator execution flow described herein.

In particular, the scattering of scatter data 2715 generated by root node 37.g at level 2410.1 down to the leaf level nodes at level 2410.3 can be facilitated via participation of nodes at intermediate level 2410.2. For example, in a similar fashion as data propagating upwards from the leaf level one level at a time to ultimately arrive at the root level as illustrated in FIG. 27A and discussed previously herein, the scatter output can similarly propagate downwards from the root level one level at a time to ultimately arrive at the leaf level.

As illustrated in FIG. 27B, execution of the query operator execution flow 2817 of FIG. 27A can include, after performing flow subplan 2727.2 of FIG. 27B, performing flow subplans 2727.3.1 and 2727.3.2 root level 2410.1 and intermediate level 2410.2, respectfully, via “downwards” propagation of data through the query execution plan 2405.

For example, root level node 37.g at level 2727.1 first generates a plurality of outputs 2713 of scatter output 2715 for dispersal to respective child nodes at intermediate level 2410.2 based on executing operators of subplan 2727.3.1 upon rows included in the outputs 2713.2 received from the child nodes at level 2713.2. Subplan 2727.3.1 can optionally be implemented as some or all of subplan 2727.3 of FIG. 27A, where output 2727.3 is generated via execution of other operators, and this output is segregated multiple discrete subsets corresponding to its multiple child nodes at level 2410.2. Next, each of the intermediate level nodes 37 generate their respective output 2713.3 as its own scatter output 2415 for dispersal to respective child nodes at leaf level 2410.1 based on executing operators of subplan 2727.3.1 upon rows included in outputs 2413.3 received from their respective parent node at level. For example, node 37.e receives output 2713.3.g.e from root node 37.g and executes flow subplan 2727.2 to segregate output 2713.3.g.e into multiple discrete subsets corresponding to its multiple child nodes at level 2410.3, and node 37.f similarly receives output 2713.3.g.f from root node 37.g and executes flow subplan 2727.2 to segregate output 2713.3.g.f into multiple discrete subsets corresponding to its multiple child nodes at level 2410.3. The leaf level nodes, upon receiving their respective output 2713.3 from their parent node at intermediate level 2410.2, can process this output 2713.3 in conjunction with executing flow subplan 2727.4 as illustrated in FIG. 27A.

FIG. 27C illustrates an embodiment of execution of a scatter operator 2730 via a parent node 37 at a given level 2410.z of query execution plan 2405 to generate corresponding scatter output 2715 that includes a plurality of outputs 2713.1-2713.M dispersed across M child nodes at an immediately lower level 2410.z+1. Some or all features and/or functionality of scatter operator 2730 can implement execution of subplan 2713.3, subplan 2713.3.1, and/or subplan 2713.3.2. For example, scatter operator 2730 is implemented as a particular type of operator 2520. Some or all features and/or functionality of scatter output 2715 can implement any embodiment of scatter output described herein.

A scatter input row set 2761 (e.g. corresponding to the input to the subplan received from another node as another node's output, and/or generated via execution of prior operators in a corresponding subplan executed by the node 37) can include a plurality of rows 3037 (which can be implemented as rows/records 2422 and/or as any rows/records processed in conjunction with performing operators 2520 of a query operator execution flow described herein) to be dispersed across a set of child nodes 37.1-37.M for processing. Execution of scatter operator 2730 can thus render generation of a plurality of row subsets 2762.1-2762.M included in a corresponding plurality of outputs 2713.1-2713.M sent to a corresponding plurality of child nodes 37.1-37.M. The plurality of row subsets 2762 can be mutually exclusive and collectively exhaustive with respect to the scatter input row set 2761, where each row 3037 in scatter input row set 2761 is guaranteed to be included in exactly one row subset 2762 of exactly one output 2713, where every row in scatter input row set 2761 is thus sent downward to exactly one child node 37.

In some embodiments, dispersal of the plurality of rows 3037 of scatter input row set 2761 across the M subsets 2762.1-2762.M can be random (e.g. in accordance with a round robin approach). In other embodiments, dispersal of the plurality of rows 3037 of scatter input row set 2761 across the M subsets 2762.1-2762.M can be non-random, for example, based on a hash key or cluster key of the rows (e.g. rows with same/similar values for one or more given columns are grouped together in the same subset). The M subsets can be configured to have equal/relatively equal numbers of rows. The M subsets can optionally be configured to have different numbers of rows (e.g. in the case where the keyed distribution is applied and the keys are non-uniformly distributed, and/or in embodiments where dispersal is based on current/expected memory/processing capacity/efficiency of the different nodes, where nodes expected/known to be able to handle more rows and/or process them more quickly receive more rows than other nodes expected/known to be able to handle less rows and/or process them less quickly).

In the case where scatter output is propagated downwards across multiple levels, for example, as illustrated in FIG. 27B, this scatter operator 2730 can be included in multiple subplans for performance at multiple consecutive levels (e.g. in subplans 2727.3.1 and 2727.3.2 performed at levels 2410.1 and 2410.2, respectively). For example, the scatter input row set 2761 of the parent node 37 at level 2410.z can thus be received as output 2713 from a node at a higher level 2410.z−1 that executed scatter operator 2730 upon its own scatter input row set. Alternatively or in addition, a given output 2713 generated by parent node 37 at level 2410.z can thus be processed as a scatter input row set 2761 to scatter operator for execution by a corresponding child node 27 at level 2410.z+1.

Note that based on the properties of execution of scatter operator 2730 at each consecutive level, a set of outputs 2713 received across a lower level (e.g. level 2410.z+k, where k is positive and optionally greater than 1) based on propagation of data via such execution of scatter operators across multiple consecutive levels starting from an upper level (e.g. level 2410.z) that processed a corresponding scatter input row set 2761 can be guaranteed to be mutually exclusive and collectively exhaustive with respect to the scatter input row set 2761, where each row 3037 in scatter input row set 2761 processed at level 2410.z is guaranteed to be included inexactly one row subset 2762 of exactly one output 2713 at level 2410.z+k, where every row in scatter input row set 2761 is thus propagated downward to exactly one node 37 at level 2410.z+1.

In some embodiments, shuffle and/or broadcast is performed in conjunction with executing scatter operator 2730 at one or more levels. In some embodiments, if the leaf level needs the data shuffled or broadcasted, it may or may not be more efficient to do this as part of the scatter operation. In embodiments where it is more efficient to perform the broadcast and/or shuffle during the scatter operation, hash multiplexers can optionally be implemented via scatter operator 2730, for example, with some adjustments for null handling.

FIGS. 27D-27F illustrate embodiments of an operator flow generator module 2514 that implements a flow optimizer module 4914 generates an updated query operator execution flow 2718.1 from an initial query operator execution flow 2718.0 based on determining to insert at least one scatter operator 2730 into the query operator execution flow based on determining a scatter condition indicated in scatter condition data 2725 has been met. Some or all features and/or functionality of the updated query operator execution flow 2718.1 can implement the query operator execution flow 2718 of FIGS. 27A and/or 27B. Some or all features and/or functionality of operator flow generator module 2514 and/or flow optimizer module 4914 can implement any embodiment of operator flow generator module and/or flow optimizer module/optimizer described herein.

As illustrated in FIG. 27D, a flow optimizer module 4914 can generate a flow 2817.1, for example, in conjunction with implementing an optimizer/performing a query optimization process. This can include detecting whether a scatter condition is met (e.g. based on flow 2817.0). For example, this can be based on detecting whether a given operator 2520.x to be executed at the root node/another upper level node of the query execution plan is expensive/would be more efficient if the corresponding input to this operator were scattered to the leaf level/another lower level for parallelized execution of this operator upon corresponding portions of the input at the lower level. This can optionally be based on the type of the operator, whether it can be parallelized, etc.

The flow 2817.1 can be generated based on inserting one or more scatter operators into the plan. In particular, a selected one or more operators 2420.x to be executed in parallel at a lower level (e.g. based on meeting scatter condition) can have one or more scatter operators inserted below it accordingly, where execution of these scatter operators will render pushing down of respective output generated at an upper level to a lower level for execution of the operator by nodes at the lower level for increased levels of parallelization.

The flow 2817.1 can be further generated based on inserting one or more gather operators into the plan. In particular, the selected one or more operators 2420.x to be executed in parallel at a lower level (e.g. based on meeting scatter condition) can have one or more gather operators inserted above it accordingly, where execution of these gather operators will render gathering up of respective output of the operator 2520.x (e.g. back up to the upper level at which it was originally destined to be executed in flow 2817.0/back up to the upper level which input to operator 2520 prior to scattering was generated).

In some embodiments, a number of scatter operators inserted can be equal to the number of gather operators, where the gather operators effectively counter the scatter operator. In particular, scatter operators can be implemented to segregate and disperse input (e.g. row set 2761) intended for operator 2520.x (e.g. output of a prior operator 2520.x−1) from a given upper level (e.g. level 2420.1 or another level 2410.z) down to a given lower level (e.g. level 2420.3 or another level 2410.z+k) via one or more respective executions of scatter operator (e.g. k executions of scatter operator at levels 2410.1-2410.z+k−1) After operator 2520.x is executed in parallel across respective outputs 2713 (e.g. respective subsets 2762), the outputs of operator 2520.x can be gathered from the given lower level backup to the given upper level via one or more respective executions of gather operator (e.g. k executions of scatter operator at levels 2410.z+k-2410.z+1, or optionally at levels 2410.z+k−1-2410.z).

FIG. 27E illustrates an embodiment of dispersal of operators of flow 2817.1 of FIG. 27D across different flow subplans 2727.1 for execution at different levels. The flow 2817.1 and/or corresponding flow subplans can implement the flow 2817 of FIGS. 27A and/or 27B and/or any embodiment of query operator execution flow 2817 described herein.

In particular, one or more operators 2520.y of flow 2817.0 are included in flow subplan 2727.1, for example, executed at level 2410.3; one or more operators 2520.x−1 of flow 2817.0 and scatter operator 2730 inserted into the plan via flow optimizer module 4914 are included in flow subplan 2727.3.1, for example, executed at level 2410.1 to render generating of output of operators 2520.x−1 and dispersal of this output into scatter output sent to nodes of level 2410.2; another scatter operator 2730 inserted into the plan via flow optimizer module 4914 is included in flow subplan 2732.2, for example, executed at level 2410.2 to render processing of the scatter output generated by level 2410.1 to render further scattering of the output of operators 2520.x−1 for dispersal to nodes of level 2410.3; operator 2520.x of flow 2817.0 is included in flow subplan 2727.4, for example, executed at level 2410.3 upon scatter output generated by level 2410.2; gather operator inserted into the plan via flow optimizer module 4914 is included in flow subplan 2727.5, for example, executed at level 2410.2 to render gathering of output generated by level 2410.3 at level 2727.2 (and/or optionally executed at level 2410.3 to render sending of output generated by level 2410.3 to level 2727.2); gather operator inserted into the plan via flow optimizer module 4914 and one or more operators 2520.x+1 of flow 2817.0 are included in flow subplan 2727.6, for example, executed at level 2410.1 to render further gathering of output generated by execution of operator(s) 2520.x at level 2410.1, and to render execution of operators 2520.x+1 upon this gathered output of operator 2520.x (and/or the gather operator is optionally executed at level 2410.2 to render sending of output received from level 2410.3 to level 2727.1 for processing by level 2727.1 in performing operators 2520.x+1).

FIG. 27F illustrates an embodiment of flow optimizer module 4914 that inserts one or more gather and/or scatter operators based on first applying a pushdown operator selection module 2746 to select the one or more operators 2520.x to be performed in parallel at a lower level (if applicable), and next applying a scatter operator insertion module 2747 to insert the one or more scatter operators before the selected operator(s) 2520.x (if identified) and/or to further insert one or more gather operators above this selected operator(s) 2520.x.

In some embodiments, the pushdown operator selection module 2746 can be implemented based on performing a recursive candidate operator identification process 2749 (e.g. to recursively identify a current selection and update this selection if a better operator is identified via a breadth-first search of the operator execution flow, for example, to identify a bottom-rightmost operator meeting scatter condition data 2725. In other embodiments, the pushdown operator selection module 2746 can otherwise identify whether any operators should be performed in parallel at a lower level, and/or identify a most favorable operator to be performed in parallel.

In some embodiments, the pushdown operator selection module 2746 is reapplied to a latter portion of the plan starting from operators 2520.x−1 after operator 2520.x is identified to determine whether any subsequent operators also be pushed down to the leaf level for parallelized execution, where scatter operators and gather operators are similarly inserted to surround such operators after operator 2520.x+1 accordingly.

As discussed previously, for query performance to benefit from pushdown, the optimizer (e.g. flow generator module 4914) can be implemented to identify cases where the parallelization gained by pushing down partial results is worth the cost of sending those results over the network. To do this, the optimizer can optionally search for the lowest possible operator being executed at L1 (e.g. operators starting from operator 2520.x−1 in flow 2817.0) which is expensive (e.g. based on pre-existing category based mainly on the type of operator) and can be executed in parallel (e.g. certain operations, such as ungrouped aggregation and unpartitioned window, are expensive but must occur at L1). For example, in some embodiments, operator 2520.x−1 is optionally not pushed down based on being one or more operators implementing an ungrouped aggregation and/or an unpartitioned window. In some embodiments, the lowest possible operator meeting such criteria is optionally identified via performing recursive candidate operator identification process 2749.

In some embodiments, once such an operator (e.g. operator 2520.x in flow 2817.0) is identified, the flow optimizer module 4914 can insert scatters below this operator and gathers above it to render placement of the operator at a lower level (e.g. the lowest possible level). In some embodiments, other optimization rules can then push the new gathers up as high as possible, so that after the data has been pushed down as much computation as is allowed will occur in parallel at L3 (e.g. multiple operators 2520.x are ultimately below gather operators 2731, where a lowest of these operators 2520.x was identified first, and the gather operators 2731 were pushed above subsequent ones of these operators).

In some embodiments, implementing flow optimizer module 4914 includes implementing a corresponding an optimization heuristic (e.g. implemented in conjunction with determining whether scatter condition indicated in scatter condition data 2725 is met, and/or implemented in conjunction with selecting operator(s) 2520.x to be pushed down for parallelization at a lower level. Such an optimization heuristic can be implemented, for example, via the compiler applied after all our other rules for determining levels of operators. In some embodiments, implementing the heuristic optimization can be based on implementing some or all of the following logic:
1. If there's an operation at level 1 (or hypothetically level N<#levels) that could happen at a lower level, place (#levels-N) scatters under it and gathers above it so that the operator is at the leaf level
2. Then push the gathers up until it is no longer legal, according to existing rules
3. Then evaluate whether the entire chunk of operators between the scatters and the gathers is worth pushing down; if not, push the gathers back down until they encounter the scatters and cancel out
4. Then push projects and potentially some selects back down again

This logic can be applied starting with the lowest parallelizable non-leaf operator, and it can be then repeated on whatever remains above the newly introduced gathers or already-checked operators. This can optionally be implemented as recursion by treating scatters as leaf operators, where recursive candidate operator identification process 2749 is optionally implemented via implementing some or all of the logic above.

In some embodiments, implementing the heuristic optimization can be based on existing transforms from pushing anything down past a scatter, with certain exceptions (e.g. project operators and/or select operators). In some embodiments, transforms of the flow 2817 implemented via flow optimizer module 2914 often push down operators in order to increase parallelism, but pushing down past a scatter can mean less parallelism. To handle such cases, transforms of the flow 2817 implemented via flow optimizer module 2914 can optionally be configured to push operators past the entire block of operators between the scatters and gathers, but not stop anywhere in between.

In some embodiments, flow optimizer module 4914 generates flow 2817.1 from flow 2817.0 based on implementing a heuristic optimization. In some embodiments, implementing the heuristic optimization can be performed via implementing some or all of the following logic:
1. Apply gather push up
2. Try to apply level push down via scatter
3. If level push down was applied goto step 1 and repeat
4. Otherwise continue with the rest of heuristic optimization

In some embodiments, implementing the heuristic optimization can alternatively or additionally be based on implementing some or all of the following logic:
1. If the plan is a virtual plan, exit and return false. (To avoid applying the scatter operator to pushdown operations to L3 to dummy plans and/or queries on virtual tables)
2. Search for an appropriate candidate operator (e.g. via performing recursive candidate operator identification process 2749)
3. If a candidate operator was not found, return false.
4. Otherwise, a candidate was found. Insert NUM_LEVELS−1 (e.g. 2) scatters and gathers below the candidate operator 2520.x, e.g.:
   . . . ←operator 2520←L1 gather←L2 gather←L2 scatter←L1 scatter← . . .
5. Push both gathers over the candidate, e.g.:
   . . . ←L1 gather←L2 gather←operator 2520←L2 scatter←L1 scatter← . . .
   If gather push up fails here, an invalid candidate operator was picked and an exception is thrown (in some embodiments this is not strictly necessary because a GPU will optionally be applied again later, but this can avoid an infinite loop: this can prevent the situation where a bad candidate operator 2520 is picked, pushing the gathers up fails but it appears that the push down was applied properly, where the candidate would again be found again next iteration and keep inserting scatters and gathers in an infinite loop)

In some embodiments, finding the candidate operator (e.g. at step 2 of the logic above) can be performed via a breadth first search that finds the deepest, rightmost candidate for such pushdown for execution at a lower level in parallel. In some embodiments, this step of implementing the heuristic optimization and/or implementing the recursive candidate operator identification process 2749 can be performed via implementing some or all of the following logic:
1. Initialize a queue with the root operator and an empty visited set
2. While the queue is not empty:
   2.1. Pop operator from the queue
   2.2. If the operator is a gather, leaf op or has already been visited: stop and go to the next loop iteration
   2.3. If the operator is a good candidate, save it as the current best candidate
   2.4. Push the operator's children onto the queue
3. Return the last candidate found, or null pointer (e.g. nullptr) if none was found

In some embodiments, determining whether the operator is a good candidate (e.g. at step 2.3 of the logic above) can be based on implementing some or all of the following logic, for example, in conjunction with performing the heuristic optimization.

Consider the following three example queries have joins that depend on ungrouped aggregations. The joins can thus be required to be executed on level 1 if the level push down functionality described in conjunction with FIGS. 27A-27F is disabled, but can be pushed down with level push down.
create table test10 as select * from sys.dummy10;
select * from test10 b join (select count(*) as “count” from test10) c on b.c1>c.“count”;
select * from test10 a join (select * from test10 b join (select count(*) as “count” from test10) c on b.c1>c.“count”) ON a.c1>c.“count”;

For example, the first query corresponds to a CTAS statement to create a dummy table on L3; the second query corresponds to pushdown being applied once to this first query; the second query corresponds to being applied twice to this first query.

In some embodiments, the plan for the second query can be implemented via implementing some or all of the following example logic:

```
ROOT_OP @ (0x7f2ea5ab5840) ID: 104, md: 2, Out (2): c1 count |
  REORDER_OP @ (0x7f2ea5ab5140) ID: 102, md: 0, Out (2): c1
  count |
  no-op reorder
  RENAME_OP @ (0x7f2ea5ab54c0) ID: 103, md: 2, Out (2): c1
  count |
  Old2New: (count(c1) −> count) (test10.c1 −> c1)
    GATHER_OP @ (0x7f2ea5634e40) ID: 120, md: 2, Out (2):
    test10.c1
    count(c1) |
    SPACE_AWARE_OP @ (0x7f2ec0833b40) ID: 149, md: 2,
    Out (2):
    test10.c1 count(c1) |
      GATHER_OP @ (0x7f2ea5aaff40) ID: 122, md: 2, Out (2):
      test10.c1
      count(c1) |
      SPACE_AWARE_OP @ (0x7f2ec0833840) ID: 148, md: 2,
      Out (2):
      test10.c1 count(c1) |
        PRODUCT_OP @ (0x7f2ea5a47440) ID: 99, md: 0,
        Out (2):
        test10.c1 count(c1) | Type: 0 (INNER), Predicate:
        ((test10.c1 G
        count(c1)))
    PROJECT_OP @ (0x7f2ec083aa40) ID: 135, md: 2, Out (1):
        test10.c1 | Removing: test10._dummy_cluster
      TEE_OP @(0x7f2ec083adc0) ID: 136, md: 2, Out (2): test10.c1
          test10._dummy_cluster | parent IDs: 139 135
          RANDOM_SHUFFLE_OP @ (0x7f2ec083d0c0) ID: 143,
          md: 2, Out (2): test10.c1 test10._dummy_cluster |
            INDEX_OP @ (0x7f2ea5ad2740) ID: 91, md: 1, Out (2):
            test10.c1 test10._dummy_cluster |
    BROADCAST_OP @ (0x7f2ec085b540) ID: 130, md: 2, Out (1):
        count(c1) |
          SCATTER_OP @ (0x7f2ea5634840) ID: 117, md: 2, Out (1):
          count(c1) | Level:
          SCATTER_OP @ (0x7f2ea5633340) ID: 116, md: 2, Out
          (1):
          count(c1) | Level:
            SUPER_SELECT_OP @ (0x7f2ea563aac0) ID: 128, md:
            2, Out (1): count(c1) | Predicate: ((count(c1) NE NULL))
            AGG_OP @ (0x7f2ec0842740) ID: 140, md: 0, Out (1):
            count(c1) | Agg ops: TYPE_SUM,
              AGG_OP @ (0x7f2ea5a46a40) ID: 94, md: 0, Out (1):
              count(c1) | Agg ops: TYPE_SUM,
              GATHER_OP @ (0x7f2ea5633040) ID: 93, md: 2,
              Out (1): count(c1) |
                SPACE_AWARE_OP @ (0x7f2ec0833540) ID:
                147, md: 2, Out (1): count(c1) |
            AGG_OP @(0x7f2ec0842c40) ID: 141, md: 0,
                Out (1): count(c1) | Agg ops: TYPE_SUM,
              AGG_OP @ (0x7f2ea5627040) ID: 110, md:
                  0, Out (1): count(c1) | Agg ops: TYPE_SUM,
              GATHER_OP @ (0x7f2ec0900640) ID: 92,
                  md: 2, Out (1): count(c1) |
                    SPACE_AWARE_OP @
                    (0x7f2ec0833240) ID: 146, md: 2, Out
                    (1): count(c1) |
                    AGG_OP @ (0x7f2ec0843140) ID:
                    142, md: 0, Out (1): count(c1) | Agg
                    ops: TYPE_SUM,
                      AGG_OP @ (0x7f2ea5627540) ID:
                      111, md: 0, Out (1): count(c1) | Agg
                      ops: TYPE_COUNT_STAR,
                      PROJECT_OP @
                      (0x7f2ec083cd40) ID: 139, md: 2,
                      Out (1): test10._dummy_cluster
                      Removing: test10.c1
                        TEE_OP @ (0x7f2ec083adc0)
                        ID: 136, -- reference --
```

FIG. 27G illustrates an embodiment of query execution module that communicates subplans to nodes via messages generated via a per-level message generator module 2740 via root node 37 (e.g. node 37.g of FIG. 27A). In particular, multiple subplans (e.g. that are not consecutive in the flow 2817 but nonetheless belong to the same level due to implementing both upwards and downwards propagation of data as discussed in conjunction with FIGS. 27A-27F) can be communicated together in a same message, where each node receives/processes one message containing all subplans 2727 for execution at its respective level (and optionally processes multiple such messages if participating at multiple levels). This can enable nodes at different levels to compile plans in parallel, improving the efficiency of communicating a query operator execution flow for execution via a hierarchical query execution plan 2405. Some or all features and/or functionality of nodes 37 and/or levels 2410 of query execution plan 2405 can implement nodes 37 and/or levels 2410 of query execution plan 2405 of FIGS. 27A and/or 27B (e.g. to render communication of respective subplans to the nodes for execution) and/or can implement any embodiment of query execution plan 2405 and/or query execution module 2504 described herein.

In some embodiments, for example, where scatter operations are not implemented to enable pushing operator execution down to a lower level, each subplan of a query can be executed as its own independent action, and can be responsible for initiating compilation and execution of the subplans directly beneath it in the tree by forwarding those subplans downstream. For example, each subplan is implemented in such cases to only identify those beneath it by finishing its own compilation process.

In implementing the functionality of FIGS. 27A-27F where scatter operations are implemented to enable pushing operator execution down to a lower level, this approach would necessitate several passes up and down through the levels, waiting for compilation to complete at each level, just to initiate all the necessary actions (e.g. due to the nature of multiple, non-consecutive subplans 2727 being executed at some or all levels as a result of this functionality being employed). This can slow down compilation and signaling—even in the simplest possible pushdown plan such as that of the examples of FIGS. 27A and/or 27B, 7 subplans would need to compile sequentially at levels 1, 2, 3, 2, 1, 2, 3, if processed independently, and/or certain control signals might need to traverse all 7 levels to take effect. Furthermore, implementing scatter operations to enable pushing operator execution down to a lower level can also motivate the need to deduplicate subplans which are being sent to a less parallel level from a more parallel one—e.g. an L2 node would receive the same subplan from every L3 node.

The process of compilation and execution can be improved in implementing the case where scatter operations are implemented to enable pushing operator execution down to a lower level. This can include configuring execution such that, at each level of the query execution plan, each node runs a single action executing all the applicable subplans in one place, which are passed in on initialization. This can reduces the amount of messaging needed for a signal to reach all actions in a query and cuts down on redundant state needed to track the execution of a query. Such functionality is presented in FIG. 27G.

In particular, at level 2410.1 a single pass can be performed to identify all subplans in the query, where the identified subplans are then grouped by execution level, and are then forwarded downstream as a single message per level per node, enabling VM compilation to occurs at multiple levels in parallel rather than sequentially.

As illustrated in FIG. 27G, operator flow generator module 2514 can generate flow 2817 for execution (e.g. flow 2817.1 based on optimizing an initial flow 2817.0 via some or all features and/or functionality of FIGS. 27D-27F). In some embodiments, some or all of operator flow generator module 2514 is implemented via root node at the root level 2412 (e.g. node 37.g) for example, based on being implemented as the SQL node.

The root node can implement a per-level message generator module 2740 to generate a plurality of messages corresponding to the plurality of levels, corresponding to groupings of subplans for each level (and/or their relation to other subplans/their ordering in the plan/other execution instructions). This can include grouping the subplans into subplan groupings 2745 by level. In this example, subplan grouping 2745.2 includes subplans 2727.2, 2727.3.2, and 2727.5, corresponding to the set of subplans to be executed via nodes at level 2410.2, and subplan grouping 2745.3 includes subplans 2727.1 and 2727.4 to be executed via nodes at level 2410.3. A message 2741.2 designated for nodes at level 2410.2 can indicate subplan grouping 2745.2 and/or a message 2741.3 designated for nodes at level 2410.3 can indicate subplan grouping 2745.3.

A message communication module 2743 of the root node can communicate these messages to respective nodes at respective levels. This can include message communication module 2743 of the root node sending messages 2741.2 and 2741.3 to each of its child nodes at level 2410.2. Each of these intermediate level nodes can then process (e.g. compile and ultimately execute) the subplans indicated in their own messages 2410, and communicate message 2741.3 to each of its child nodes at level 2410.3 for processing (e.g. complication and ultimately execution). The messages 2741 can be generated/received/processed as/in conjunction with implementing Execute Plan Actions (EPA), where a single EPA is optionally processed by each node despite multiple non-consecutive subplans being compiled/ultimately executed by the node, based on a single message 2741 being processed per node with all subplans for execution at the respective level.

Each node 37 can compile and ultimately execute its subplans 2727 of its subplan grouping 2745 for its respective level (or levels, if participating in multiple levels) via implementing a subplan compilation module 2750 to generate compiled subplan data 2746, and/or executing the subplan via processing the compiled subplan data 2746 via a subplan execution module 2751. The subplan compilation module 2750 and/or subplan execution module 2751 of a given node can be implemented via the query processing module 2435 of the given node.

This compilation and execution can be performed by lower level nodes based on receiving corresponding subplan data for respective subplan in a corresponding message 2741 generated by root node and/or sent from a parent node/routed via at least one other node. Meanwhile, this compilation and execution can be performed by root node once its own subplans have been generated/identified in its own subplan grouping 2745.1 (e.g. no corresponding message is generated for/received by the root level node, as the root node generated/identified the subplans itself).

By implementing this means of sending out messages containing all subplan data at once, nodes across different levels can be compiling their own subplans in parallel (e.g. a leaf level node at level 2410.3 receives and begins compiling subplans 2727 received in a message 2741.3 received from its parent node at level 2410.2, and this compilation begins while one or more nodes at level 2410.2 is still compiling some or all of its own subplans 2727). This can increase the efficiency of preparing all nodes for their respective execution of the query operator execution flow 2817 via query execution plan 2405, enabling execution to begin sooner and/or reducing the amount of further compilation required during execution if subsequent subplans hadn't yet been communicated/compiled.

In some embodiments, compilation (e.g. VM compilation) is configured such that there is only one Execute Plan Action (EPA) per node per level per query, as opposed to separate EPAs for each branch. This can mainly entail passing each EPA a vector of subplans from the plan compiler; and/or implanting a layer of routing within EPA to identify the target branch for signals (e.g. to render passing of corresponding messages multiple levels down the plan to its intended target), for example, as a field and/or metadata in the respective message 2741.

In some embodiments, Execute Plan Actions and/or corresponding messages 2741 are implemented via forwarding gather signals to nodes at lower levels (e.g. forward data block from a bottom gather to a specified child node/downstream peer rather than the unique parent node/upstream peer) to render the corresponding output being sent up to this respective node in conjunction with execution of the gather via the respective node.

In some embodiments, to support scatter operators, the VM protocol can implement logic to forward gather blocks and signals in both directions (both upwards and downwards). For example, blocks could only flow to higher levels while most signals (e.g. pull, pause) could only flow to lower ones. This flexibility can allows reuse of logic and code between gather and scatter cases.

In some embodiments, scatter operators are compiled into top and bottom gathers.

In some embodiments, a data block router is utilized to implement scatter operations. In some embodiments scatter operations are implemented via performance of a shuffle operation.

In some embodiments, lower-level nodes executing operator 2520.x create top gathers, where the higher-level node creates a round robin multiplexer leading to one bottom gather per receiving operator instance in conjunction with implementing the scatter operation.

In some embodiments, gather operator instances implemented in conjunction with scatter operations having data sent back upwards can be configured to handle bloom filters.

While the examples of FIG. 27A-27G include these three levels and example set of nodes, such functionality can optionally be implemented via any hierarchical query plan (e.g. any query execution plan 2405) with any number of multiple levels (e.g. only two levels, or four or more levels). For example, a root node at a top level (e.g. level L1) of an N-level plan (e.g. LN) can perform the scatter as discussed herein via a scatter down to level LN, which can include respective scattering down more than two respective levels, and can thus require performance of more than two (e.g. N−1) scatter operations and/or gather operations).

While the examples of FIG. 27A-27G include the scatter operation being performed at the topmost, root node for dispersal of scatter output all the way down to the leaf nodes at the bottommost, leaf level of the hierarchical query plan, such functionality can optionally be implemented via any upper level node(s) sending data down to lower level nodes in a three level plan, or any N level plan where N>1. For example, intermediate level nodes at a given intermediate level 2410.z, where z is greater than 1, can propagate data down to nodes at any level lower than 2410.z, such as level 2410.z+k where k is positive, and where level 2410.z+k can be any intermediate level below level 2410.z where z+k<N, and/or can be the leaf level 2410.N. As another example, root level node level 2410.1 can propagate data down to nodes at any level lower than 2410.1 that is optionally above the leaf level, such as level 2410.k where k is greater than 1 and less than N. In some cases, the lower level processing the scattered output for propagation back upwards can be directly below the upper level that scattered its output (e.g. where exactly one scatter operator 2730 is inserted in the plan), were upper level 2410.z (which may the root level or an intermediate level) propagates data down only one level to lower level 2410.z−1 (which may be an intermediate level or the leaf level). In other cases, the lower level processing the scattered output for propagation back upwards can be directly below the upper level that scattered its output (e.g. where more than one scatter operator 2730 is inserted in the plan), were upper level 2410.z (which may the root level or an intermediate level) propagates data down multiple levels to lower level 2410.z+k (which may be an intermediate level or the leaf level), where k is strictly greater than 1.

FIG. 27H illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 27H, for example, based on participating in execution of a query being executed by the database system 10. Some or all of the method of FIG. 27H can be performed by nodes executing a query in conjunction with a query execution, for example, via one or more nodes 37 implemented as nodes of a query execution module 2504 implementing a query execution plan 2405. In some embodiments, a node 37 can implement some or all of FIG. 27H based on implementing some or all of a plurality of processing modules 2610.1-2610.W, for example, as a corresponding plurality of processing core resources 48.1-48.W. Some or all of the steps of FIG. 27H can optionally be performed by any other one or more processing modules of the database system 10. Some or all of the steps of FIG. 27H can be performed to implement some or all of the functionality of the database system 10 as described in conjunction with FIGS. 27A-27G, for example, by implementing some or all of the functionality of nodes 37 of a query execution plan 2405 implemented via query execution module 2504 in executing query operator execution flow 2817, for example, via execution of scatter operator 2730. Some or all steps of FIG. 27H can be performed by database system 10 in accordance with other embodiments of the database system 10 and/or nodes 37 discussed herein. Some or all of the steps of FIG. 27H can be performed in conjunction with performing some or all steps of any other method described herein.

Step 2782 includes determining a query operator execution flow for execution via a plurality of nodes each assigned to participate in a corresponding level of a hierarchical query plan. In various examples, the query operator execution flow includes an ordered arrangement of a plurality of operators for execution that includes: a first set of operators (e.g. one or more operators 2420.y); a second set of operators (e.g. one or more operators 2420.x−1) for execution serially after the first set of operators; a third set of operators (e.g. one or more operators 2420.x) for execution serially after the second set of operators; and/or a fourth set of operators (e.g. one or more operators 2420.x+1) for execution serially after the third set of operators. Step 2784 includes executing the query operator execution flow via the plurality of nodes in conjunction with execution of a corresponding query.

In various embodiments, performing step 2784 includes performing step 2786, 2788, 2790, 2792, 2794, and/or 2796. Step 2786 includes generating, for example, via a first subset of nodes of the plurality of nodes participating in at least one lower level of the hierarchical query plan, a plurality of first output based on the first subset of nodes executing the first set of operators in parallel. Step 2788 includes generating, for example, via at least one second node of the plurality of nodes participating in at least one upper level of the hierarchical query plan, second output based on processing the plurality of first output via executing the second set of operators in response to receiving the plurality of first output from the first subset of nodes. Step 2790 includes segregating, for example, via the at least one second node, the second output into a plurality of second output portions. Step 2792 includes dispersing, for example, via the at least one second node, the plurality of second output portions across the first subset of nodes at the at least one lower level of the hierarchical query plan for processing. Step 2794 includes generating, for example, via the first subset of nodes, a plurality of third output based on the first subset of nodes executing the third set of operators upon corresponding second output portions of the plurality of second output portions in parallel. Step 2796 includes generating, for example, via the at least one second node, fourth output based on processing the plurality of third output via executing the fourth set of operators in response to receiving the plurality of third output from the first subset of nodes, where a query resultant for the corresponding query is generated based on the fourth output.

In various examples, the first set of operators includes exactly one operator. In various examples, the first set of operators includes multiple operators. In various examples, at least two of the operators of the multiple operators of the first set of operators are executed serially. In various examples, at least two of the operators of the multiple operators of the first set of operators are executed in parallelized paths.

In various examples, the second set of operators includes exactly one operator. In various examples, the second set of operators includes multiple operators. In various examples, at least two of the operators of the multiple operators of the second set of operators are executed serially. In various examples, at least two of the operators of the multiple operators of the second set of operators are executed in parallelized paths.

In various examples, the third set of operators includes exactly one operator. In various examples, the third set of operators includes multiple operators. In various examples, at least two of the operators of the multiple operators of the third set of operators are executed serially. In various examples, at least two of the operators of the multiple operators of the third set of operators are executed in parallelized paths.

In various examples, the fourth set of operators includes exactly one operator. In various examples, the fourth set of operators includes multiple operators. In various examples, at least two of the operators of the multiple operators of the fourth set of operators are executed serially. In various examples, at least two of the operators of the multiple operators of the fourth set of operators are executed in parallelized paths.

In various examples, the first subset of nodes includes multiple nodes. In various examples, the at least one second node includes exactly one node. In various examples, the at least one second node includes multiple nodes.

In various examples, the hierarchical query plan includes more than three levels. In various examples, the hierarchical query plan includes exactly two levels. In various examples, the hierarchical query plan includes exactly three levels.

In various examples, a first subset of the first set of operators is executed via first ones of the first subset of nodes participating at a lowest level of the three levels. In various examples, a second subset of the first set of operators is executed via second ones of the first subset of nodes participating at an intermediate level of the three levels. In various examples, the second set of operators is executed via the at least one second node participating at a topmost level of the three levels. In various examples, a first subset of the third set of operators is executed via the first ones of the first subset of nodes participating at the lowest level of the three levels. In various examples, a second subset of the third set of operators is executed via the second ones of the first subset of nodes participating at the intermediate level of the three levels. In various examples, the fourth set of operators is executed via the at least one second node participating at the topmost level of the three levels.

In various examples, the at least one second node includes exactly one node based on the topmost level of the three levels being configured to include only one node acting as a root node of the hierarchical query plan.

In various examples, the each of the first ones of the first subset of nodes sends corresponding lowest level output to exactly one of the second ones of the first subset of nodes based on being a parent node of the each of the first ones of the first subset of nodes. In various examples, each of the second ones of the first subset of nodes generates corresponding intermediate level output based on processing a corresponding set of lowest level output received from multiple corresponding ones of the first subset of nodes based on being child nodes of the each of the second ones of the first subset of nodes. In various examples, the each of the second ones of the first subset of nodes sends the corresponding intermediate level output to one node of the at least one second node based on being a parent node of the each of the second ones of the first subset of nodes.

In various examples, dispersing the plurality of second output portions across the first subset of nodes at the at least one lower level of the hierarchical query plan for processing is based on: sending, via the at least one second node, each of the second output portions to one corresponding node included in the second ones of the first subset of nodes participating at the intermediate level of the three levels; and/or dispersing, via each node of the second ones of the first subset of nodes participating at the intermediate level of the three levels, corresponding ones of the second output portions received by the each node across a set of child nodes of the each node included in the first ones of the first subset of nodes participating at the lowest level of the three levels.

In various examples, dispersing the plurality of second output portions across the first subset of nodes at the at least one lower level of the hierarchical query plan for processing is further based on segregating, via each node of the second ones of the first subset of nodes participating at the intermediate level of the three levels, each of the corresponding ones of the second output portions received by the each node into a set of corresponding sub-portions for dispersal across different ones of the set of child nodes of the each node.

In various examples, the second output is segregated into the plurality of second output portions for dispersal and processing via the first subset of nodes in parallel based on determining a scatter condition has been met.

In various examples, the scatter condition is determined to be met based on applying at least one predetermined heuristic.

In various examples, the scatter condition is determined to be met based on a type of operator included in the third set of operators being one of a predetermined set of operator types; and/or a first expected query efficiency achieved via executing the third set of operators upon different portions of the second output in parallel being greater than a second expected query efficiency achieved via unparallelized executing the third set of operators upon all of the second output.

In various examples, the ordered arrangement of the plurality of operators for execution further includes: a fifth set of operators for execution serially after the fourth set of operators; and/or a sixth set of operators for execution serially after the fifth set of operators.

In various examples, executing the query operator execution flow via the plurality of nodes in conjunction with execution of the corresponding query is further based on: segregating, via the at least one second node, the fourth output into a plurality of fourth output portions; dispersing, via the at least one second node, the plurality of fourth output portions across the first subset of nodes at the at least one lower level of the hierarchical query plan for processing; generating, via the first subset of nodes, a plurality of fifth output based on the first subset of nodes executing the fifth set of operators upon corresponding fourth output portions of the plurality of fourth output portions in parallel; and/or generating, via the at least one second node, sixth output based on processing the plurality of fifth output via executing the sixth set of operators in response to receiving the plurality of fifth output from the first subset of nodes. In various example, the query resultant for the corresponding query is generated based on the fifth output.

In various examples, the ordered arrangement of the plurality of operators for execution further includes a scatter operator serially before the third set of operators and serially after second set of operators. In various examples, executing the query operator execution flow via the plurality of nodes in conjunction with execution of the corresponding query is further based on executing, via the at least one second node, the scatter operator. In various examples, the plurality of second output portions are dispersed across the first subset of nodes at the at least one lower level of the hierarchical query plan for processing based on execution of the scatter operator by the at least one second node.

In various examples, determining the query operator execution flow for execution includes updating an initial query operator execution flow by inserting the scatter operator serially before the third set of operators based on determining the initial query operator execution flow meets a scatter condition.

In various examples, determining the query operator execution flow for execution further includes selecting the third set of operators as a selected operator selected from an initial plurality of operators of the initial query operator execution flow based on selecting the selected operator for parallelized execution via the first subset of nodes. In various examples, the scatter operator is inserted serially before the selected operator based on selecting the selected operator.

In various examples, the ordered arrangement of the plurality of operators for execution further includes a gather operator serially after the at third set of operators and serially before the fourth set of operator. In various examples, executing the query operator execution flow via the plurality of nodes in conjunction with execution of the corresponding query is further based on executing, via the at least one second node, the gather operator. In various examples, the plurality of third output are received by the at least one second node for processing based on execution of the gather operator by the at least one second node.

In various examples, the query operator execution flow includes a plurality of subplans. In various examples, each of the plurality of subplans corresponds to one of a plurality of levels of the hierarchical query plan. In various examples, nodes at different nodes of the plurality of levels receive and compile corresponding subplans of the plurality of subplans in parallel. In various examples, a first subplan of the plurality of subplans corresponds to a lowest level of the at least one lower level and includes at least one of the first set of operators. In various examples, the second subplan of the plurality of subplans also corresponds to the lowest level of the at least one lower level and includes at least one of the third set of operators. In various examples, lowest level nodes at the lowest level execute the at least one of the first set of operators in conjunction with executing the first subplan during a first temporal period. In various examples, lowest level nodes at the lowest level execute the at least one of the third set of operators in conjunction with executing the second subplan during a third temporal period strictly after the first temporal period.

In various examples, executing at least one operator of the query operator execution flow is based on processing a plurality of rows in conjunction with execution of the corresponding query. In various examples, the corresponding query indicates performance of a load operation. In various examples, the query operator execution flow includes a first instance of the load operation serially before a second instance of the load operation. In various examples, executing the query operator execution flow is further based on, after processing at least one row of the plurality of rows, switching from a first mode of operation that includes executing the first instance of the load operation to a second mode of operation that includes skipping execution of the first instance of the load operation.

In various examples, executing at least one operator of the query operator execution flow is based on processing a plurality of rows in conjunction with execution of the corresponding query, based on executing optimized unnesting-based filtering structuring of a query plan implemented via the query operator execution flow to implement filtering based on unnested values of an array column based on: generating a filtered subset of the plurality of rows based on element-based filtering predicates; further processing only rows in the filtered subset of the plurality of rows by generating a filtered array structure for each row in the filtered subset of the plurality of rows based on the array column; and/or performing an unnest operation only upon the filtered array structure generated for the each row in the filtered subset of the plurality of rows.

In various embodiments, any one of more of the various examples listed above are implemented in conjunction with performing some or all steps of FIG. 27H. In various embodiments, any set of the various examples listed above can be implemented in tandem, for example, in conjunction with performing some or all steps of FIG. 27H, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 27H described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 27H, for example, in conjunction with further implementing any one or more of the various examples described above.

In various embodiments, the operational instructions, when executed by the at least one processor, cause the database system to determine a query operator execution flow for execution via a plurality of nodes each assigned to participate in a corresponding level of a hierarchical query plan, where the query operator execution flow includes an ordered arrangement of a plurality of operators for execution that includes: a first set of operators; a second set of operators for execution serially after the first set of operators; a third set of operators for execution serially after the second set of operators; and/or a fourth set of operators for execution serially after the third set of operators. In various embodiments, the operational instructions, when executed by the at least one processor, further cause the database system to execute the query operator execution flow via the plurality of nodes in conjunction with execution of the query based on: generating, via a first subset of nodes of the plurality of nodes participating in at least one lower level of the hierarchical query plan, a plurality of first output based on the first subset of nodes executing the first set of operators in parallel; generating, via at least one second node of the plurality of nodes participating in at least one upper level of the hierarchical query plan, second output based on processing the plurality of first output via executing the second set of operators in response to receiving the plurality of first output from the first subset of nodes; segregating, via the at least one second node, the second output into a plurality of second output portions; dispersing, via the at least one second node, the plurality of second output portions across the first subset of nodes at the at least one lower level of the hierarchical query plan for processing; generating, via the first subset of nodes, a plurality of third output based on the first subset of nodes executing the third set of operators upon corresponding second output portions of the plurality of second output portions in parallel; and/or generating, via the at least one second node, fourth output based on processing the plurality of third output via executing the fourth set of operators in response to receiving the plurality of third output from the first subset of nodes. In various embodiments, a query resultant for the query is generated based on the fourth output.

FIG. 27I illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 27I, for example, based on participating in execution of a query being executed by the database system 10. Some or all of the method of FIG. 27I can be performed by nodes executing a query in conjunction with a query execution, for example, via one or more nodes 37 implemented as nodes of a query execution module 2504 implementing a query execution plan 2405. In some embodiments, a node 37 can implement some or all of FIG. 27I based on implementing some or all of a plurality of processing modules 2610.1-2610.W, for example, as a corresponding plurality of processing core resources 48.1-48.W. Some or all of the steps of FIG. 27I can optionally be performed by any other one or more processing modules of the database system 10. Some or all of the steps of FIG. 27I can be performed to implement some or all of the functionality of the database system 10 as described in conjunction with FIGS. 27A-27G, for example, by implementing some or all of the functionality of operator flow generator module 2514, for example, via implementing pushdown operator selection module 2746 and/or scatter operator insertion module to generate operator execution flow 2817.1 to include at least one scatter operator 2730 for execution. Some or all steps of FIG. 27I can be performed by database system 10 in accordance with other embodiments of the database system 10 and/or nodes 37 discussed herein. Some or all of the steps of FIG. 27I can be performed in conjunction with performing some or all steps of FIG. 27H, and/or some or all steps of any other method described herein.

Step 2882 includes determining an initial query operator execution flow for a query for execution indicating an initial ordered arrangement of operators for execution via a plurality of nodes each assigned to participate in a corresponding level of a plurality of levels of a hierarchical query plan. Step 2884 includes generating an updated query operator execution flow for the query indicating an updated ordered arrangement of operators based on inserting at least one scatter operator into the initial query operator execution flow for execution serially before a selected operator (e.g. operator 2520.x) based on detecting a scatter condition is met by the initial query operator execution flow. Step 2886 includes executing the updated query operator execution flow via the plurality of nodes in conjunction with execution of the query.

In various embodiments, performing step 2886 includes performing step 2888 and/or 2890. Step 2888 includes determining scatter operator input received by at least one upper-level node of the plurality of nodes participating in an upper level of the hierarchical query plan based on output of a first set of operators serially before the scatter operator in the updated query operator execution flow. Step 2890 includes executing the scatter operator to disperse the scatter operator input across a plurality of lower-level nodes of the plurality of nodes participating in a lower level of the hierarchical query plan for parallelized processing as input of the selected operator.

In various examples, a query resultant of the query is generated based on processing a plurality of selected operator output generated based on the plurality of lower-level nodes executing the selected operator.

In various examples, generating the updated query operator execution flow is further based on inserting at least one gather operator into the initial query operator execution flow for execution serially after the selected operator based on determining the scatter condition is met. In various examples, executing the updated query operator execution flow via the plurality of nodes in conjunction with execution of the query is further based on the at least one upper-level node of the plurality of nodes receiving the plurality of selected operator output generated based on the plurality of lower-level nodes executing the selected operator. In various examples, the query resultant of the query is generated based on the at least one upper-level node processing the plurality of selected operator output.

In various examples, generating the updated query operator execution flow is based on inserting into the initial query operator execution flow, based on the hierarchical query plan including exactly level between the upper level and the lower level: exactly one scatter operator for execution serially before the selected operator; and/or exactly one gather operator for execution serially after the selected operator.

In various examples, generating the updated query operator execution flow is based on inserting into the initial query operator execution flow, based on the hierarchical query plan including at least one level between the upper level and the lower level: multiple scatter operators for execution serially before the selected operator; and/or multiple gather operators for execution serially after the selected operator.

In various examples, a number of scatter operators in the multiple scatter operators is equal to a number of gather operators in the multiple gather operators.

In various examples, the number of scatter operators and the number of gather operators is equal to one more than a number of levels between the upper level and the lower level.

In various examples, the upper level corresponds to a topmost level of the hierarchical query plan. In various examples, the lower level corresponds to a bottommost level of the hierarchical query plan.

In various examples, the initial query operator execution flow indicates execution of the initial ordered arrangement of operators in accordance with only an upward flow across the plurality of levels of the hierarchical query plan based on the initial ordered arrangement of operators including no scatter operators. In various examples, the updated query operator execution flow indicates execution of the updated ordered arrangement of operators in accordance both an upward flow and a downward flow across the plurality of levels of the hierarchical query plan based on the updated ordered arrangement of operators including the at least one scatter operator.

In various examples, generating the updated query operator execution flow indicating an updated ordered arrangement of operators is further based on selecting the selected operator from a plurality of operators in the initial ordered arrangement of operators for parallelized execution at the lower level based on detecting the scatter condition is met for the selected operator. In various examples, the at least one scatter operator into the initial query operator execution flow for execution serially before the selected operator based on selecting the selected operator.

In various examples, selecting the selected operator is based on determining the an expense metric of the selected operator is greater than an expense metric threshold and/or determining an operator type of the selected operator is not included in an excluded set of operator types.

In various examples, selecting the selected operator is based on determining a plurality of candidate operators in the a plurality of operators meeting candidate operator criteria, where the plurality of candidate operators includes the selected operator. In various examples, selecting the selected operator is based on selecting the selected operator from the plurality of candidate operators based on identifying the selected operator as a most favorable candidate operator of the plurality of candidate operators.

In various examples, identifying the selected operator as the most favorable candidate operator of the plurality of candidate operators is based on maintaining a current best operator in conjunction with performing a recursive process. In various examples, the current best operator is updated when a more favorable operator than a previously identified current best operator is identified during the recursive process. In various examples, the selected operator is identified as the most favorable candidate operator of the plurality of candidate operators based on being the current best operator upon completion of the recursive process.

In various examples, the initial ordered arrangement of operators is in accordance with a directed acyclic graph of operators. In various examples, the recursive process is performed based on performing a breadth first search of the directed acyclic graph to identify a deepest rightmost operator in the directed acyclic graph meeting candidate operator criteria.

In various examples, the updated query operator execution flow is generated in conjunction with performing a query flow optimization process upon the initial query operator execution flow. In various examples, performing the query flow optimization process includes determining whether the scatter condition is met.

In various examples, the method further includes determining a second initial query operator execution flow for a second query for execution indicating a second initial ordered arrangement of operators for execution via the plurality of nodes. In various examples, the method further includes generating a finalized query operator execution flow for the second query indicating a finalized ordered arrangement of operators. In various examples, the finalized ordered arrangement of operators includes no scatter operators based on determining the scatter condition is not met by the second initial query operator execution flow. In various examples, the method further includes executing the finalized query operator execution flow via the plurality of nodes in conjunction with execution of the second query.

In various examples, determining the scatter condition is not met by the second initial query operator execution flow is based on identifying no selected operator in a plurality of operators included in the second initial query operator execution flow based on determining none of the plurality of operators meeting candidate operator criteria. In various examples, determining the scatter condition is not met by the second initial query operator execution flow is based on identifying no selected operator in a plurality of operators included in the second initial query operator execution flow based on identifying a non-null set of candidate operators in the plurality of operators meeting the candidate operator criteria, and/or further determining a gather operator cannot be inserted serially after any of the non-null set of candidate operators.

In various examples, the first set of operators includes a first subset of the first set of operators serially before a second subset of the first set of operators. In various examples, the first subset of the first set of operators are executed via the plurality of lower-level nodes in parallel. In various examples, the second subset of the first set of operators are executed via the at least one upper-level node.

In various examples, executing at least one operator of the updated query operator execution flow is based on processing a plurality of rows in conjunction with execution of the query. In various examples, the query indicates performance of a load operation. In various examples, the updated query operator execution flow includes a first instance of the load operation serially before a second instance of the load operation. In various examples, executing the updated query operator execution flow is further based on, after processing at least one row of the plurality of rows, switching from a first mode of operation that includes executing the first instance of the load operation to a second mode of operation that includes skipping execution of the first instance of the load operation.

In various examples, executing at least one operator of the updated query operator execution flow is based on processing a plurality of rows in conjunction with execution of the query, based on executing optimized unnesting-based filtering structuring of a query plan implemented via the updated query operator execution flow to implement filtering based on unnested values of an array column based on: generating a filtered subset of the plurality of rows based on element-based filtering predicates; further processing only rows in the filtered subset of the plurality of rows by generating a filtered array structure for each row in the filtered subset of the plurality of rows based on the array column; and/or performing an unnest operation only upon the filtered array structure generated for the each row in the filtered subset of the plurality of rows.

In various embodiments, any one of more of the various examples listed above are implemented in conjunction with performing some or all steps of FIG. 27I. In various embodiments, any set of the various examples listed above can be implemented in tandem, for example, in conjunction with performing some or all steps of FIG. 27I, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 27I described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 27I, for example, in conjunction with further implementing any one or more of the various examples described above.

In various embodiments, the operational instructions, when executed by the at least one processor, cause the database system to determine an initial query operator execution flow for a query for execution indicating an initial ordered arrangement of operators for execution via a plurality of nodes each assigned to participate in a corresponding level of a plurality of levels of a hierarchical query plan, generate an updated query operator execution flow for the query indicating an updated ordered arrangement of operators based on inserting at least one scatter operator into the initial query operator execution flow for execution serially before a selected operator based on detecting a scatter condition is met by the initial query operator execution flow, and/or execute the updated query operator execution flow via the plurality of nodes in conjunction with execution of the query based on: determining scatter operator input received by at least one upper-level node of the plurality of nodes participating in an upper level of the hierarchical query plan based on output of a first set of operators serially before the scatter operator in the updated query operator execution flow; and/or executing the scatter operator to disperse the scatter operator input across a plurality of lower-level nodes of the plurality of nodes participating in a lower level of the hierarchical query plan for parallelized processing as input of the selected operator. In various embodiments, a query resultant of the query is generated based on processing a plurality of selected operator output generated based on the plurality of lower-level nodes executing the selected operator.

FIG. 27J illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 27J, for example, based on participating in execution of a query being executed by the database system 10. Some or all of the method of FIG. 27J can be performed by nodes executing a query in conjunction with a query execution, for example, via one or more nodes 37 implemented as nodes of a query execution module 2504 implementing a query execution plan 2405. In some embodiments, a node 37 can implement some or all of FIG. 27J based on implementing some or all of a plurality of processing modules 2610.1-2610.W, for example, as a corresponding plurality of processing core resources 48.1-48.W. Some or all of the steps of FIG. 27J can optionally be performed by any other one or more processing modules of the database system 10. Some or all of the steps of FIG. 27J can be performed to implement some or all of the functionality of the database system 10 as described in conjunction with FIGS. 27A-27G, for example, by implementing some or all of the functionality of query execution module 2504, for example, via one or mode nodes 37 implementing operator flow generator module 2514, per-level message generator module 2740, message communication module 2743, subplan compilation module 2730, and/or subplan execution module 2751. Some or all steps of FIG. 27J can be performed by database system 10 in accordance with other embodiments of the database system 10 and/or nodes 37 discussed herein. Some or all of the steps of FIG. 27J can be performed in conjunction with performing some or all steps of FIG. 27H and/or 27I, and/or some or all steps of any other method described herein.

Step 2982 includes determining, for example, via a root node at a topmost level of a plurality of levels of a hierarchical query plan, a plurality of subplans of a query operator execution flow a query. In various examples, a plurality of nodes of the hierarchical query plan includes the root node and a plurality of additional nodes participating across a set of lower levels of the hierarchical query plan. In various examples, each subplan of the plurality of subplans is configured for execution via nodes of the plurality of nodes participating at a given level of the plurality of levels of the hierarchical query plan.

Step 2984 includes grouping, for example, via the root node, the plurality of subplans into a plurality of level-based subplan groupings. In various examples, all subplans of the plurality of subplans configured for execution at the given level are included in a corresponding one of the plurality of level-based subplan groupings. In various examples, a subset of the plurality of level-based subplan groupings corresponds to the set of lower levels.

Step 2986 includes communicating, for example, via the root node, a plurality of messages indicating the subset of the plurality of level-based subplan groupings to the plurality of additional nodes. In various examples, each node of the plurality of nodes is included in a corresponding level of the plurality of levels. In various examples, the each node compiles a set of subplans included in one of the plurality of level-based subplan groupings for the corresponding level.

Step 2988 includes executing, for example, via the plurality of nodes, the query operator execution flow in conjunction with execution of the query based on the each node of the plurality of nodes executing the set of subplans based on having compiled the set of subplans.

In various examples, multiple ones of the plurality of nodes participate in each of the set of lower levels. In various examples, a corresponding set of subplans in a level-based subplan grouping for the each of the set of lower levels are executed by the multiple ones of the plurality of nodes in parallel.

In various examples, one of the plurality of level-based subplan groupings corresponds to the topmost level. In various examples, the root node executes a corresponding set of subplans included in the one of the plurality of level-based subplan groupings in conjunction with execution of the query.

In various examples, each node of the plurality of additional nodes executes subplans included in exactly one message of the plurality of messages indicating a corresponding level-based subplan grouping of the plurality of level-based subplan groupings.

In various examples, the set of lower levels includes a plurality of lower levels. In various examples, nodes included in different ones of the plurality of lower levels compile corresponding sets of subplans in parallel based on the plurality of messages indicating the subset of the plurality of level-based subplan groupings.

In various examples, at least one of the plurality of level-based subplan groupings includes multiple subplans based on the query operator execution flow including at least one scatter operator to disperse output generated via at least one first node at a first level of the hierarchical query plan for processing via second nodes at a second level of the hierarchical query plan that is lower than the first level in the hierarchical query plan.

In various examples, the at least one first node includes only the root node based on the first level corresponding to the topmost level of the query plan.

In various examples, the second level of the hierarchical query plan is a lowest level of the hierarchical query plan.

In various examples, a first level-based subplan grouping of the plurality of level-based subplan groupings for the first level includes a first set of multiple subplans. In various examples, a second level-based subplan grouping of the plurality of level-based subplan groupings for the second level includes a second set of multiple subplans.

In various examples, the first set of multiple subplans and the second set of multiple subplans include a same number of subplans.

In various examples, an additional level-based subplan grouping of the plurality of level-based subplan groupings for another level of the plurality of levels includes a third set of multiple subplans based on the another level being between the first level and the second level in the hierarchical query plan.

In various examples, the third set of multiple subplans includes a first number of subplans equal to one less than twice a second number of subplans included in the second set of multiple subplans based on the another level being between the first level and the second level in the hierarchical query plan.

In various examples, the at least one scatter operator is included in the query operator execution flow based on the root node determining at scatter condition has been met in optimizing the query operator execution flow.

In various examples, the scatter condition is determined to be met based on a type of operator included the query operator execution flow being one of a predetermined set of operator types and/or a first expected query efficiency achieved via executing a set of operators in parallel being greater than a second expected query efficiency achieved via unparallelized execution of the set of operators.

In various examples, the plurality of subplans are executed serially in accordance with a serialized ordering. In various examples, no two subplans included in any given one of the plurality of level-based subplan groupings are consecutive in the serialized ordering.

In various examples, executing at least one operator of the query operator execution flow is based on processing a plurality of rows in conjunction with execution of the query. In various examples, the query indicates performance of a load operation. In various examples, the query operator execution flow includes a first instance of the load operation serially before a second instance of the load operation. In various examples, executing the query operator execution flow is further based on, after processing at least one row of the plurality of rows, switching from a first mode of operation that includes executing the first instance of the load operation to a second mode of operation that includes skipping execution of the first instance of the load operation.

In various examples, executing at least one operator of the query operator execution flow is based on processing a plurality of rows in conjunction with execution of the query, based on executing optimized unnesting-based filtering structuring of a query plan implemented via the query operator execution flow to implement filtering based on unnested values of an array column based on: generating a filtered subset of the plurality of rows based on element-based filtering predicates; further processing only rows in the filtered subset of the plurality of rows by generating a filtered array structure for each row in the filtered subset of the plurality of rows based on the array column; and/or performing an unnest operation only upon the filtered array structure generated for the each row in the filtered subset of the plurality of rows.

In various embodiments, any one of more of the various examples listed above are implemented in conjunction with performing some or all steps of FIG. 27J. In various embodiments, any set of the various examples listed above can be implemented in tandem, for example, in conjunction with performing some or all steps of FIG. 27J, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 27J described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 27J, for example, in conjunction with further implementing any one or more of the various examples described above.

In various embodiments, the operational instructions, when executed by the at least one processor, cause the database system to: determine, via a root node at a topmost level of a plurality of levels of a hierarchical query plan, a plurality of subplans of a query operator execution flow a query, where a plurality of nodes of the hierarchical query plan includes the root node an a plurality of additional nodes participating across a set of lower levels of the hierarchical query plan, and/or where each subplan of the plurality of subplans is configured for execution via nodes of the plurality of nodes participating at a given level of the plurality of levels of the hierarchical query plan; group, via the root node, the plurality of subplans into a plurality of level-based subplan groupings, where all subplans of the plurality of subplans configured for execution at the given level are included in a corresponding one of the plurality of level-based subplan groupings, and/or where a subset of the plurality of level-based subplan groupings corresponds to the set of lower levels; communicate, via the root node, a plurality of messages indicating the subset of the plurality of level-based subplan groupings to the plurality of additional nodes, where each node of the plurality of nodes is included in a corresponding level of the plurality of levels, and/or where the each node compiles a set of subplans included in one of the plurality of level-based subplan groupings for the corresponding level; and/or execute, via the plurality of nodes, the query operator execution flow in conjunction with execution of the query based on the each node of the plurality of nodes executing the set of subplans based on having compiled the set of subplans.

As used herein, an “AND operator” can correspond to any operator implementing logical conjunction. As used herein, an “OR operator” can correspond to any operator implementing logical disjunction.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., indicates an advantageous relationship that would be evident to one skilled in the art in light of the present disclosure, and based, for example, on the nature of the signals/items that are being compared. As may be used herein, the term “compares unfavorably”, indicates that a comparison between two or more items, signals, etc., fails to provide such an advantageous relationship and/or that provides a disadvantageous relationship. Such an item/signal can correspond to one or more numeric values, one or more measurements, one or more counts and/or proportions, one or more types of data, and/or other information with attributes that can be compared to a threshold, to each other and/or to attributes of other information to determine whether a favorable or unfavorable comparison exists. Examples of such an advantageous relationship can include: one item/signal being greater than (or greater than or equal to) a threshold value, one item/signal being less than (or less than or equal to) a threshold value, one item/signal being greater than (or greater than or equal to) another item/signal, one item/signal being less than (or less than or equal to) another item/signal, one item/signal matching another item/signal, one item/signal substantially matching another item/signal within a predefined or industry accepted tolerance such as 1%, 5%, 10% or some other margin, etc. Furthermore, one skilled in the art will recognize that such a comparison between two items/signals can be performed in different ways. For example, when the advantageous relationship is that signal 1 has a greater magnitude than signal 2, a favorable comparison may be achieved when the magnitude of signal 1 is greater than that of signal 2 or when the magnitude of signal 2 is less than that of signal 1. Similarly, one skilled in the art will recognize that the comparison of the inverse or opposite of items/signals and/or other forms of mathematical or logical equivalence can likewise be used in an equivalent fashion. For example, the comparison to determine if a signal X>5 is equivalent to determining if −X<−5, and the comparison to determine if signal A matches signal B can likewise be performed by determining −A matches −B or not(A) matches not(B). As may be discussed herein, the determination that a particular relationship is present (either favorable or unfavorable) can be utilized to automatically trigger a particular action. Unless expressly stated to the contrary, the absence of that particular condition may be assumed to imply that the particular action will not automatically be triggered. In other examples, the determination that a particular relationship is present (either favorable or unfavorable) can be utilized as a basis or consideration to determine whether to perform one or more actions. Note that such a basis or consideration can be considered alone or in combination with one or more other bases or considerations to determine whether to perform the one or more actions. In one example where multiple bases or considerations are used to determine whether to perform one or more actions, the respective bases or considerations are given equal weight in such determination. In another example where multiple bases or considerations are used to determine whether to perform one or more actions, the respective bases or considerations are given unequal weight in such determination.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a“start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e. machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event—without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind.

While particular combinations of various functions and features of the one or more embodiments have been expressly described herein, other combinations of these features and functions are likewise possible. The present disclosure is not limited by the particular examples disclosed herein and expressly incorporates these other combinations.

1-20. (canceled)

21. A query and response sub-system of a database system, wherein the query and response sub-system comprises:
a plurality of computing device clusters, wherein a computing device cluster of the plurality of computing device clusters, wherein the computing cluster includes one or more computing devices, and wherein the computing device cluster is operable to:
generate a plurality of query operations for a query regarding data of a dataset, wherein a query operation of the plurality of query operations includes one or more operators, wherein the plurality of query operations includes:
a first set of query operations that, when executed by hierarchical computing nodes, causes the hierarchical computing nodes to:
execute, in a wide parallelism mode, a first operation of the first set of operations on the data of the dataset to produce a plurality of first outputs;
execute, in a narrow parallelism mode, another operation of the first set of operations on the plurality of first outputs or on a plurality of further processed first outputs to produce a first output result;
a scatter operation that, when executed by a computing node of the hierarchical computing nodes, causes the computing node to:
divide the first output result into a plurality of first output scattered data;
a second set of query operations that, when executed by the hierarchical computing nodes, causes the hierarchical computing nodes to:
receive, in the wide parallelism mode, the plurality of first scattered data;
execute, in the wide parallelism mode, a first operation of the second set of operations on the plurality of first scattered data to produce a plurality of second outputs;
execute, in the narrow parallelism mode, another operation of the second set of operations on the plurality of second outputs or on a plurality of further processed second outputs to produce a second output result.

22. The query and response sub-system of claim 21, wherein the computing device cluster is further operable to generate the plurality of query operations to further include:
a second scatter operation that, when executed by one of the computing nodes of the hierarchical computing nodes, causes the one of the computing nodes to:
divide the second output result into a plurality of second output scattered data;
a third set of query operations that, when executed by the hierarchical computing nodes, causes the hierarchical computing nodes to:
receive, in the wide parallelism mode, the plurality of second scattered data;
execute, in the wide parallelism mode, a first operation of the third set of operations on the plurality of second scattered data to produce a plurality of third outputs;
execute, in the narrow parallelism mode, another operation of the third set of operations on the plurality of third outputs or on a plurality of further processed third outputs to produce a third output result.

23. The query and response sub-system of claim 21, wherein the computing device cluster is further operable to generate a query execution plan regarding the plurality of query operations by:
identifying the hierarchical computing nodes of a store and compute sub-system of the database system based on storage mapping information that indicates that at least some of the hierarchical computing nodes store, or are to store, the data of the dataset;
ordering execution of the first set of query operations to precede execution of the scatter operation, which precedes execution of the second set of query operations;
for the first set of query operations:
identifying a first group of computing nodes of the hierarchical computing nodes to execute, in the wide parallelism mode, the first operation of the first set of operations;
identifying a second group of computing nodes of the hierarchical computing nodes to execute, in the narrow parallelism mode, the other operation of the first set of operation, wherein a number of computing nodes of the first group is substantially larger than a number of computing nodes in the second group, wherein the number of computing nodes in the second group is one or more; and
ordering execution of the first operation of the first set of operations to precede the other operation of the first set of operations; and
for the second set of query operations:
identifying the first group of computing nodes of the hierarchical computing nodes to execute, in the wide parallelism mode, the first operation of the second set of operations;
identifying the second group of computing nodes of the hierarchical computing nodes to execute, in the narrow parallelism mode, the other operation of the second set of operation; and
ordering execution of the first operation of the second set of operations to precede the other operation of the second set of operations.

24. The query and response sub-system of claim 21, wherein the computing device cluster is further operable to generate the plurality of query operations by:
generating the first set of query operations such that:
the first operation of the first set of operations is to be executed on the data of the dataset by a first group of computing nodes of the hierarchical computing nodes; and
the other operation of the first set of operations is to be executed on the plurality of first outputs by a second group of computing nodes of the hierarchical computing nodes, wherein a number of computing nodes of the first group is substantially larger than a number of computing nodes in the second group, wherein the number of computing nodes in the second group is one or more;
generating the scatter operation for executing by the second group of computing nodes;
generating the second set of query operations such that:
the first operation of the second set of operations is to be executed on the plurality of scattered data by the first group of computing nodes of the hierarchical computing nodes; and
the other operation of the second set of operation is to be executed on the plurality of second outputs by the second group of computing nodes of the hierarchical computing nodes.

25. The query and response sub-system of claim 21, wherein the computing device cluster is further operable to generate the plurality of query operations by:
generating the first set of query operations such that:
the first operation of the first set of operations is to be executed on the data of the dataset by a first group of computing nodes of the hierarchical computing nodes;
a second operation of the first set of operations is to be executed on the plurality of first outputs by a second group of computing nodes of the hierarchical computing nodes to produce a plurality of second outputs; and
the other operation of the first set of operations is to be executed on the plurality of second outputs by a third group of computing nodes of the hierarchical computing nodes, wherein a number of computing nodes of the first group is greater than a number of computing nodes in the second group, which is greater than the number of computing nodes in the third group, wherein the number of computing nodes in the third group is one or more.

26. The query and response sub-system of claim 21, wherein the computing device cluster is further operable to generate the plurality of query operations by:
generating the first set of query operations to further include a gather operation that is to be executed by the hierarchical computing nodes after execution of the first operation of the first set of operations and before execution of the other operation of the first set of operations.

27. The query and response sub-system of claim 21, wherein the computing device cluster is further operable to:
identify a set of SC computing device clusters of a plurality of SC computing device clusters of a store and compute (SC) sub-system of the database system, wherein the set of SC computing devices clusters; and
identify computing devices of the set of computing device clusters as the hierarchical computing nodes.

28. The query and response sub-system of claim 21, wherein the computing device cluster is further operable to:
identify a set of SC computing device clusters of a plurality of SC computing device clusters of a store and compute (SC) sub-system of the database system, wherein the set of SC computing devices clusters;
identify computing devices of the set of computing device clusters; and
identity computing nodes of the computing devices as the hierarchical computing nodes.

29. The query and response sub-system of claim 21, wherein the computing device cluster is further operable to:
identify a set of SC computing device clusters of a plurality of SC computing device clusters of a store and compute (SC) sub-system of the database system, wherein the set of SC computing devices clusters;
identify computing devices of the set of computing device clusters;
identity computing nodes of the computing devices; and
identify processing core resources of the computing nodes as the hierarchical computing nodes.

30. The query and response sub-system of claim 21 further comprises:
the dataset includes a plurality of data organized as a plurality of rows and a plurality of columns, wherein a row of the plurality of rows includes a row of data of the plurality of data, and wherein the row of data is organized based on the plurality of columns; and
the data of the dataset includes one or more rows of the plurality of rows of data.

31. A computer readable memory comprises:
memory that stores operational instructions that, when executed by a computing device cluster of the plurality of computing device clusters of a query and response sub-system of a database system, causes the computing device cluster to:
generate a plurality of query operations for a query regarding data of a dataset, wherein a query operation of the plurality of query operations includes one or more operators, wherein the plurality of query operations includes:
a first set of query operations that, when executed by hierarchical computing nodes, causes the hierarchical computing nodes to:
execute, in a wide parallelism mode, a first operation of the first set of operations on the data of the dataset to produce a plurality of first outputs;
execute, in a narrow parallelism mode, another operation of the first set of operations on the plurality of first outputs or on a plurality of further processed first outputs to produce a first output result;
a scatter operation that, when executed by a computing node of the hierarchical computing nodes, causes the computing node to:
divide the first output result into a plurality of first output scattered data;
a second set of query operations that, when executed by the hierarchical computing nodes, causes the hierarchical computing nodes to:
receive, in the wide parallelism mode, the plurality of first scattered data;
execute, in the wide parallelism mode, a first operation of the second set of operations on the plurality of first scattered data to produce a plurality of second outputs;
execute, in the narrow parallelism mode, another operation of the second set of operations on the plurality of second outputs or on a plurality of further processed second outputs to produce a second output result.

32. The computer readable memory of claim 31, wherein the memory further stores operational instructions that, when executed by the computing device cluster, causes the computing device cluster to further generate the plurality of query operations to include:
a second scatter operation that, when executed by one of the computing nodes of the hierarchical computing nodes, causes the one of the computing nodes to:
divide the second output result into a plurality of second output scattered data;
a third set of query operations that, when executed by the hierarchical computing nodes, causes the hierarchical computing nodes to:
receive, in the wide parallelism mode, the plurality of second scattered data;
execute, in the wide parallelism mode, a first operation of the third set of operations on the plurality of second scattered data to produce a plurality of third outputs;
execute, in the narrow parallelism mode, another operation of the third set of operations on the plurality of third outputs or on a plurality of further processed third outputs to produce a third output result.

33. The computer readable memory of claim 31, wherein the memory further stores operational instructions that, when executed by the computing device cluster, causes the computing device cluster to generate a query execution plan regarding the plurality of query operations by:
identifying the hierarchical computing nodes of a store and compute sub-system of the database system based on storage mapping information that indicates that at least some of the hierarchical computing nodes store, or are to store, the data of the dataset;
ordering execution of the first set of query operations to precede execution of the scatter operation, which precedes execution of the second set of query operations;
for the first set of query operations:
identifying a first group of computing nodes of the hierarchical computing nodes to execute, in the wide parallelism mode, the first operation of the first set of operations;
identifying a second group of computing nodes of the hierarchical computing nodes to execute, in the narrow parallelism mode, the other operation of the first set of operation, wherein a number of computing nodes of the first group is substantially larger than a number of computing nodes in the second group, wherein the number of computing nodes in the second group is one or more; and
ordering execution of the first operation of the first set of operations to precede the other operation of the first set of operations; and
for the second set of query operations:
identifying the first group of computing nodes of the hierarchical computing nodes to execute, in the wide parallelism mode, the first operation of the second set of operations;
identifying the second group of computing nodes of the hierarchical computing nodes to execute, in the narrow parallelism mode, the other operation of the second set of operation; and
ordering execution of the first operation of the second set of operations to precede the other operation of the second set of operations.

34. The computer readable memory of claim 31, wherein the memory further stores operational instructions that, when executed by the computing device cluster, causes the computing device cluster to generate the plurality of query operations by:
generating the first set of query operations such that:
the first operation of the first set of operations is to be executed on the data of the dataset by a first group of computing nodes of the hierarchical computing nodes; and
the other operation of the first set of operations is to be executed on the plurality of first outputs by a second group of computing nodes of the hierarchical computing nodes, wherein a number of computing nodes of the first group is substantially larger than a number of computing nodes in the second group, wherein the number of computing nodes in the second group is one or more;
generating the scatter operation for executing by the second group of computing nodes;
generating the second set of query operations such that:
the first operation of the second set of operations is to be executed on the plurality of scattered data by the first group of computing nodes of the hierarchical computing nodes; and
the other operation of the second set of operation is to be executed on the plurality of second outputs by the second group of computing nodes of the hierarchical computing nodes.

35. The computer readable memory of claim 31, wherein the memory further stores operational instructions that, when executed by the computing device cluster, causes the computing device cluster to generate the plurality of query operations by:
generating the first set of query operations such that:
the first operation of the first set of operations is to be executed on the data of the dataset by a first group of computing nodes of the hierarchical computing nodes;
a second operation of the first set of operations is to be executed on the plurality of first outputs by a second group of computing nodes of the hierarchical computing nodes to produce a plurality of second outputs; and
the other operation of the first set of operations is to be executed on the plurality of second outputs by a third group of computing nodes of the hierarchical computing nodes, wherein a number of computing nodes of the first group is greater than a number of computing nodes in the second group, which is greater than the number of computing nodes in the third group, wherein the number of computing nodes in the third group is one or more.

36. The computer readable memory of claim 31, wherein the memory further stores operational instructions that, when executed by the computing device cluster, causes the computing device cluster to generate the plurality of query operations by:
generating the first set of query operations to further include a gather operation that is to be executed by the hierarchical computing nodes after execution of the first operation of the first set of operations and before execution of the other operation of the first set of operations.

37. The computer readable memory of claim 31, wherein the memory further stores operational instructions that, when executed by the computing device cluster, causes the computing device cluster to:
identify a set of SC computing device clusters of a plurality of SC computing device clusters of a store and compute (SC) sub-system of the database system, wherein the set of SC computing devices clusters; and
identify computing devices of the set of computing device clusters as the hierarchical computing nodes.

38. The computer readable memory of claim 31, wherein the memory further stores operational instructions that, when executed by the computing device cluster, causes the computing device cluster to:
identify a set of SC computing device clusters of a plurality of SC computing device clusters of a store and compute (SC) sub-system of the database system, wherein the set of SC computing devices clusters; and
identify computing devices of the set of computing device clusters; and
identity computing nodes of the computing devices as the hierarchical computing nodes.

39. The computer readable memory of claim 31, wherein the memory further stores operational instructions that, when executed by the computing device cluster, causes the computing device cluster to:
identify a set of SC computing device clusters of a plurality of SC computing device clusters of a store and compute (SC) sub-system of the database system, wherein the set of SC computing devices clusters; and
identify computing devices of the set of computing device clusters;
identity computing nodes of the computing devices; and
identify processing core resources of the computing nodes as the hierarchical computing nodes.

40. The computer readable memory of claim 31 further comprises:
the dataset includes a plurality of data organized as a plurality of rows and a plurality of columns, wherein a row of the plurality of rows includes a row of data of the plurality of data, and wherein the row of data is organized based on the plurality of columns; and
the data of the dataset includes one or more rows of the plurality of rows of data.
